(19) United States
(12) Patent Application Publication
(10) Pub. No.: US 2023/0120925 A1
(43) Pub. Date: Apr. 20, 2023

(54) PROGRAM, INFORMATION PROCESSING METHOD, TERMINAL, AND SERVER

(71) Applicant: LINE CORPORATION, Tokyo (JP)

(72) Inventors: Ryosuke HAMASAKO, Tokyo (JP); Yosuke MAZAKI, Tokyo (JP)

(73) Assignee: LINE CORPORATION, Tokyo (JP)

(21) Appl. No.: 18/083,199

(22) Filed: Dec. 16, 2022

Related U.S. Application Data
(63) Continuation of application No. PCT/JP2020/034099, filed on Sep. 9, 2020.

(30) Foreign Application Priority Data
Jun. 17, 2020 (JP) 2020-104382
Jun. 17, 2020 (JP) 2020-104383

(51) Int. Cl. G06Q 20/10; G06Q 20/40

(52) U.S. Cl. CPC G06Q 20/10; G06Q 20/405

(57) ABSTRACT

An information processing method includes: receiving, by a communication part of a terminal, first information relating to a remittance request from a first user, displaying, in a display of the terminal, a first indication based on the first information, displaying, in the display, a second indication that is based on the remittance request and differs from the first indication, receiving, by the communication part, an input by a user of the terminal based on the second indication displayed in the display, and executing, by a processor of the terminal, remittance processing that is based on the remittance request and relates to remittance from the user of the terminal to the first user, based on the input by the user of the terminal.

### CROSS-REFERENCE TO RELATED APPLICATIONS

This application is a bypass continuation of PCT International Application No. PCT/JP2020/34099, which was filed on Sep. 9, 2020, and claims priority to Japanese Patent Application No. JP2020-104382, filed on Jun. 17, 2020, and Japanese Patent Application No. JP2020-104383, filed on Jun. 17, 2020, in the Japan Intellectual Property Office, the disclosures of which are incorporated herein by reference in their entireties.

### BACKGROUND

### 1. Field

The disclosure relates to an information processing method and terminal.

### 2. Description of Related Art

Recent years have seen the prevalence of services in which an application executable in a terminal such as a smartphone is used to realize the management, transmittance/reception, and the like of electronic money by a terminal or the user of a terminal. For example, JP 2002-176671A discloses a technology for making a payment for purchased goods.

### SUMMARY

According to an aspect of the disclosure, a non-transitory computer readable medium includes computer readable program code or instructions which are executable by a processor to perform a method. The method includes: receiving, by a communication part of a terminal, first information relating to a remittance request from a first user; displaying, in a display of the terminal, a first indication based on the first information; displaying, in the display, a second indication that is based on the remittance request and differs from the first indication; receiving, by an input device of the terminal, an input by a user of the terminal based on the second indication displayed in the display; and executing remittance processing that is based on the remittance request and relates to remittance from a user of the terminal to the first user, based on the input by the user of the terminal.

The first indication may include information of an amount based on the remittance request, and the second indication may include information of the amount based on the remittance request.

The first indication may include information of the first user, and the second indication may include information of the first user.

The second indication may be displayed in the terminal based on a first condition.

The first condition may include a condition relating to time.

The first condition may include a condition of a point in time or a period of time set by the terminal.

The first condition may include a condition of a point in time or a period of time set by a terminal of the first user.

The first condition may include a condition relating to a balance associated with the user of the terminal.

The first condition may include a condition relating to remittance to the user of the terminal.

The condition relating to remittance to the user of the terminal may include remittance to the user of the terminal as a result of the user of the terminal obtaining a loan.

The condition relating to remittance to the user of the terminal may include remittance to the user of the terminal from a purchaser who purchased an item offered for sale by the user of the terminal.

The first condition may include a condition relating to purchase of an item offered for sale by the user of the terminal.

The method may further include, based on the first condition, receiving, by the communication part, second information that may be based on the remittance request and differs from the first information, where the second indication may be displayed in the display based on reception of the second information.

The first indication and the second indication may be displayed in the display by an application installed in the terminal.

The method may further include: displaying a chat room, in the display, the chat room comprising at least the user of the terminal and the first user, where the first indication and the second indication may be displayed in the chat room.

The chat room may include at least the user of the terminal, the first user, and a second user different from the first user, and the second indication may be not displayed in a chat room that may be displayed in a terminal of the second user.

The second indication may be not displayed in a chat room that may be displayed in a terminal of the first user.

The second indication may include information indicating the user of the terminal.

The second indication may be displayed in a first display manner in the chat room, and may be displayed in a second display manner that may be different from the first display manner in the chat room displayed in the terminal of the second user.

The first information may be transmitted via a server to the terminal based on an input by the first user to a terminal of the first user, and the second indication may be displayed based on second information that differs from the first information and may be transmitted by the server to the terminal, and the second information may be based on a settlement request.

The second information may be transmitted to the terminal based on a time at which the first information may be transmitted to the terminal or a time at which the first information may be received by the terminal.

The method may further include: receiving, by the communication part, third information that may be based on the remittance request and transmitted from the terminal of the first user, based on the input by the first user to the terminal of the first user; and displaying, in the display, a third indication based on the third information, where the second information may be transmitted to the terminal based on transmission of the third information to the terminal.

The method may further include: performing notification processing based on reception, by the communication part, of second information that may be based on a settlement request and differs from the first information, where the notification processing may be performed based on a second condition.

The method may further include: displaying, in the display, a fourth indication that remittance based on the remittance request has not been executed, based on the remittance processing not being executed; and displaying, in the display, a fifth indication that remittance based on the remittance request has been executed, based on the remittance processing being executed.

The remittance processing may be executed based on an input by the user of the terminal based on the first indication.

The method may further include: displaying, in the display, information indicating that remittance processing based on the remittance request has been executed.

The method may further include: transmitting, by the communication part, information relating to a request for remittance processing based on the remittance request.

The first user may be a store that sells a product relating to the remittance request.

The first user may be a user who uses a business account.

According to an aspect of the disclosure, an information processing method performed by a terminal includes: receiving, by a communication part of the terminal, first information relating to a remittance request from a first user; displaying, in a display of the terminal, a first indication based on the first information; displaying, in the display, a second indication that is based on the remittance request and differs from the first indication; receiving, by the communication part, an input by a user of the terminal based on the second indication displayed in the display; and executing, by a processor of the terminal, remittance processing that is based on the remittance request and relates to remittance from the user of the terminal to the first user, based on the input by the user of the terminal.

According to an aspect of the disclosure a terminal includes: a communication part configured to receive first information relating to a remittance request from a first user; a display configured to display a first indication based on the first information and a second indication that is based on the remittance request and differs from the first indication; and a processor configured to execute remittance processing that is based on the remittance request and relates to remittance from a user of the terminal to the first user, based on an input that is based on the second indication displayed in the display.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1-1 is a diagram showing an example of a configuration of a communication system in an example embodiment;

FIG. 1-2 is a diagram showing an example of functions realized by a controller of a server according to an example embodiment;

FIG. 1-3 is a diagram showing an example of information stored in a storage of the server according to an example embodiment;

FIG. 1-4 is a diagram showing an example of user registration data according to an example embodiment;

FIG. 1-5 is a diagram showing an example of a user management database according to an example embodiment;

FIG. 1-6 is a diagram showing an example of remittance request management data according to an example embodiment;

FIG. 1-7 is a diagram showing an example of functions realized by a controller of a terminal according to an example embodiment;

FIG. 1-8 is a diagram showing an example of information stored in a storage of the terminal according to an example embodiment;

FIG. 1-9 is a diagram showing an example of a display screen of the terminal according to an example embodiment;

FIG. 1-10 is a diagram showing an example of a display screen of the terminal according to an example embodiment;

FIG. 1-11 is a diagram showing an example of a display screen of the terminal according to an example embodiment;

FIG. 1-12 is a diagram showing an example of a display screen of the terminal according to an example embodiment;

FIG. 1-13 is a flowchart showing an example of a flow of processing performed by the terminal and the server according to an example embodiment;

FIG. 1-14 is a flowchart showing an example of a flow of processing performed by the terminal and the server according to an example embodiment;

FIG. 1-15 is a flowchart showing an example of a flow of processing performed by the terminal and the server according to an example embodiment;

FIG. 2-1 is a diagram showing an example of remittance request management data according to an example embodiment;

FIG. 2-2 is a diagram showing an example of a display screen of the terminal according to an example embodiment;

FIG. 2-3 is a diagram showing an example of a display screen of the terminal according to an example embodiment;

FIG. 2-4 is a diagram showing an example of a display screen of the terminal according to an example embodiment;

FIG. 2-5 is a diagram showing an example of a display screen of the terminal according to an example embodiment;

FIG. 2-6 is a diagram showing an example of a display screen of the terminal according to an example embodiment;

FIG. 2-7 is a diagram showing an example of a display screen of the terminal according to an example embodiment;

FIG. 2-8 is a diagram showing an example of a display screen of the terminal according to an example embodiment;

FIG. 2-9 is a diagram showing an example of a display screen of the terminal according to an example embodiment;

FIG. 2-10 is a diagram showing an example of a display screen of the terminal according to an example embodiment;

FIG. 2-11 is a flowchart showing an example of a flow of processing performed by the terminal and the server according to an example embodiment;

FIG. 2-12 is a flowchart showing an example of a flow of processing performed by the terminal and the server according to an example embodiment;

FIG. 2-13 is a diagram showing an example of a display screen of the terminal according to an example embodiment;

FIG. 2-14 is a diagram showing an example of a display screen of the terminal according to an example embodiment;

FIG. 2-15 is a diagram showing an example of a display screen of the terminal according to an example embodiment;

FIG. 2-16 is a diagram showing an example of a display screen of the terminal according to an example embodiment;

FIG. 2-17 is a diagram showing an example of a display screen of the terminal according to an example embodiment;

FIG. 2-18 is a diagram showing an example of a display screen of the terminal according to an example embodiment;

FIG. 3-1 is a diagram showing an example of a timing chart according to an example embodiment;

FIG. 3-2 is a diagram showing an example of a timing chart according to an example embodiment;

FIG. 4-1 is a flowchart showing an example of a flow of processing performed by the terminal and the server according to an example embodiment;

FIG. 4-2 is a diagram showing an example of remittance reminding condition data according to an example embodiment;

FIG. 4-3 is a diagram showing an example of a display screen of the terminal according to an example embodiment;

FIG. 4-4 is a diagram showing an example of a display screen of the terminal according to an example embodiment;

FIG. 4-5 is a flowchart showing an example of a flow of processing performed by the terminal and the server according to an example embodiment;

FIG. 5-1 is a diagram showing an example of a display screen of the terminal according to an example embodiment;

FIG. 5-2 is a diagram showing an example of a display screen of the terminal according to an example embodiment;

FIG. 5-3 is a diagram showing an example of a display screen of the terminal according to an example embodiment;

FIG. 5-4 is a flowchart showing an example of a flow of processing performed by the terminal and the server according to an example embodiment;

FIG. 5-5 is a flowchart showing an example of a flow of processing performed by the terminal and the server according to an example embodiment;

FIG. 5-6 is a diagram showing an example of a display screen of the terminal according to an example embodiment;

FIG. 5-7 is a diagram showing an example of a display screen of the terminal according to an example embodiment;

FIG. 5-8 is a diagram showing an example of a table relating to a method for displaying a remittance request message and a remittance reminder message according to an example embodiment;

FIG. 5-9 is a flowchart showing an example of a flow of processing performed by the terminal and the server according to an example embodiment;

FIG. 5-10 is a flowchart showing an example of a flow of processing performed by the terminal and the server according to an example embodiment;

FIG. 5-11 is a diagram showing an example of a display screen of the terminal according to an example embodiment;

FIG. 5-12 is a diagram showing an example of a display screen of the terminal according to an example embodiment;

FIG. 5-13 is a diagram showing an example of a display screen of the terminal according to an example embodiment;

FIG. 5-14 is a diagram showing an example of a display screen of the terminal according to an example embodiment;

FIG. 5-15 is a diagram showing an example of a display screen of the terminal according to an example embodiment;

FIG. 5-16 is a diagram showing an example of a display screen of the terminal according to an example embodiment;

FIG. 5-17 is a diagram showing an example of a display screen of the terminal according to an example embodiment;

FIG. 5-18 is a diagram showing an example of a display screen of the terminal according to an example embodiment;

FIG. 5-19 is a diagram showing an example of a display screen of the terminal according to an example embodiment;

FIG. 5-20 is a diagram showing an example of a display screen of the terminal according to an example embodiment;

FIG. 6-1 is a flowchart showing an example of a flow of processing performed by the terminal and the server according to an example embodiment;

FIG. 6-2 is a flowchart showing an example of a flow of processing performed by the terminal and the server according to an example embodiment;

FIG. 6-3 is a diagram showing an example of a display screen of the terminal according to an example embodiment;

FIG. 6-4 is a diagram showing an example of a display screen of the terminal according to an example embodiment;

FIG. 6-5 is a diagram showing an example of a display screen of the terminal according to an example embodiment;

FIG. 6-6 is a flowchart showing an example of a flow of processing performed by the terminal and the server according to an example embodiment;

FIG. 6-7 is a flowchart showing an example of a flow of processing performed by the terminal and the server according to an example embodiment;

FIG. 6-8 is a diagram showing an example of a display screen of the terminal according to an example embodiment;

FIG. 6-9 is a diagram showing an example of a display screen of the terminal according to an example embodiment;

FIG. 7-1 is a flowchart showing an example of a flow of processing performed by the terminal and the server according to an example embodiment;

FIG. 7-2 is a flowchart showing an example of a flow of processing performed by the terminal and the server according to an example embodiment;

FIG. 7-3 is a diagram showing an example of a table relating to display manners of information relating to a remittance request according to an example embodiment;

FIG. 7-4 is a flowchart showing an example of a flow of processing performed by the terminal and the server according to an example embodiment;

FIG. 7-5 is a flowchart showing an example of a flow of processing performed by the terminal and the server according to an example embodiment;

FIG. 8-1 is a diagram showing an example of remittance request management data according to an example embodiment;

FIG. 8-2 is a diagram showing an example of a remittance reminder determination table according to an example embodiment;

FIG. 8-3 is a diagram showing an example of a display screen of the terminal according to an example embodiment;

FIG. 8-4 is a diagram showing an example of a display screen of the terminal according to an example embodiment;

FIG. 8-5 is a diagram showing an example of a display screen of the terminal according to an example embodiment;

FIG. 8-6 is a diagram showing an example of a display screen of the terminal according to an example embodiment;

FIG. 8-7 is a diagram showing an example of a display screen of the terminal according to an example embodiment;

FIG. 8-8 is a diagram showing an example of a display screen of the terminal according to an example embodiment;

FIG. 8-9 is a diagram showing an example of a display screen of the terminal according to an example embodiment;

FIG. 8-10 is a flowchart showing an example of a flow of processing performed by the terminal and the server according to an example embodiment;

FIG. 8-11 is a diagram showing an example of reminder stop management data according to an example embodiment;

FIG. 9-1 is a diagram showing an example of a remittance reminder determination table according to an example embodiment;

FIG. 9-2 is a diagram showing an example of a display screen of the terminal according to an example embodiment;

FIG. 9-3 is a diagram showing an example of a display screen of the terminal according to an example embodiment;

FIG. 9-4 is a diagram showing an example of a display screen of the terminal according to an example embodiment;

FIG. 9-5 is a diagram showing an example of a display screen of the terminal according to an example embodiment;

FIG. 9-6 is a diagram showing an example of a display screen of the terminal according to an example embodiment;

FIG. 9-7 is a diagram showing an example of a display screen of the terminal according to an example embodiment;

FIG. 9-8 is a diagram showing an example of a display screen of the terminal according to an example embodiment; and

FIG. 9-9 is a diagram showing an example of a display screen of the terminal according to an example embodiment.

### DETAILED DESCRIPTION

The embodiments herein and the various features and advantageous details thereof are explained more fully with reference to the non-limiting embodiments that are illustrated in the accompanying drawings and detailed in the following description, where similar reference characters denote corresponding features consistently throughout. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

In the present specification, the expression “by means of a communication I/F” is used as appropriate. This expression means that a device transmits and receives various types of information and data via the communication I/F (via a communication part) based on control performed by a controller (a processor, etc.), in a non-limiting example.

### System Configuration

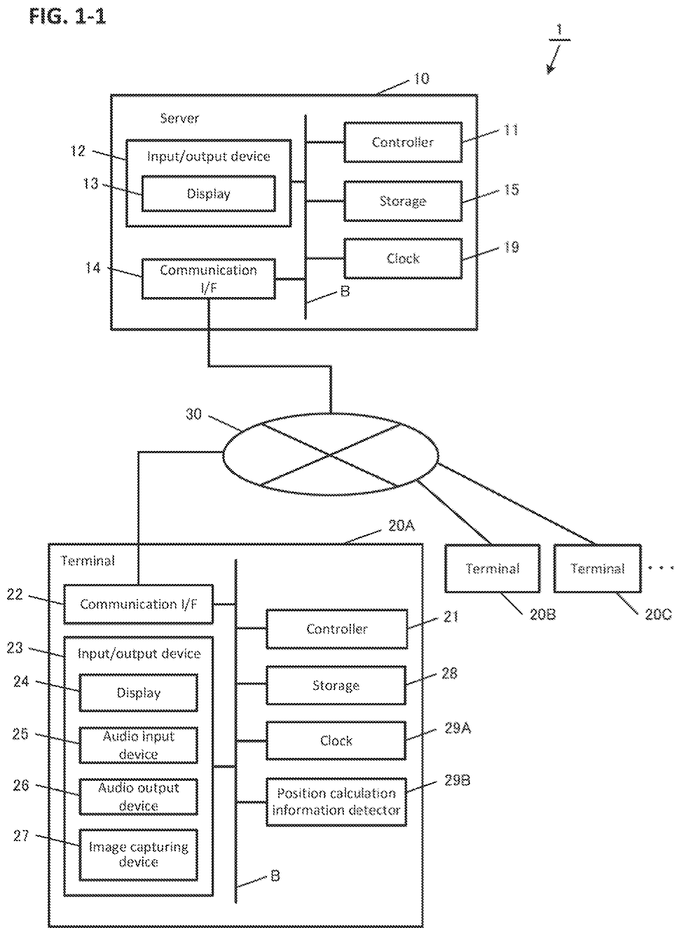

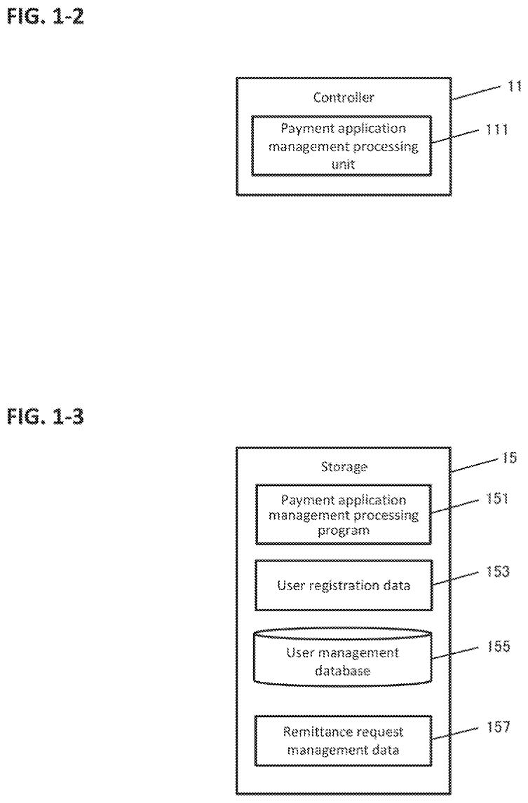

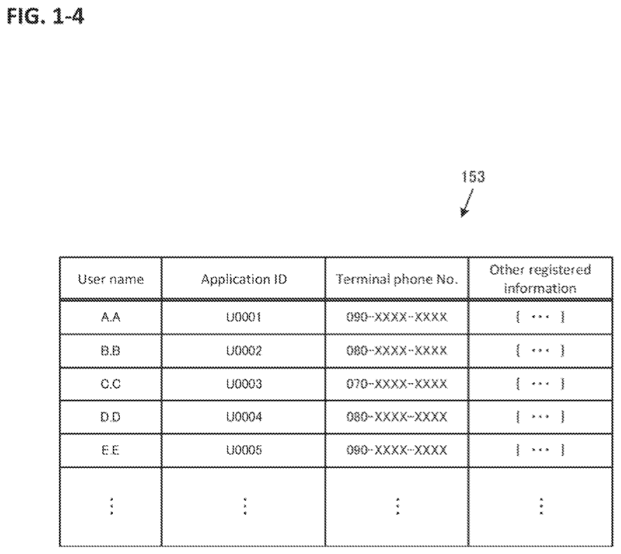

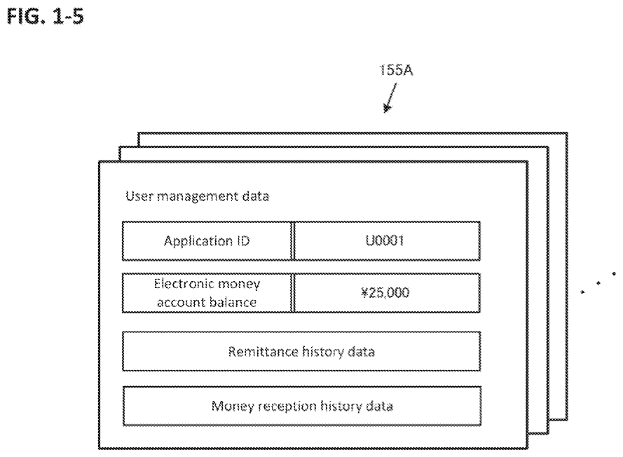

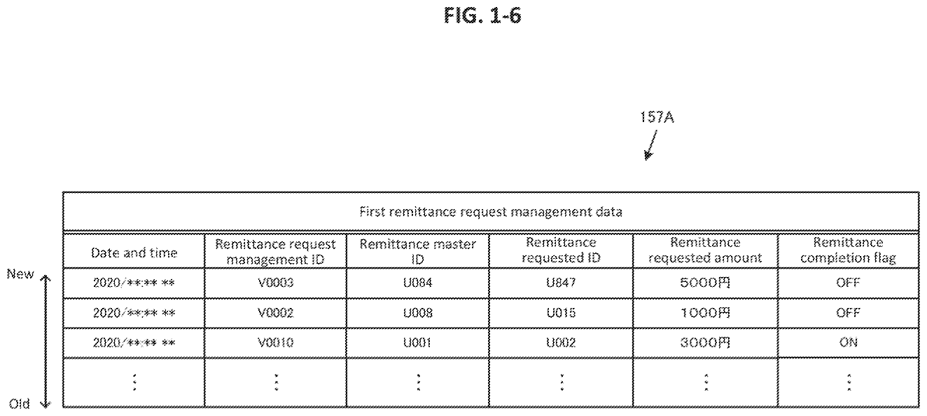

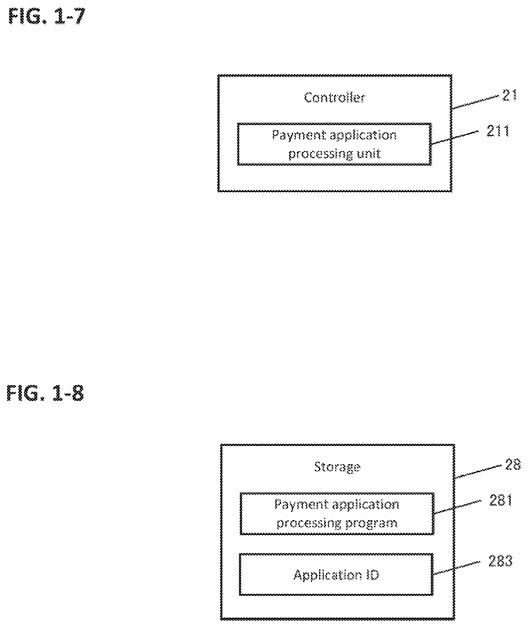

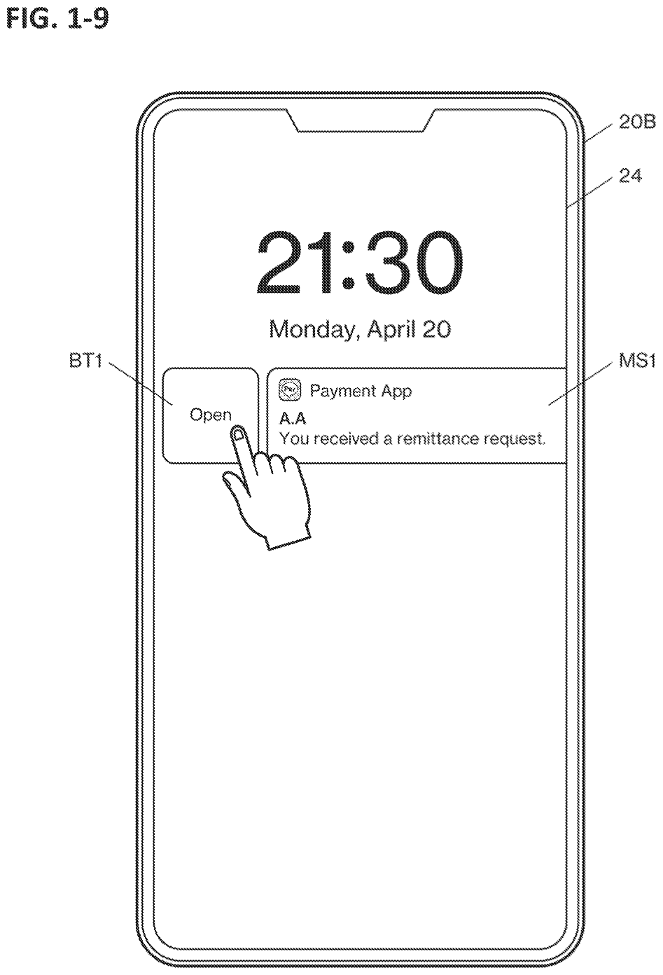

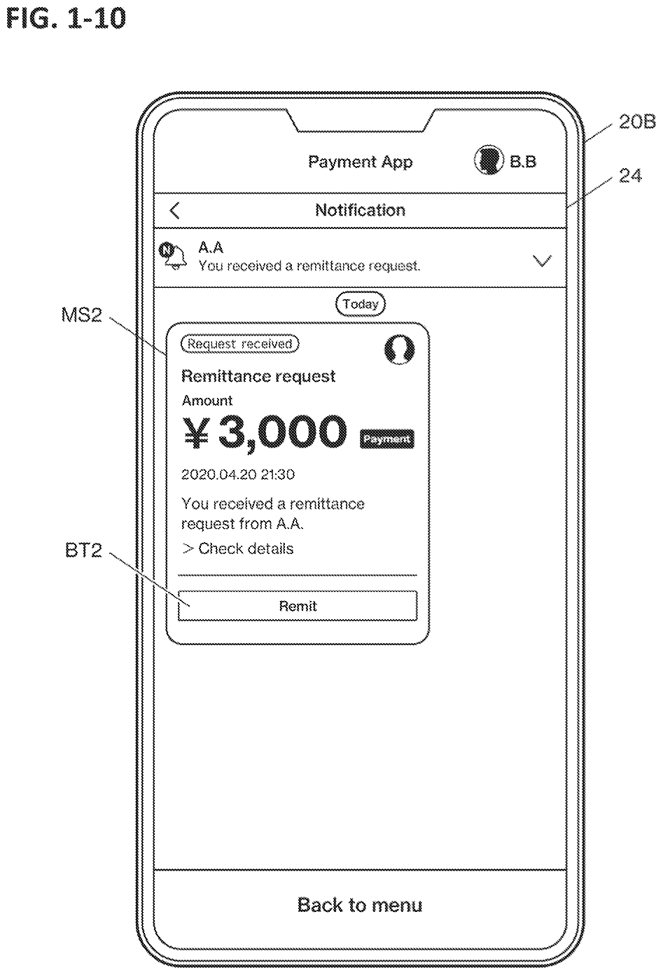

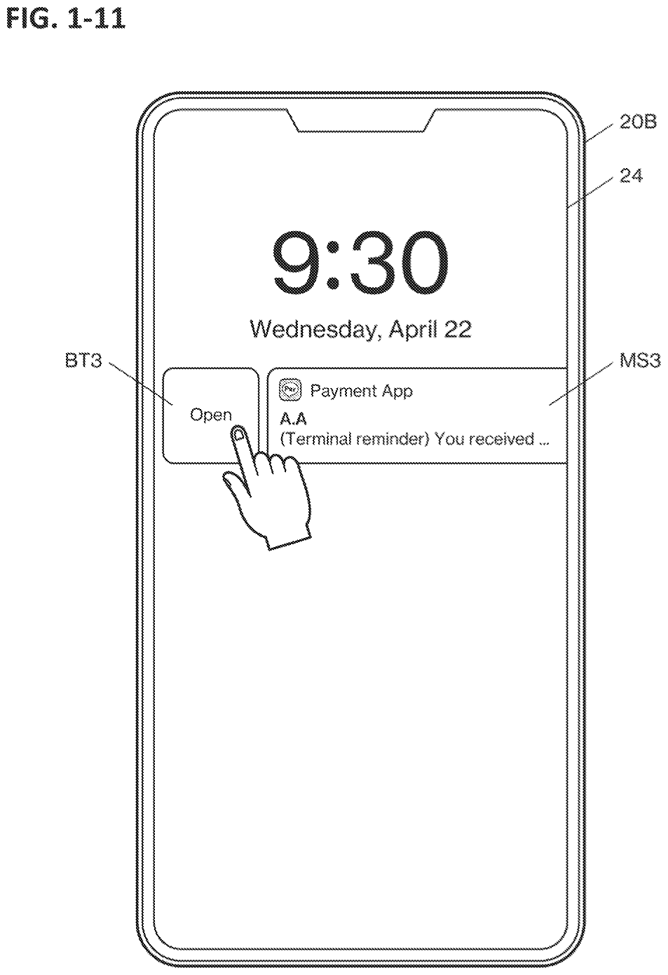

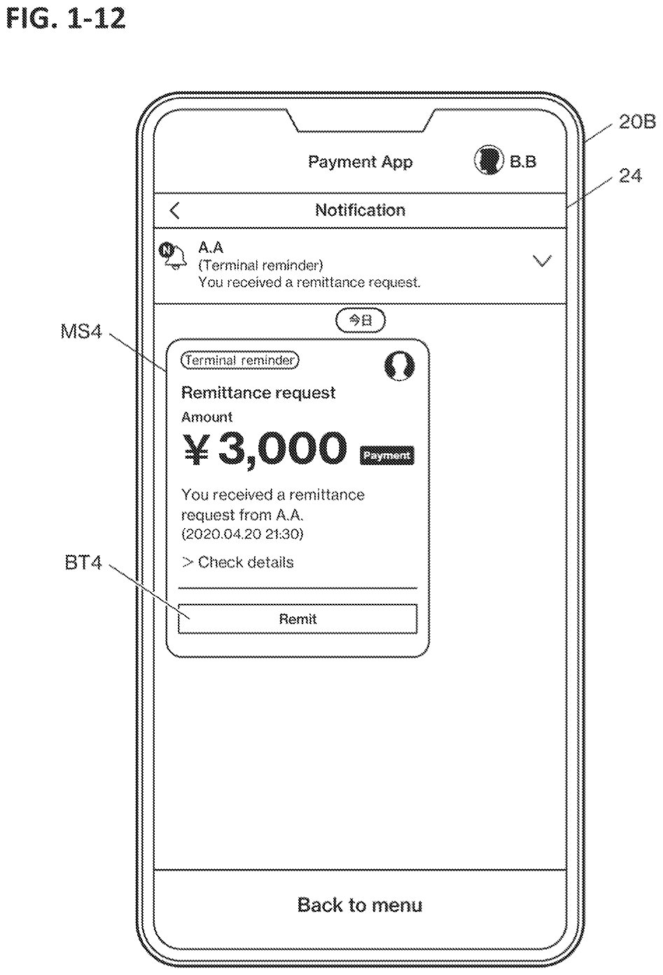

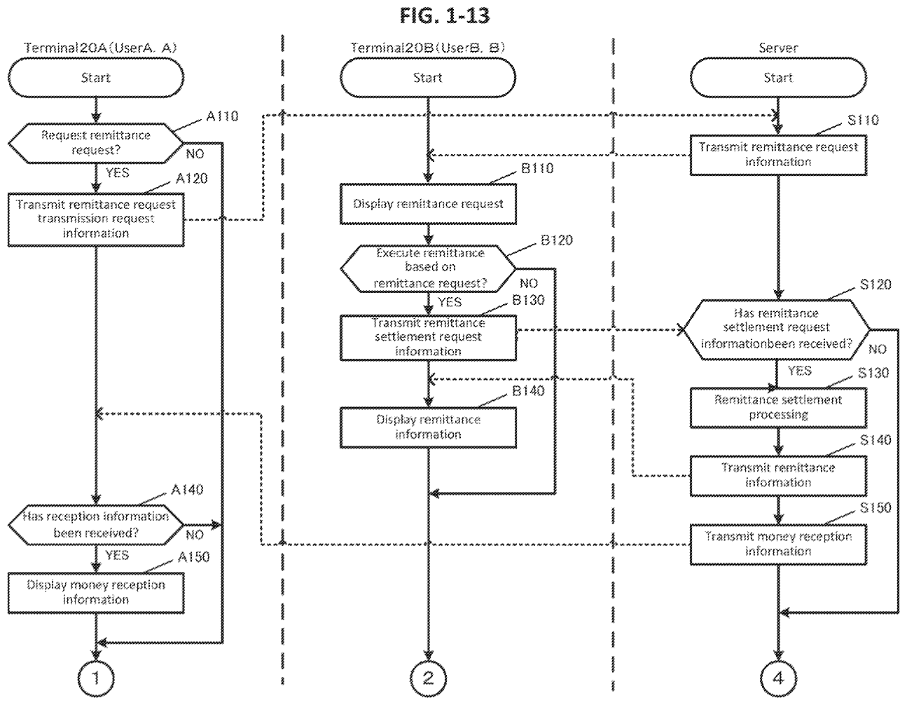

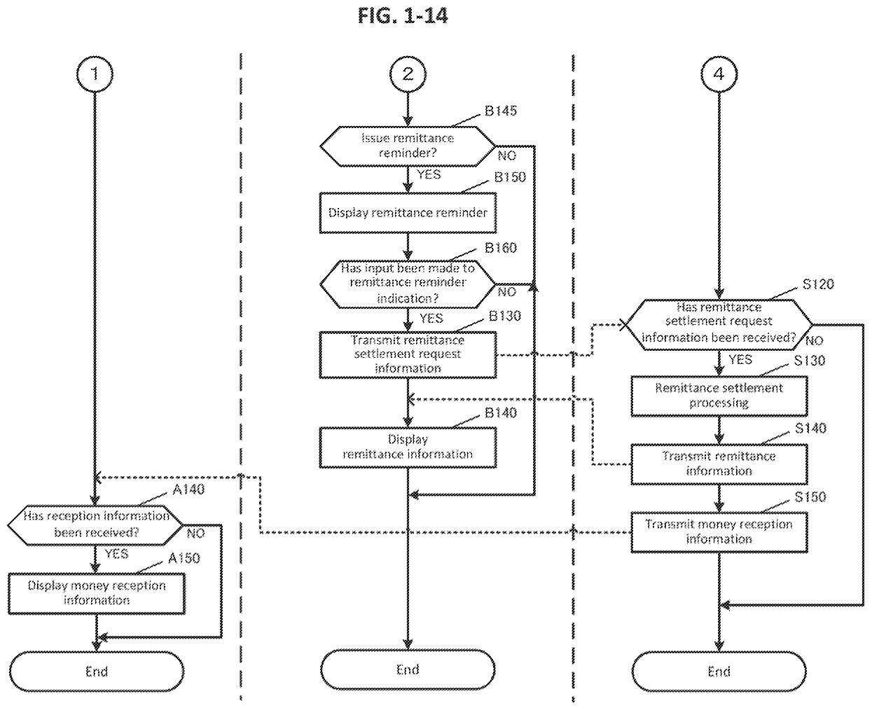

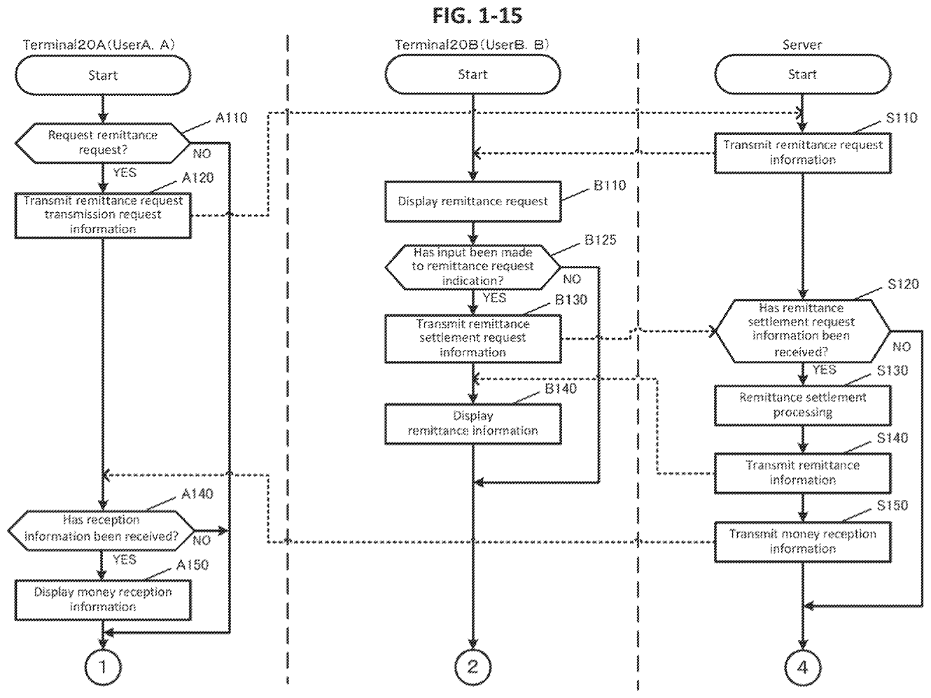

FIG. 1-1 is a diagram showing an example of a system configuration of a communication system 1 in an example embodiment.

In the communication system 1, a server 10 and a plurality of terminals 20 (terminals 20A, 20B, 20C, . . . ) are connected to each other via a network 30, in a non-limiting example.

The server 10 has the function of providing the terminals 20 owned by users with a payment service and a messaging service via the network 30. The server 10 may also be referred to as “a payment management (messaging management) server”, “a payment service (messaging service) server”, or the like.

Each of the terminals 20 (terminals 20A, 20B, 20C, . . . ) may be any information processing terminal that is capable of implementing functions described in various embodiments. Non-limiting examples of the terminals 20 include a smartphone, a mobile phone (a feature phone), a computer (non-limiting examples of which include a desktop, a laptop, and a tablet), a media computer platform (non-limiting examples of which include cable and satellite set-top boxes and a digital video recorder), a handheld computer device (non-limiting examples of which include a personal digital assistant (PDA) and an electronic mail client), a wearable terminal (an eyeglasses-type device, a watch-type device, etc.), a virtual reality (VR) terminal, a smart speaker (an audio recognition device), and other types of computers and communication platforms. The terminals 20 may also be referred to as “information processing terminals”.

The configurations of the terminals 20A, 20B, and 20C are essentially the same. A terminal that is used by a user X will be referred to as a “terminal 20X”, and user information that is associated with the user X or the terminal 20X in a predetermined service will be referred to as “user information X”, as necessary.

The user information is information regarding a user associated with an account that is used by the user in the predetermined service. Non-limiting examples of the user information include information that is input by the user or is assigned by the predetermined service, and is associated with the user, such as the user's name, an icon image of the user, the user's age, the user's sex, the user's address, the user's hobbies/preferences, and the user's identifier, and the user information may optionally be any one of or a combination of two or more of these pieces of information.

The network 30 serves to connect one or more terminals 20 and one or more servers 10 to each other. That is, the network 30 serves as a communication network that provides a connection path to enable the various types of devices described above to transmit and receive data after the devices are connected to each other.

Note that the number of servers 10 and terminals 20 connected to the network 30 is not limited.

One or more portions of the network 30 may optionally be a wired network or a wireless network. Non-limiting examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, integrated service digital networks (ISDNs), a radio LAN, long term evolution (LTE), code division multiple access (CDMA), Bluetooth (registered trademark), satellite communication, and a combination of two or more of these networks. The network 30 may be constituted by a single network 30 or a plurality of networks 30.

The server 10 (a non-limiting example of a server, an information processing device, and an information management derive) has the function of providing a predetermined service (in an example embodiment, a payment service and the like) to the terminals 20. The server 10 may be any information processing device that is capable of implementing functions described in various embodiments. Non-limiting examples of the server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an electronic mail client), and other types of computers and communication platforms. The server 10 may also be referred to as an “information processing device”. If there is no need to distinguish the server 10 and the terminals 20, each of the server 10 and the terminals 20 may optionally be referred to as an “information processing device”.

### Hardware (HW) Configurations of Devices

The HW configurations of the devices included in the communication system 1 will be described.

### HW Configurations of Terminals

FIG. 1-1 shows an example of the HW configuration of each terminal 20.

Each terminal 20 includes a controller 21 (central processing unit: CPU), a storage 28, a communication I/F (interface) 22, an input/output device 23, a clock 29A, and a position calculation information detector 29B. The HW constituent elements of each terminal 20 are connected to each other via a bus B, in a non-limiting example. Note that the HW configuration of each terminal 20 does not necessarily have to include all of the constituent elements. Each terminal 20 may optionally be configured such that one or more constituent elements are removable, in a non-limiting example.

The communication I/F 22 transmits and receives various types of data via the network 30. Communication may be carried out in a wired or wireless manner, and may be based on any communication protocol that enables mutual communication to be carried out. The communication I/F 22 functions to communicate with various types of devices such as the server 10 via the network 30. The communication I/F 22 transmits various types of data to various types of devices such as the server 10 in accordance with instructions from the controller 21. Further, the communication I/F 22 receives various types of data transmitted from various types of devices such as the server 10 and conveys the data to the controller 21. The communication I/F 22 may also be simply referred to as a “communication part”. The communication I/F 22 may also be referred to as a “communication circuit” in cases where the communication I/F is constituted by a physically structured circuit.

The input/output device 23 includes a device that inputs various operations made to the terminal 20 and a device that outputs a result of processing performed by the terminal 20. The input/output device 23 may optionally be constituted by a single device into which an input device and an output device are integrated, or an input device and an output device that are separate from each other.

The input device is implemented by any one of or a combination of two or more of all types of devices capable of accepting input from a user and conveying information regarding the input to the controller 21. Non-limiting examples of the input device include a touch panel, a touch display, hardware keys of a keyboard or the like, a pointing device such as a mouse, a camera (input of operations via moving images), and a microphone (input of operations using voice).

The output device is implemented by any one of or a combination of two or more of all types of devices capable of outputting a result of processing performed by the controller 21. Non-limiting examples of the output device include a touch panel, a touch display, a speaker (audio output), a lens (non-limiting examples of which include 3D (three-dimensional) output and hologram output), and a printer.

In one embodiment, the input/output device 23 includes a display 24, an audio input device 25, an audio output device 26, and an image capturing device 27, in a non-limiting example.

The display 24 is implemented by any one of or a combination of two or more of all types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HDM), and devices capable of displaying images, text information, and the like using projection mapping or holograms, or in the air (may optionally be a vacuum). Note that the display 24 may optionally be capable of displaying display data in 3D.

The audio input device 25 is used to input audio data (which may be speech data). The audio input device 25 includes a microphone and so on.

The audio output device 26 is used to output audio data. The audio output device 26 includes a speaker and so on.

The image capturing device 27 is used to acquire moving image data. The image capturing device 27 includes a camera and so on.

If the input/output device 23 is a touch panel, the input/output device 23 and the display 24 may also have substantially the same size and shape and be arranged opposing each other.

The clock 29A is a built-in clock of the terminal 20 and outputs time information (time measurement information). The clock 29A includes a clock that employs a crystal oscillator, or the like, in a non-limiting example. The clock 29A may also be referred to as a “time measurement device” or a “time information detecting device”, in a non-limiting example.

Note that the clock 29A may optionally include a clock to which NITZ (Network Identity and Time Zone) standards or the like are applied.

The position calculation information detector 29B is a functional unit that detects (measures) information (hereinafter referred to as “position calculation information”) that is necessary for the controller 21 to calculate (measure) the position of the terminal 20. The position calculation information detector 29B may also be referred to as a “position calculation sensor unit”, in a non-limiting example.

Non-limiting examples of the position calculation information detector 29B include a satellite positioning sensor (a satellite positioning unit) that is a sensor or a unit for calculating the position of the terminal 20 using a satellite positioning system such as GPS (Global Positioning System), an inertial measurement sensor (IMU (Inertial Measurement Unit)) that is a sensor or a unit for calculating the position of the terminal 20 using an inertial navigation system, and a ultrawide band (UWB) positioning sensor (UWB positioning unit) that is a sensor or a unit for calculating the position of the terminal 20 using a UWB.

The satellite positioning unit includes an RF (Radio Frequency) receiving circuit that converts RF signals, which include a positioning satellite signal emitted from a positioning satellite and received by an antenna (not illustrated), into digital signals and a baseband processing circuit that captures the positioning satellite signal by performing correlation operation processing or the like on a digital signal output from the RF receiving circuit and outputs information such as satellite orbit data and time data that are taken from the positioning satellite signal, as position calculation information, in a non-limiting example.

The inertial measurement unit includes an inertial sensor that detects information necessary to calculate the position of the terminal 20 through an inertial navigation operation. The inertial sensor includes a three-axis acceleration sensor and a three-axis gyroscope sensor, and outputs acceleration detected by the acceleration sensor and angular velocity detected by the gyroscope sensor, as position calculation information, in a non-limiting example.

The UWB positioning unit includes a ultrawide band RF (Radio Frequency) receiving circuit that converts ultrawide band RF signals, which include a positioning ultrawide band pulse signal emitted from a positioning beacon and received by an antenna (not illustrated), into digital signals and a relative position calculation processing circuit that calculates the position of the terminal 20 relative to the positioning beacon based on digital signals output from the ultrawide band RF receiving circuit, in a non-limiting example.

Note that the UWB positioning unit may optionally cause the terminal 20 to function as a positioning beacon by transmitting a ultrawide band RF signal including a positioning ultrawide band pulse signal from the antenna (not illustrated), in in a non-limiting example.

The controller 21 calculates the position of the terminal 20 at periodical timings or specified timings based on the position calculation information detected by the position calculation information detector 29B, in a non-limiting example. The position of the terminal will be referred to as a “terminal position”, and the calculated terminal position will be referred to as a “calculated terminal position”. The controller 21 associates the calculated terminal position with date and time at which the calculated terminal position is calculated, and stores the calculated terminal position as calculated terminal position history data in the storage 28.

The controller 21 includes a physically structured circuit for executing functions that are implemented in accordance with codes or commands included in a program, and is implemented by a data processing device embedded in hardware, in a non-limiting example. Accordingly, the controller 21 may optionally be referred to as a “control circuit”.

Non-limiting examples of the controller 21 include a central processing unit (CPU), a microprocessor, a processor core, a multiprocessor, an ASIC (Application-Specific Integrated Circuit), and a FPGA (Field Programmable Gate Array).

The storage 28 functions to store various programs and various types of data that are necessary for the terminal 20 to operate. Non-limiting examples of the storage 28 include various storage media such as an HDD (Hard Disk Drive), an SSD (Solid State Drive), a flash memory, a RAM (Random Access Memory), and a ROM (Read Only Memory). The storage 28 may optionally be referred to as a “memory”.

The terminal 20 stores a program P in the storage 28, and the controller 21 executes the program P to perform processing while serving as devices that are included in the controller 21. That is, the program P stored in the storage 28 causes the terminal 20 to implement the functions to be executed by the controller 21. The program P may optionally be referred to as a “program module”.

### (2) HW Configuration of Server

FIG. 1-1 shows an example of the HW configurations of the server 10.

The server 10 includes a controller (CPU) 11, a storage 15, a communication I/F (interface) 14, an input/output device 12, and a clock 19. The HW constituent elements of the server 10 are connected to each other via a bus B, in a non-limiting example. Note that the HW configuration of the server 10 does not necessarily have to include all of the constituent elements. The HW of the server 10 may optionally be configured such that one or more constituent elements are removable, in a non-limiting example.

The controller 11 includes a physically structured circuit for executing functions that are implemented in accordance with codes or commands included in a program, and is implemented by a data processing device embedded in hardware, in a non-limiting example.

The controller 11 is typically a central processing unit (CPU), and may optionally be a microprocessor, a processor core, a multiprocessor, an ASIC, or a FPGA. In the present disclosure, the controller 11 is not limited to these examples.

The storage 15 functions to store various programs and various types of data that are necessary for the server 10 to operate. The storage 15 is implemented by various storage media such as an HDD, an SSD, and a flash memory. However, in the present disclosure, the storage 15 is not limited to these examples. The storage 15 may optionally be referred to as a “memory”.

The communication I/F 14 transmits and receives various types of data via the network 30. Communication may be carried out in a wired or wireless manner, and may be based on any communication protocol that enables mutual communication to be carried out. The communication I/F 14 functions to communicate with various types of devices such as the terminals 20 via the network 30. The communication I/F 14 transmits various types of data to various types of devices such as the terminals 20 in accordance with instructions from the controller 11. Further, the communication I/F 14 receives various types of data transmitted from various types of devices such as the terminals 20 and conveys the data to the controller 11. The communication I/F 14 may also be simply referred to as a “communication part”. The communication I/F 14 may also be referred to as a “communication circuit” in cases where the communication I/F is constituted by a physically structured circuit.

The input/output device 12 is implemented by a device that inputs various operations made to the server 10.

The input device is implemented by any one of or a combination of two or more of all types of devices capable of accepting input from a user and conveying information regarding the input to the controller 11. The input device is implemented by hardware keys, a typical example of which is a keyboard, and a pointing device such as a mouse. Note that the input device may optionally include a touch panel, a camera (input of operations via moving images), or a microphone (input of operations using voice), in a non-limiting example.

The output device is implemented by any one of or a combination of two or more of all types of devices capable of outputting a result of processing performed by the controller 11. Non-limiting examples of the output device include a touch panel, a touch display, a speaker (audio output), a lens (non-limiting examples of which include 3D (three-dimensional) output and hologram output), and a printer.

In one embodiment, the input/output device 12 includes a display 13.

The display 13 is typically implemented by a monitor (non-limiting examples of which include a liquid crystal display and an organic electroluminescence display (OELD)). Note that the display 13 may optionally be a head mounted display (HDM) or the like. Note that the display 13 may optionally be capable of displaying display data in 3D. In the present disclosure, the display 13 is not limited to these examples.

The clock 19 is a built-in clock of the server 10 and outputs time information (time measurement information). The clock 19 includes an RTC (Real Time Clock) as a hardware clock, a system clock, or the like, in a non-limiting example. The clock 19 may also be referred to as a “time measurement device” or a “time information detecting device”, in a non-limiting example.

### (3) Others

The server 10 stores a program P in the storage 15, and the controller 11 executes the program P to perform processing while serving as devices that are included in the controller 11. That is, the program P stored in the storage 15 causes the server 10 to implement the functions to be executed by the controller 11. The program P may optionally be referred to as a “program module”.

The same applies to other devices.

Embodiments of the present disclosure will be described assuming that the embodiments are implemented as a result of CPU(s) of the terminals 20 and/or the server 10 executing the program P.

The same applies to other devices.

Note that the controller 21 of each terminal 20 and/or the controller 11 of the server 10 may optionally implement processing by using not only the CPU(s) including a control circuit, but also a logic circuit (hardware) or a dedicated circuit that is formed on an integrated circuit (an IC (Integrated Circuit) chip or an LSI (Large Scale Integration) chip) or the like. Further, these circuits may optionally be implemented by one or more integrated circuits, and a plurality of types of processing described in the embodiments may optionally be implemented by a single integrated circuit. LSI may be referred to as VLSI, super LSI, ultra LSI, or the like depending on the degree of integration. Accordingly, the controller 21 may optionally be referred to as a “control circuit”.

The same applies to other devices.

The program P (non-limiting examples of which include a software program, a computer program, and a program module) in the embodiments of the present disclosure may optionally be provided in a state where the program is stored in a computer-readable storage medium. The program P can be stored in a “non-transitory tangible medium”. Further, the program P may optionally be a program for implementing some of the functions described in the embodiments of the present disclosure. Furthermore, the program P may optionally be a differential file (differential program) that is configured to implement the functions described in the embodiments of the present disclosure in combination with a program P that is already recorded in a storage medium.

The storage medium may include one or more semiconductor-based or other integrated circuits (ICs, non-limiting examples of which include field programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Further, the storage medium may optionally be referred to as a “memory”.

The server 10 and/or the terminals 20 can implement functions of a plurality of functional units described in the embodiments by reading the program P stored in the storage medium and executing the read program P.

The same applies to other devices.

The program P according to the present disclosure may optionally be provided to the server 10 and/or the terminals 20 via any transmission medium (a communication network, broadcast waves, etc.) that is capable of transmitting the program. The server 10 and/or the terminals 20 implement(s) the functions of the functional units described in the embodiments by executing the program P downloaded via the Internet or the like, in a non-limiting example.

The same applies to other devices.

The embodiments of the present disclosure can also be implemented in the form of a data signal in which the program P is embodied through electronic transmission.

At least a portion of processing executed in the server 10 and/or the terminals 20 may optionally be implemented through cloud computing constituted by one or more computers.

At least a portion of processing executed in the terminals 20 may optionally be carried out by the server 10. In this case, the server 10 may optionally carry out at least a portion of processing carried out by functional units of the controller 21 of each terminal 20.

At least a portion of processing executed in the server 10 may optionally be carried out by the terminals 20. In this case, the terminals 20 may optionally carry out at least a portion of processing carried out by functional units of the controller 11 of the server 10.

In the embodiments of the present disclosure, configurations for determination are not essential unless explicitly mentioned otherwise, and predetermined processing may be activated when a determination condition is satisfied, or predetermined processing may be activated when a determination condition is not satisfied, without limitation thereto.

The program according to the present disclosure is implemented using a script language such as ActionScript or JavaScript (registered trademark), a compiler language such as Objective-C or Java (registered trademark), or a markup language such as HTMLS, for example, although there is no limitation thereto.

The following describes embodiments in which the present disclosure is implemented by a server client system.

However, the present disclosure can be implemented by not only the server client system but also a system that does not include a server. Non-limiting examples of such a system include the following.

A system (distributed system) in which the terminals 20 have the functions of the server. Such a system can be realized using a block chain technology, in a non-limiting example.

A system in which the terminals 20 perform wireless communication with each other. Such a system can be realized by using a short-range wireless communication technology such as Bluetooth to perform communication in a P2P (peer to peer) method.

In the following description, the expression “by means of a communication I/F” is used as appropriate. This expression means that a device transmits and receives various types of information and data via the communication I/F (via a communication part) based on control performed by a controller (a processor, etc.), in a non-limiting example.

### Outline

Recent years have seen widespread use of applications (application software) relating to network services such as applications (payment applications) for making payments using electronic money, applications (settlement applications) for making settlements using electronic money, applications (remittance applications) for sending and receiving electronic money, and applications into which some or all functions of these applications are integrated, and users of the terminals 20 can use various services in which electronic money is used by using these applications.

“Electronic money” refers to electronic money that is distinguished from physical money and is possessed by the terminals 20 managed in the various applications described above or the users of the terminals 20.

Note that electronic money may optionally be referred to as “digital currency (digital money)”.

Also, legal tender or a virtual currency may also be used as “electronic money” or “digital currency (digital money)”.

Also, cryptocurrency (crypto-assets) may also be included in “electronic money” or “digital currency (digital money)”.

Also, physical money such as coupons may also be included in a virtual currency.

In the present specification, the term “electronic money” is basically used, and the balance of an electronic money account of a user of a terminal 20 will be referred to as an “electronic money account balance”, in a non-limiting example.

In the following description, a request that is made by a user of a terminal 20 to ask a user (a counterpart user) of another terminal 20 to send money will be referred to as a “remittance request”. Information relating to this remittance request will be referred to as “remittance request information”.

Requesting remittance may also be referred to as “making a remittance request”, “issuing a remittance request”, or the like.

Also, being requested to remit may also be referred to as “receiving a remittance request”, “getting a remittance request”, or the like.

The term “remittance reminding” used in the following description has the meaning of making the counterpart user remember, recall, or check again the content of a remittance request, for example, and information relating to remittance reminding will be referred to as “remittance reminder information”.

Reminding someone to remit may also be referred to as “issuing a remittance reminder”, “performing remittance reminding”, or the like.

Also, being reminded of remittance may also be referred to as “getting a remittance reminder”, “receiving a remittance reminder”, or the like.

In the following description, a user who requests remittance will be referred to as a “remittance master user”, and a user who is requested to remit will be referred to as a “remittance requested user”, for the sake of convenience.

The remittance master user may also be referred to as a “remittance request source user”, a “remittance requesting user”, or the like.

The following describes various types of processing according to the present disclosure as processing that is executed through a payment application or a messaging application installed in the terminals 20. In this case, functions of a messaging service may be included in functions of the payment application, or functions of a payment service may be included in functions of the messaging application, although there is no limitation thereto.

The messaging service is configured to enable users to chat using a chat room.

The chat room is a virtual room for enabling one or more users of the terminals 20 to communicate with each other using a data communication line in a computer network.

In the messaging service, the chat room may also be referred to as a “talk room”.

Non-limiting examples of the talk room include a talk room for enabling one-to-one talks between users, as well as a group talk room for enabling talks between a plurality of users included in a group that is formed in the messaging service.

The messaging service may optionally include an instant messaging service (IMS) that enables transmission and reception of contents such as simple messages between the terminals 20.

Note that the messaging service (MS including IMS) can also be considered as being a form of a social networking service (SNS).

Accordingly, the messaging service (MS) and the social networking service (SNS) may be distinguished from each other, but do not necessarily have to be distinguished from each other.

In the following embodiments, remittance reminding is performed after a remittance request is issued from a remittance master user to a remittance requested user. Then, remittance from the remittance requested user to the remittance master user is implemented based on input that is made to an indication (hereinafter referred to as a “remittance reminder indication”) displayed in the terminal 20 of the remittance requested user based on remittance reminder information.

### First Example Embodiment

In an example embodiment, the terminal 20 of the remittance requested user automatically displays the remittance reminder indication based on a received remittance request. Hereinafter, this method will be referred to as “terminal reminding”.

Matter described in an example embodiment can also be applied to other embodiments and modifications.

Constitutional elements that are the same as those already described are denoted with the same reference numerals as those used for corresponding elements, and a redundant description thereof is omitted.

### Functional Configuration

### (1) Server

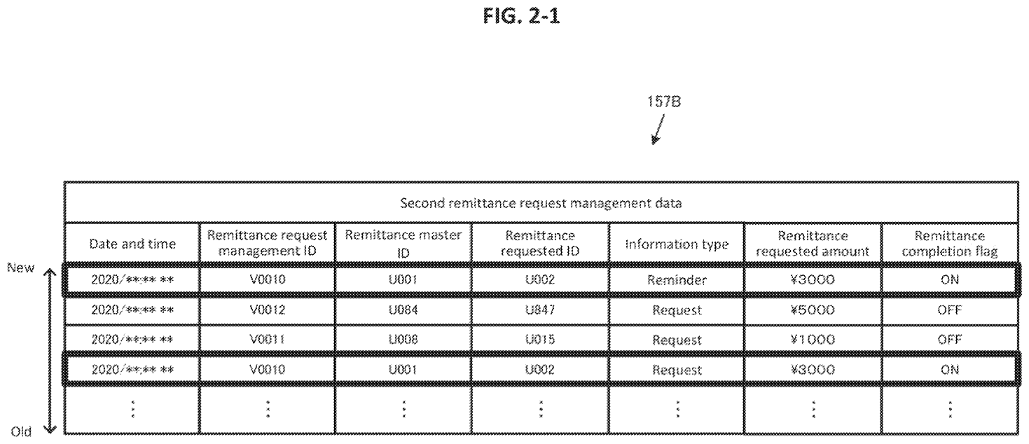

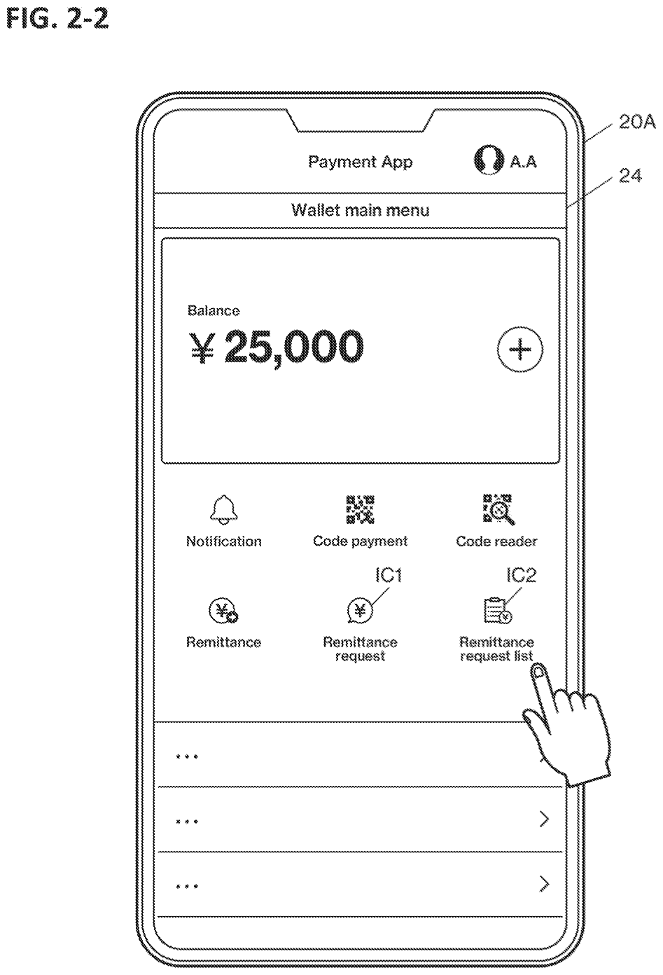

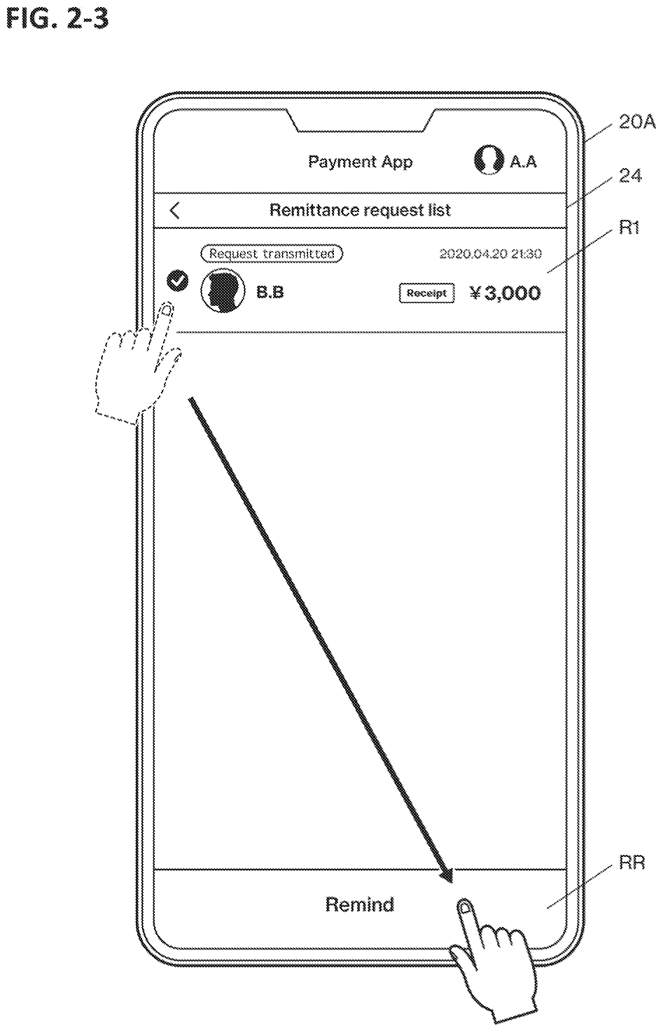

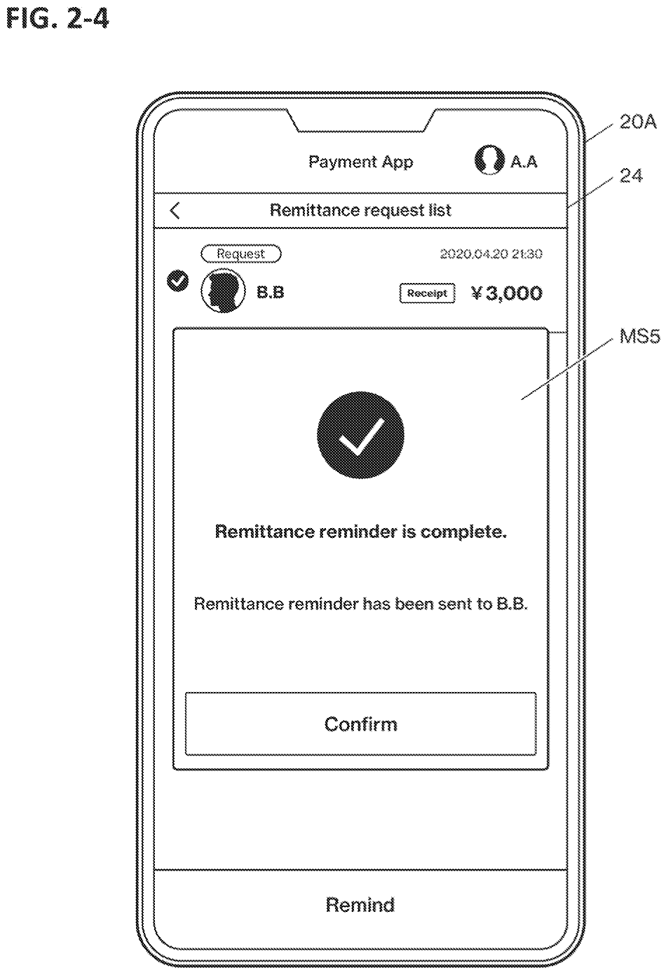

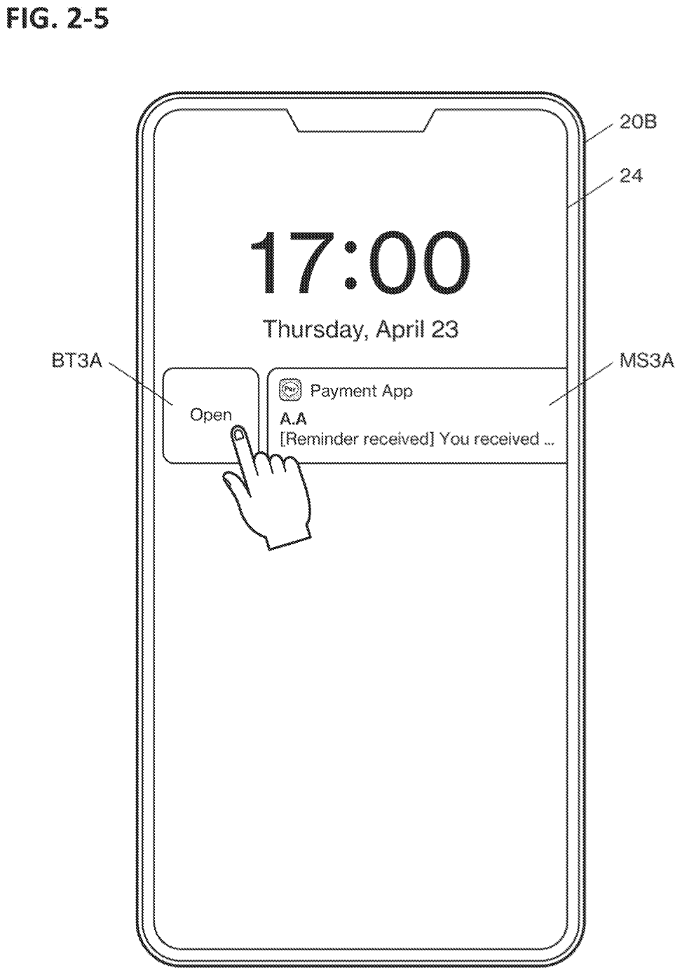

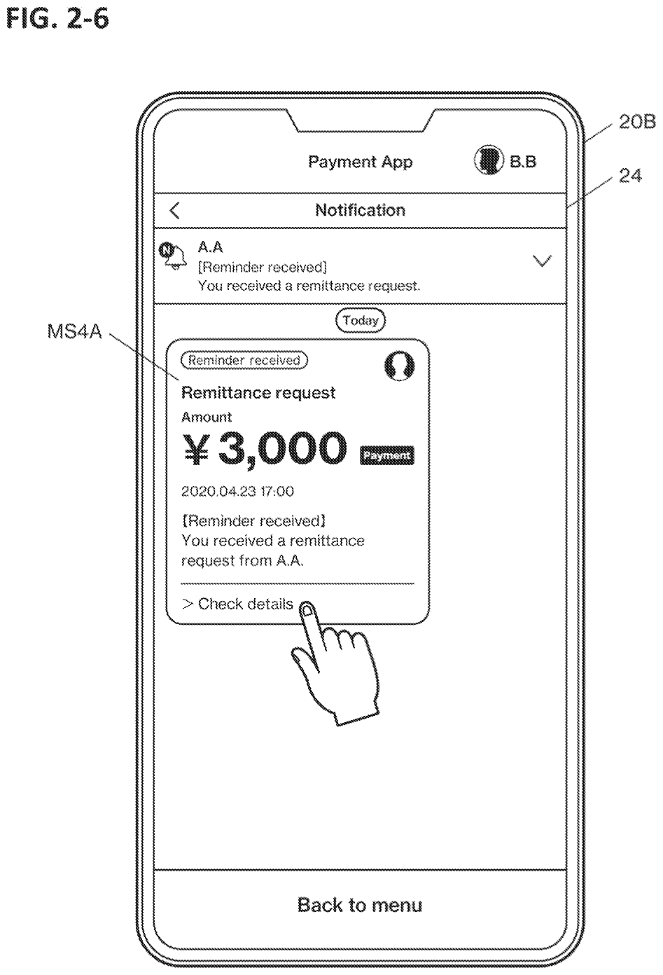

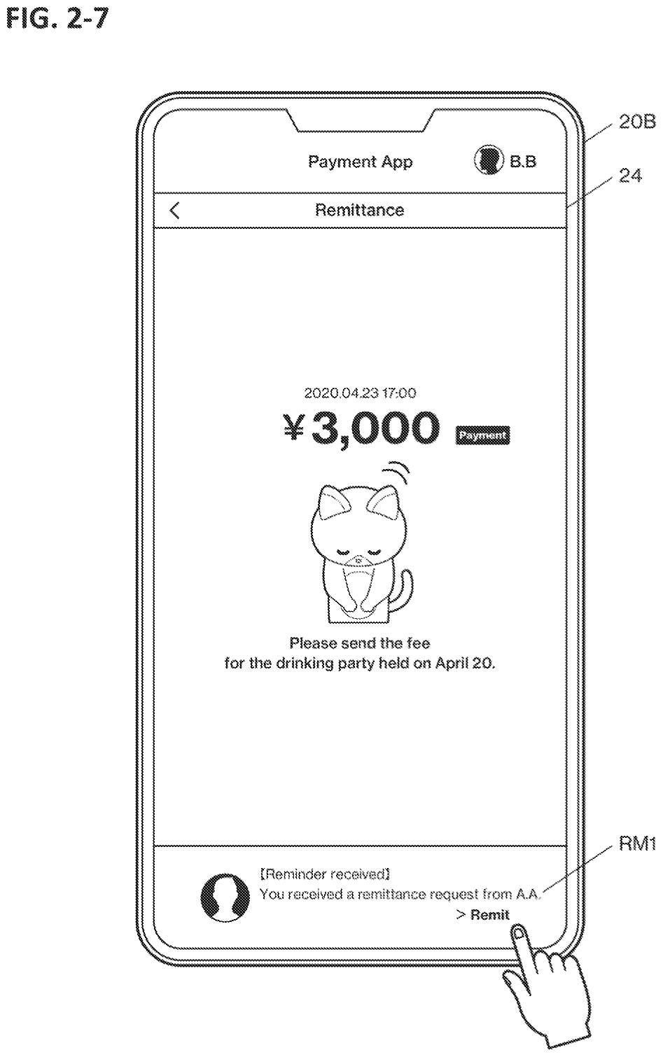

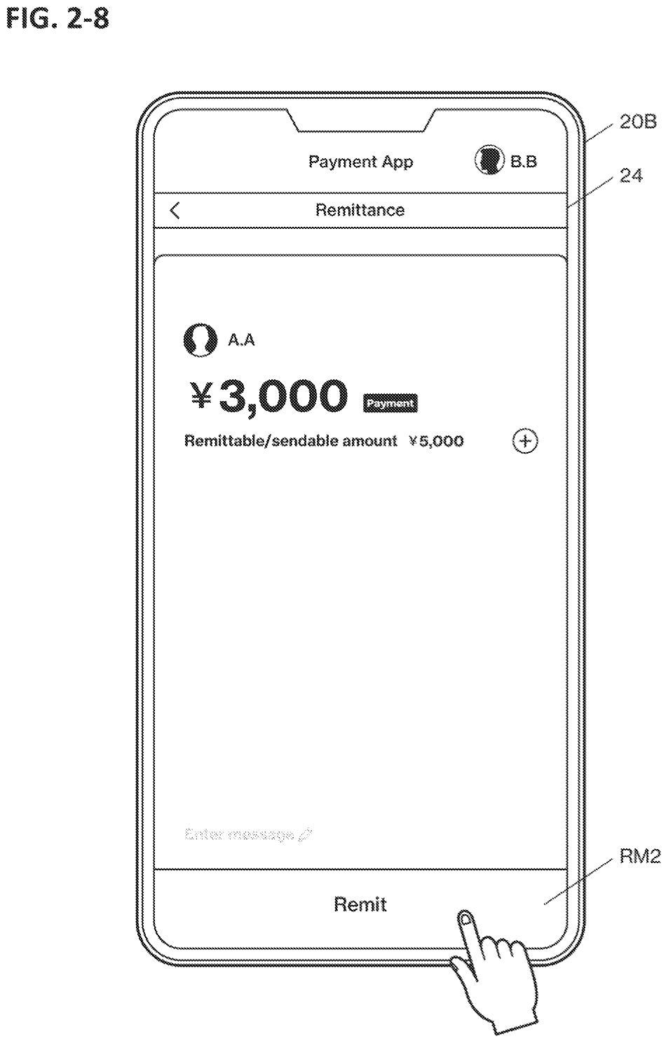

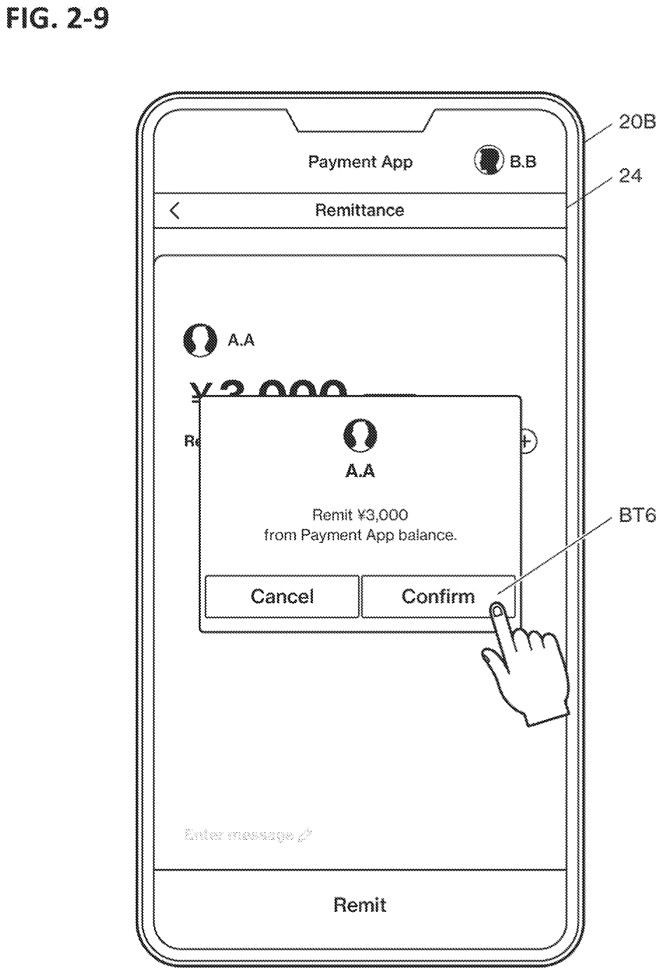

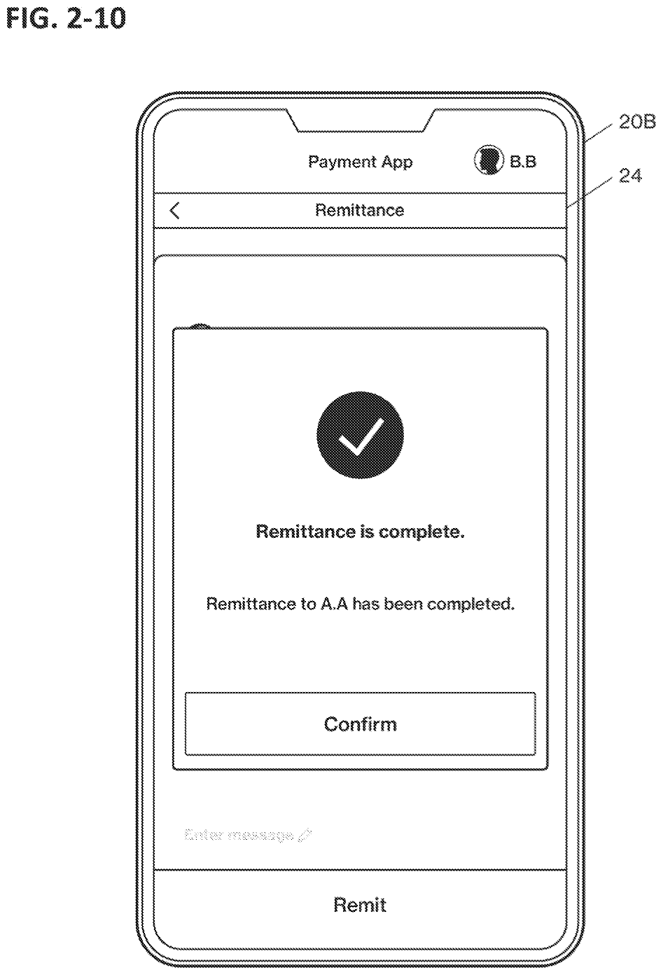

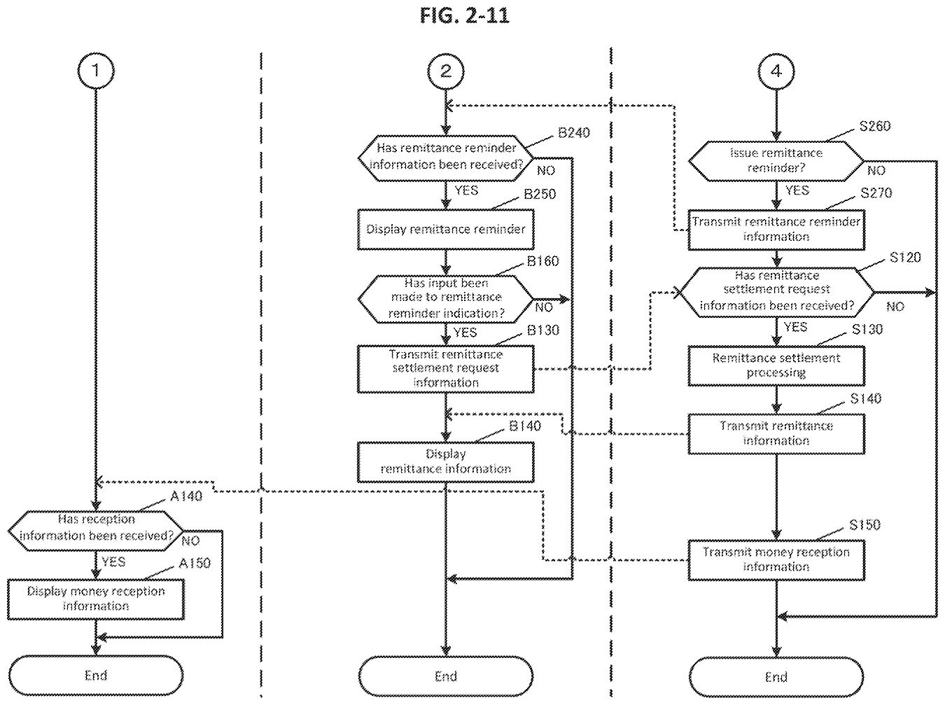

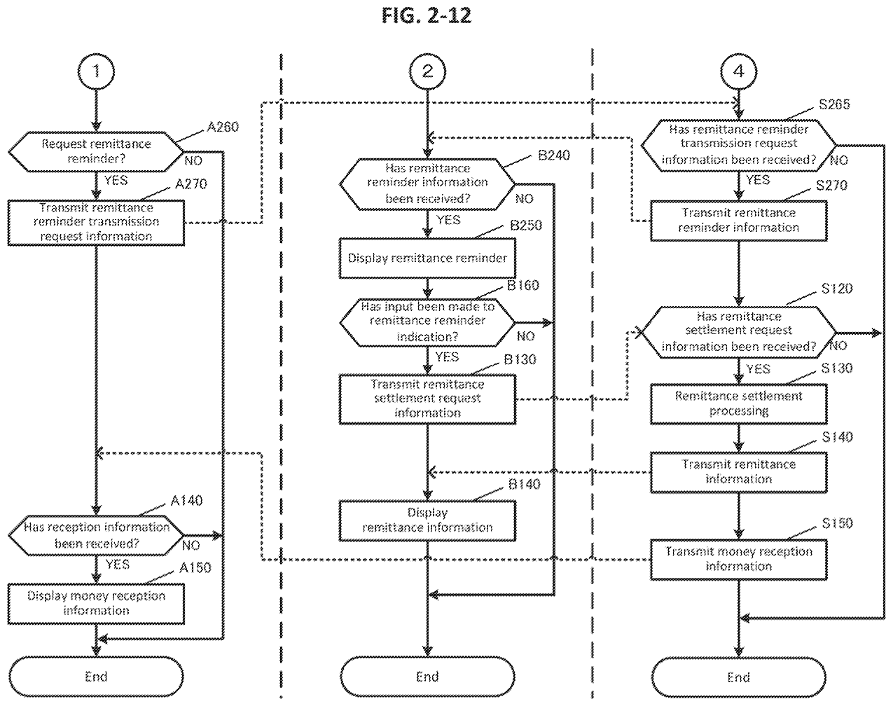

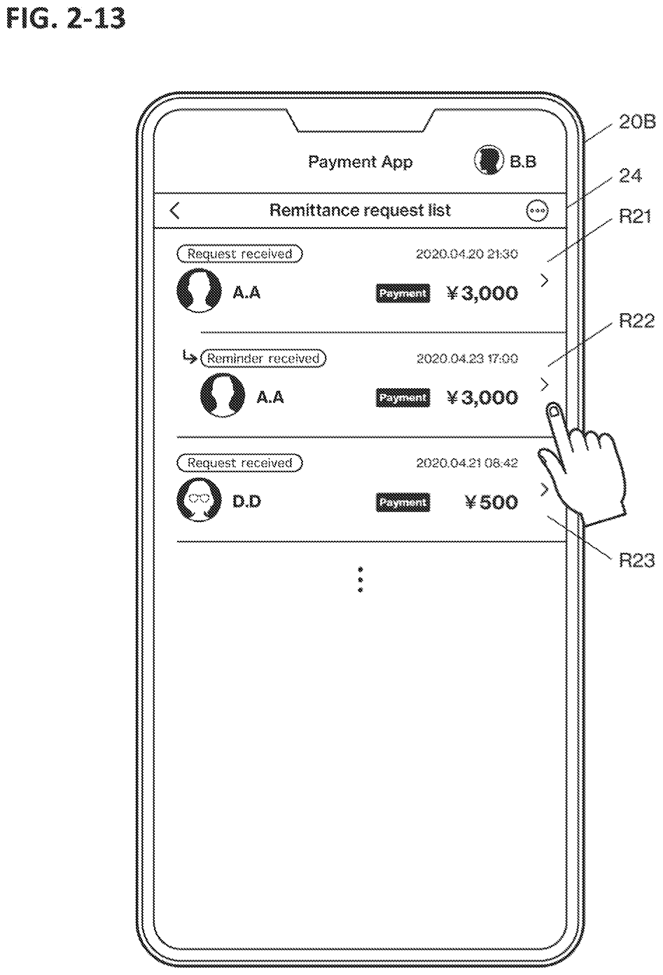

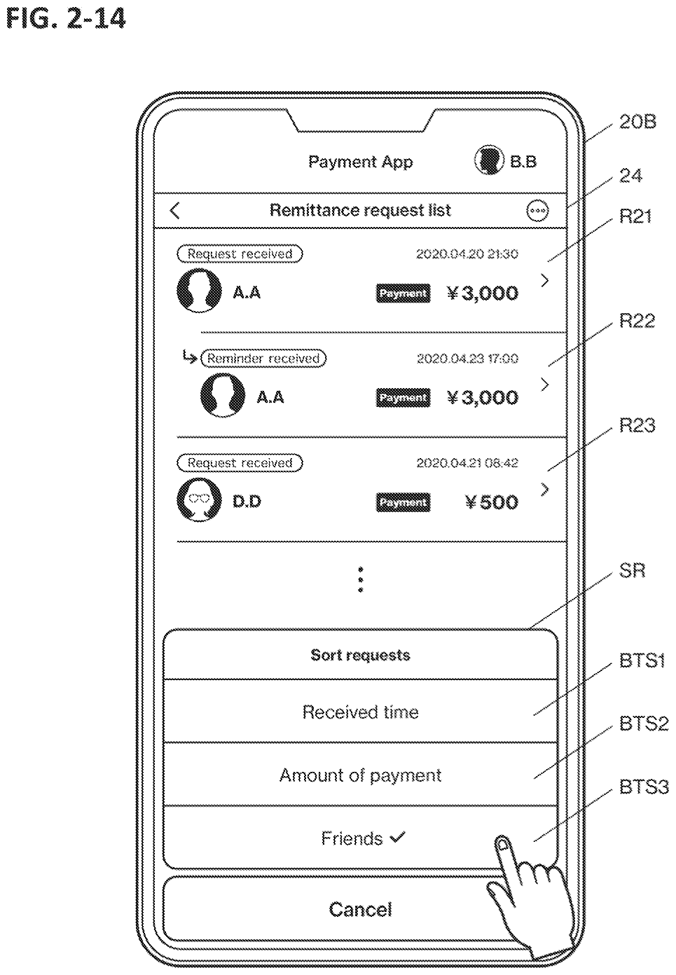

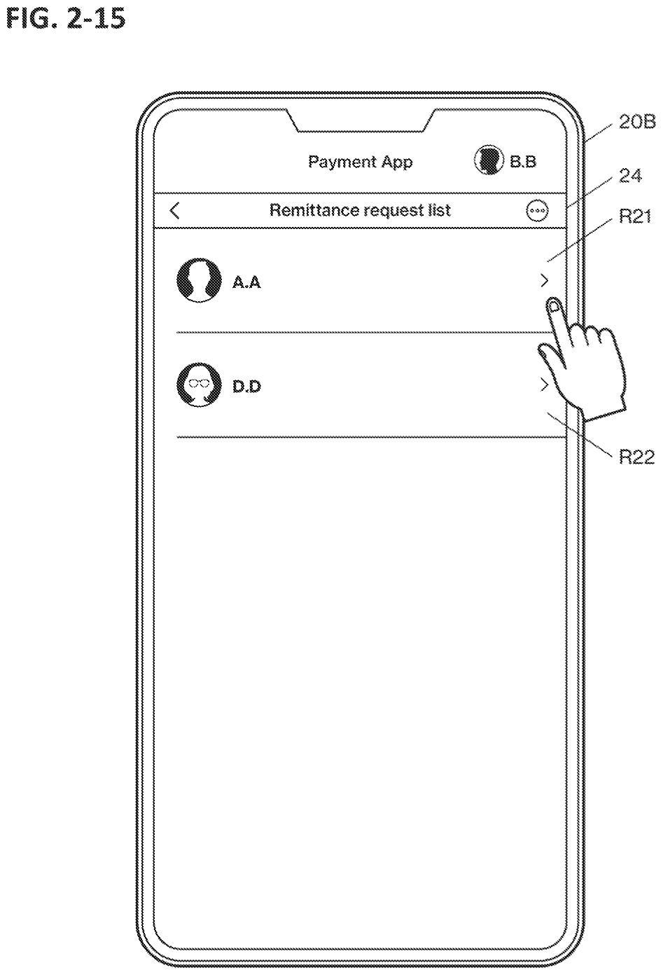

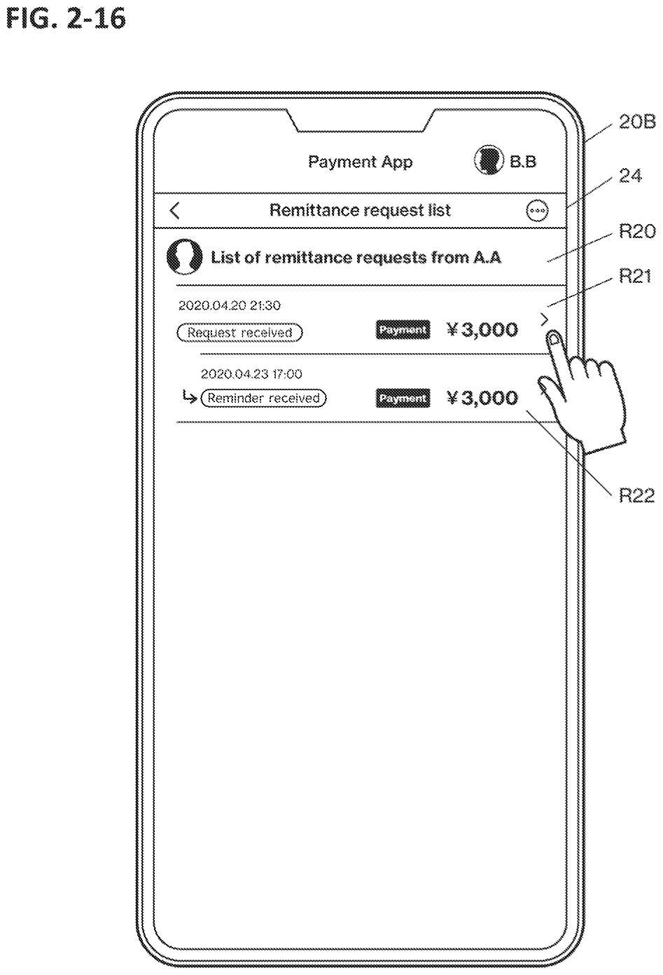

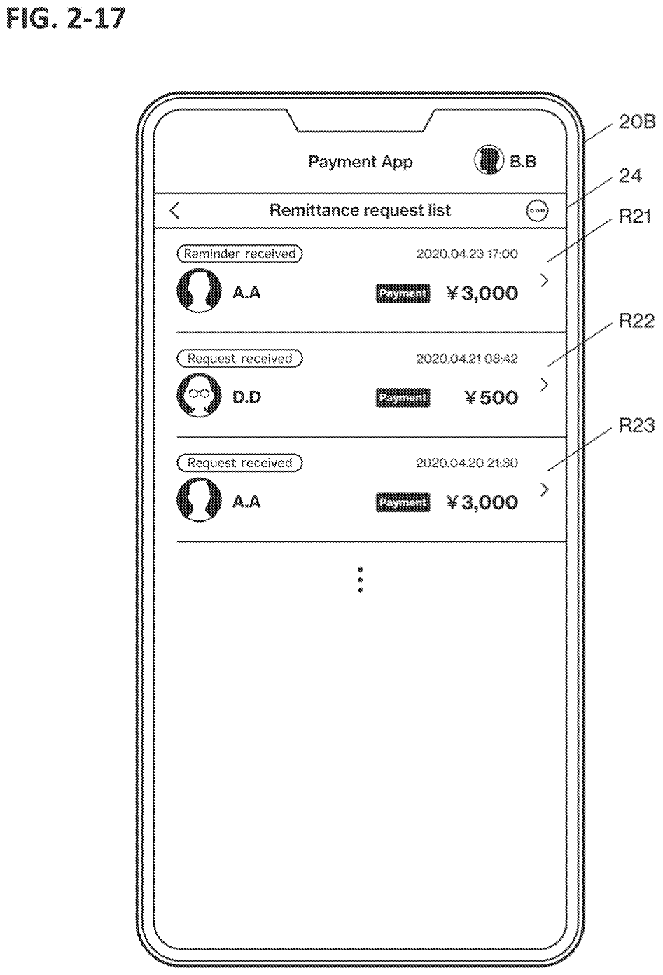

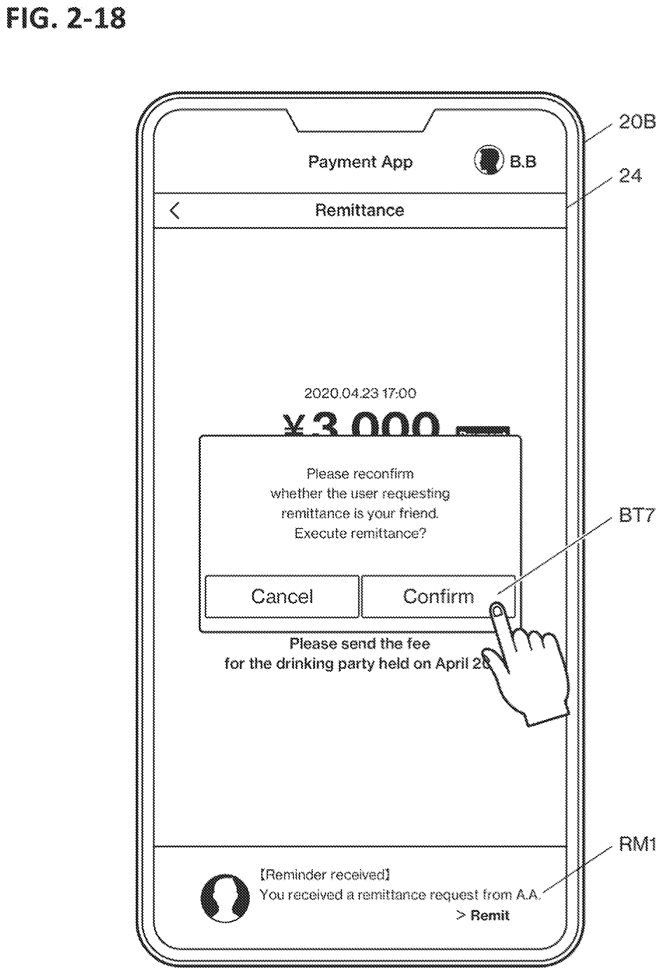

FIG. 1-2 is a diagram showing an example of functions implemented by the controller 11 of the server 10 in an example embodiment.

In a non-limiting example, the controller 11 of the server 10 includes, as a functional unit, a payment application management processing unit 111 that performs processing for providing the terminals 20 or users of the terminals 20 with various payment services realized by the payment application, in accordance with a payment application management processing program 151 that is stored in the storage 15.

FIG. 1-3 is a diagram showing an example of information stored in the storage 15 of the server 10 in an example embodiment.

In a non-limiting example, the storage 15 stores the payment application management processing program 151 that is read by the controller 11 and executed as payment application management processing, user registration data 153, a user management database 155, and remittance request management data 157.

The user registration data 153 is registered data regarding the terminals 20 that use the payment application, or users of the terminals 20, and FIG. 1-4 shows an example of the data configuration.

In a non-limiting example, a user name, an application ID, a terminal phone number, and other registered information are stored in association with each other in the user registration data 153.

The user name is the name of a user of a terminal 20 that uses the payment application. In a non-limiting example, a name that is registered by the user of the terminal 20 to use the payment application is stored as the user name.

The application ID is information that is used to identify an account of the payment application, or the account itself

The application ID may be a value that is unique to the account. In a non-limiting example, a unique value (specific value) is set for each account by the server 10 and stored as the application ID.

The application ID is information associated with the terminal 20 or the user of the terminal 20, and is an example of information regarding the terminal or information regarding the user of the terminal.

The terminal phone number is the phone number of the terminal 20 of the user having the user name. In a non-limiting example, a phone number of the terminal 20 that is registered by the user of the terminal 20 to use the payment application is stored as the terminal phone number.

In a non-limiting example, the other registered information may include an ID of the terminal 20 (terminal ID, a non-limiting example of which is International Mobile Equipment Identity (IMEI)), an email address of the terminal 20 (terminal email address) of the user having the user name, and authentication information such as a password (login password, authentication password, etc.) that is used for various types of authentication in the payment application.

In a non-limiting example, identification information for identifying the terminal 20 may be the terminal ID.

Also, in a non-limiting example, identification information for identifying the user of the terminal 20 may be the application ID. Note that the application ID may be optionally referred to as a “user ID”.

In the case of an application in which only one account can be registered for each terminal 20, the identification information for identifying the terminal 20 may be the same as the identification information for identifying the user of the terminal 20, which is the application ID, although there is no limitation thereto.

Note that a plurality of terminal IDs may optionally be allocated to a single user ID, in a non-limiting example.

The user management database 155 is a database in which data for managing information regarding the terminals 20 using the payment application or users of the terminals 20 is accumulatively stored. FIG. 1-5 shows an example of the configuration of a first user management database 155A, which is an example of the user management database 155.

In the first user management database 155A, user management data is stored as management data for each application ID.

In a non-limiting example, each user management data includes an application ID, an electronic money account balance of the user identified based on the application ID, remittance history data, and money reception history data.

Information (remittance history information) regarding a history of remittance from the user having the application ID to users having other application IDs is stored as the remittance history data.

Information (money reception history information) regarding a history of money that the user having the application ID received from users having other application IDs is stored as the money reception history data.

The remittance request management data 157 is a database in which data for managing information relating to remittance requests is accumulatively stored. FIG. 1-6 shows an example of the configuration of first remittance request management data 157A, which is an example of the remittance request management data 157.

In a non-limiting example, date and time, a remittance request management ID, a remittance master ID, a remittance requested ID, a remittance requested amount, and a remittance completion flag are stored in association with each other in the first remittance request management data 157A.

In a non-limiting example, the date and time at which remittance request information of a corresponding remittance request was transmitted from the server 10 to the terminal 20 of the remittance requested user are stored as the date and time.

An ID that is uniquely set for each remittance request by the server 10 is stored as the remittance request management ID.

The application ID of the remittance master user is stored as the remittance master ID.

The application ID of the remittance requested user is stored as the remittance requested ID.

An amount that the remittance master user requested the remittance requested user to remit in the remittance request is stored as the remittance requested amount.

The remittance completion flag is a flag for discerning whether or not a remittance corresponding to the remittance request has been completed. The remittance completion flag is initially set to “OFF” and is set to “ON” upon completion of the remittance.

Here, methods with which the server 10 manages remittance requests are roughly sorted into the following two patterns.

Pattern A: remittance requests for which remittance has been completed (remittance completion flag: ON) are left without being deleted.

Pattern B: remittance requests for which remittance has been completed (remittance completion flag: ON) are deleted.

Either pattern can be applied, but the method of pattern A is basically applied in the following description.

That is, the server 10 does not delete data of remittance requests for which the remittance completion flag is set to “ON” but rather leaves the data.

### (2) Terminal

FIG. 1-7 is a diagram showing an example of functions implemented by the controller 21 of the terminal 20 in an example embodiment.

In a non-limiting example, the controller 21 includes, as a functional unit, a payment application processing unit 211 that executes payment application processing in accordance with a payment application processing program 281 that is stored in the storage 28.

FIG. 1-8 is a diagram showing an example of information stored in the storage 28 of the terminal 20 in an example embodiment.

In a non-limiting example, the storage 28 stores the payment application processing program 281 that is read by the controller 21 and executed as the payment application processing and an application ID 283 that is associated with the terminal 20 or the user of the terminal 20. Display Screen

The following describes a case where the terminal 20 is a smartphone including a vertically elongated display as the display 24, although there is no limitation thereto.

In a non-limiting example, the smartphone includes a touch panel that serves as an input device and is arranged opposing the display, and the touch panel and the display constitute a touch screen. When an element such as an icon, a button, an item, or an entry field is displayed in the display and the user performs an operation on a region of the touch panel opposing the region in which the element is displayed, a program that is associated with the element or a subroutine of the program is executed.

In the following description, tapping (tap operation) is described as a non-limiting example of the operation performed by the user.

Tapping (tap operation) refers to motions of the user touching the display 24 (touch screen) integrated with the touch panel by hitting the display with a light blow using his or her finger, a pen point, or the like, for example, and then removing it from the display.

Note that the following transitions of display screens are merely examples of transitions of display screens that realize the method of the present disclosure. In the following examples of transitions of display screens, some display screens may be omitted, or another display screen may be added.

FIG. 1-9 is a diagram showing an example of a screen displayed in the display 24 of the terminal 20 in an example embodiment.

A remittance request indication MS1 that notifies the user of the terminal 20 (user of the payment application) of reception of remittance request information is displayed in the display 24 based on functions of the payment application executed by the terminal 20.

In a non-limiting example, the remittance request indication MS1 is a notification (hereinafter referred to as a “push notification”) that is displayed in the manner of push notification, and includes the text “Payment App” and an icon indicating that the indication is displayed based on functions of the payment application, and a message (a non-limiting example of which is “A.A”, “You received a remittance request.”) notifying the user of reception of the remittance request information and the user name of a first user requesting remittance.

Also, a button BT1 for checking detailed information regarding the remittance request is displayed on the left of the remittance request indication MS1.

The remittance request indication MS1 and the button BT1 are non-limiting examples of a first indication that is displayed based on reception, by the terminal 20, of first information (a non-limiting example of which is the remittance request information) relating to the remittance request from the first user (in this example, A.A).

When the user taps the button BT1 showing the text “Open”, details of the remittance request are displayed based on functions of the payment application.

FIG. 1-10 shows a case where the user of the terminal 20 that received the remittance request information is B.B. That is, as a result of the user B.B of the terminal 20 tapping the button BT1 shown in FIG. 1-9, the screen shifts to the screen shown in FIG. 1-10.

The text “Payment App” is displayed at the center of the top of the screen, indicating that the screen is based on functions of the payment application. An icon image and the user name (in this example, “B.B”) of the user of the terminal 20 in the payment application are displayed on the right of the text.

Also, the user name of the first user and a message (a non-limiting example of which is “A.A”, “You received a remittance request.”) indicating reception of the remittance request information from the first user are displayed below.

Also, a remittance request indication MS2 showing details of the remittance request is displayed further below.

The remittance request indication MS2 includes: an icon (in this example, icon showing the text “Request received”) indicating that the indication is displayed based on reception of the remittance request information; an icon image of the first user (A.A) requesting remittance; an amount (in this example, “\3,000”) that is specified by the remittance request information as the amount to be remitted from the user (B.B) of the terminal 20 to the first user; an icon (in this example, icon showing the text “Payment”) notifying the user of the terminal 20 that the amount is to be paid by the user; date and time (in this example, “2020.04.20 21:30”) at which the terminal 20 received the remittance request information; a message (in this example, “You received a remittance request from A.A”) indicating the user name of the first user and reception of the remittance request information from the first user; and link information (in this example, the area in which the text “>Check details” is displayed) for displaying more detailed information regarding the remittance request.

Furthermore, the remittance request indication MS2 includes a remittance button BT2 for executing remittance processing for the first user (A.A) based on functions of the payment application.

The remittance request indication MS2 is a non-limiting example of the first indication that is displayed based on the first information relating to the remittance request from the first user (in this example, A.A).

When the user (B.B) of the terminal 20 taps the remittance button BT2 in this screen, the screen shifts to a remittance screen (a non-limiting example of which is a screen shown in FIG. 2-8) for remitting the amount specified by the remittance request information. When a remittance region RM2 at the bottom of the remittance screen is tapped, the remittance screen shifts to a remittance confirmation screen (a non-limiting example of which is a screen shown in FIG. 2-9).

When the user B.B of the terminal 20 taps a confirmation button BT6 in the remittance confirmation screen, the amount specified by the remittance request (remittance requested amount: the amount shown in the remittance request indication MS2) is remitted from an electronic money account of the user B.B of the terminal 20 to an electronic money account of the first user (A.A).

In the case where an amount corresponding to the remittance requested amount requested from the first user (A.A) is remitted, a remittance reminder indication (a non-limiting example of a second indication that is based on the remittance request and differs from the first indication) that again prompts the user (B.B) of the terminal 20 to remit to the first user (A.A) is not displayed in the display 24 of the terminal 20 of the user (B.B).

On the other hand, in a case where an amount corresponding to the remittance requested amount requested from the other user (A.A) is not remitted, such as a case where the user (B.B) of the terminal 20 does not perform the remittance operation described above in a predetermined period, for example, the remittance reminder indication can be displayed in the display 24 of the terminal 20 of the user (B.B).

In an example shown in FIG. 1-11, a remittance reminder indication MS3 notifying the user of the terminal 20 (user of the payment application) that remittance reminding has been performed is displayed in the display 24 based on functions of the payment application executed by the terminal 20.

In a non-limiting example, the remittance reminder indication MS3 differs from the remittance request indication MS1 shown in FIG. 1-9 in that the remittance reminder indication includes a message (a non-limiting example of which is “A.A”, “(Terminal reminder) You received a remittance request.”) indicating that remittance reminding has been performed based on functions (functions of the payment application) of the terminal 20 (i.e., terminal reminding has been performed) and the user name of the first user relating to the remittance reminder.

Also, a button BT3 for checking detailed information regarding the remittance reminder is displayed on the left of the remittance reminder indication MS3. The remittance reminder indication MS3 and the button BT3 are non-limiting examples of the second indication that is based on the remittance request and differs from the first indication.

When the user taps the button BT3 showing the text “Open”, details of the remittance reminder are displayed based on functions of the payment application.

FIG. 1-12 shows a case where the remittance reminder is issued to the user B.B of the terminal 20. That is, as a result of the user B.B tapping the button BT3 shown in FIG. 1-11, the screen shifts to the screen shown in FIG. 1-12.

A remittance reminder indication MS4 showing details of the remittance reminder is displayed in the screen shown in FIG. 1-12.

In a non-limiting example, the remittance reminder indication MS4 differs from the remittance request indication MS2 shown in FIG. 1-12 in that: the remittance reminder indication MS4 includes an icon including the text “Terminal reminder”, notifying the user that remittance processing corresponding to the remittance request information has not been executed yet, and indicating that this notification is based on functions (functions of the payment application) of the terminal 20; and the date and time at which the terminal 20 received the remittance request information are displayed after the message indicating that the remittance request was received from the first user (in this example, “You received a remittance request from A. A. (2020.04.20 21:30)”).

That is, the content of the message or the display manner of the remittance reminder indication MS4 notifies the user that remittance reminding has been performed because remittance processing corresponding to the remittance request has not been executed yet.

Furthermore, the remittance reminder indication MS4 includes a remittance button BT4 for executing remittance processing for the first user (A.A) based on functions of the payment application.

The remittance reminder indication MS4 is a non-limiting example of the second indication that is based on the remittance request and differs from the first indication.

When the user (B.B) of the terminal 20 taps the remittance button BT4 in this screen, the screen shifts to the remittance screen (a non-limiting example of which is the screen shown in FIG. 2-8) for remitting the amount specified by the remittance reminder indication MS4. When the remittance region RM2 at the bottom of the remittance screen is tapped, the remittance screen shifts to the remittance confirmation screen (a non-limiting example of which is the screen shown in FIG. 2-9).

When the user (B.B) of the terminal 20 taps the confirmation button BT6 in the remittance confirmation screen, the amount specified by the remittance reminder indication MS4 is remitted from the electronic money account of the user (B.B) of the terminal 20 to the electronic money account of the first user (A.A).

As described above, in a non-limiting example, remittance processing that is based on the remittance request and relates to remittance from the user (B.B) of the terminal 20 to the first user (A.A) is executed by the controller 21 of the terminal 20 based on input that is made by the user (B.B) of the terminal 20 to the second indication (the remittance reminder indication MS3, the button BT3, and the remittance reminder indication MS4 including the remittance button BT4) displayed in the display 24. Processing

FIGS. 1-13 and 1-14 show a flowchart showing an example of a flow of processing executed by the devices in an example embodiment.

The processing described below is merely an example of processing for implementing the method of the present disclosure, and the present disclosure is not limited to this processing.

Also, another step may be added to the following processing, or some steps may be omitted (deleted) from the following processing.

The same applies to each flowchart (processing) described below.

Processing that is executed by the controller 21 of the terminal 20A, processing that is executed by the controller 21 of the terminal 20B, and processing that is executed by the controller 11 of the server 10 are shown in this order from the left.

The following describes a non-limiting case in which the user A.A of the terminal 20A is the remittance master user and the user B.B of the terminal 20B is the remittance requested user.

This processing is an example of processing in which the terminal 20 (in this example, the terminal 20B) of the remittance requested user automatically displays a remittance reminder indication in the display 24.

Although remittance reminding can be performed not only once but also twice or more times, remittance reminding is performed only once in the following processing, and determination for ending the processing is omitted in order to simplify description and illustration of the processing. The following description also applies to cases where remittance reminding is performed twice or more times.

First, the controller 21 of the terminal 20A determines whether or not to request transmission of a remittance request (A110) based on whether or not input (hereinafter referred to as “remittance request execution input”) for requesting transmission of the remittance request has been made to the input device, in a non-limiting example.

The remittance request execution input may be an operation (hereinafter referred to as a “remittance request execution operation”) for requesting transmission of the remittance request, in a non-limiting example.

Upon determining to make a request (A110: YES), the controller 21 of the terminal 20A transmits information (hereinafter referred to as “remittance request transmission request information”) for requesting the server 10 to transmit remittance request information to the terminal 20 (in this example, the terminal 20B) of the remittance requested user, by means of the communication I/F 22 to the server 10 (A120)

In a non-limiting example, the remittance request transmission request information may include at least identification information (a non-limiting example of which is the application ID) of the user A.A of the terminal 20A, identification information (a non-limiting example of which is the application ID) of the remittance requested user B.B, and a remittance requested amount (amount to be remitted).

Upon receiving the remittance request transmission request information from the terminal 20A by means of the communication I/F 14, the controller 11 of the server 10 generates remittance request information for which a remittance request management ID is set, based on the received remittance request transmission request information, and updates the first remittance request management data 157A. Then, the controller 11 of the server 10 transmits the generated remittance request information to the terminal 20B of the remittance requested user B.B by means of the communication I/F 14 (S110).

In a non-limiting example, the remittance request information may include the remittance request management ID, information (non-limiting examples of which include a text, an image, etc., indicating a remittance request) that enables the user to discern (recognize) that the information is a remittance request, information of the remittance requested amount, information of the remittance master user (a non-limiting example of which is the user name of the remittance master user), and the like.

Note that the information of the remittance master user is not limited to the user name, and information such as the application ID, the terminal phone number, or the terminal mail address of the remittance master user may optionally be included.

Upon receiving the remittance request information from the server 10 by means of the communication I/F 22, the controller 21 of the terminal 20B displays a remittance request indication based on the received remittance request information in the display 24 (B110).

The remittance request indication may include, in addition to indication of some or all pieces of information included in the received remittance request information, indication of information relating to the received remittance request information and indication of information (non-limiting examples of which include operation images such as the remittance button and a remittance icon) for implementing remittance based on the received remittance request information.

Thereafter, the controller 21 of the terminal 20B determines whether or not to execute remittance based on the remittance request (B120). In a non-limiting example, the controller determines whether or not input for executing remittance has been made to the input device, with the remittance request management ID specified.

Upon determining to execute remittance (B120: YES), the controller 21 of the terminal 20B transmits remittance settlement request information for requesting settlement of the remittance to the server 10 by means of the communication I/F 22 (B130).

In a non-limiting example, the remittance settlement request information may include the remittance request management ID and a to-be-remitted amount.

The to-be-remitted amount is an amount that is input as the amount to be remitted and that has not been remitted yet.

The controller 11 of the server 10 determines whether or not the remittance settlement request information has been received from the terminal 20B by the communication I/F 14 (S120), and upon determining that the remittance settlement request information has been received (S120: YES), executes remittance settlement processing (S130).

Specifically, in a non-limiting example, the controller updates the electronic money account balance of the user B.B by subtracting the to-be-remitted amount as a remitted amount from the balance, and updates the electronic money account balance of the user A.A by adding the remitted amount to the balance.

The remitted amount is the amount remitted from the remittance requested user to the remittance master user.

Also, the controller sets the remittance completion flag corresponding to the received remittance request management ID to “ON” in the first remittance request management data 157A.

Remittance will not be executed any more with respect to the remittance request management ID for which the remittance completion flag is set to “ON”.

Also, the remittance is not executed in the remittance settlement processing in a case where the electronic money account balance is insufficient (a case where the to-be-remitted amount exceeds the electronic money account balance).

In this case, the controller 11 of the server 10 transmits, to the terminal 20B, information for prompting the user to charge the electronic money account balance. The controller may optionally be configured to execute remittance after charging the electronic money account balance upon receiving information requesting charging from the terminal 20B.

Thereafter, the controller 11 of the server 10 transmits remittance information regarding the remittance to the terminal 20B by means of the communication I/F 14 (S140).

In a non-limiting example, the remittance information includes information such as a remittance completion notification for notifying the user of completion of the remittance.

Also, the controller 11 of the server 10 transmits money reception information regarding reception of money to the terminal 20A by means of the communication I/F 14 (S150).

In a non-limiting example, the money reception information includes information such as a money reception completion notification for notifying the user of completion of the reception of money.

Upon receiving the money reception information from the server 10 by means of the communication I/F 22 (A140: YES), the controller 21 of the terminal 20A displays the received money reception information in the display 24 (A150).

Upon receiving the remittance information from the server 10 by means of the communication I/F 22, the controller 21 of the terminal 20B displays the received remittance information in the display 24 (B140).

Thereafter, the controller 21 of the terminal 20B determines whether or not to perform remittance reminding (in an example embodiment, terminal reminding) with respect to the remittance request described above (B145). Specifically, in a non-limiting example, the controller determines to perform remittance reminding in a case where settings are configured to perform remittance reminding (terminal reminding).

Note that, basically, a configuration can be adopted in which remittance reminding is performed in a case where a remittance based on the remittance request has not been executed in step B120.

However, a different configuration is also possible in which remittance reminding is performed irrespective of whether or not a remittance based on the remittance request has been executed.

In a non-limiting example of this case, remittance reminding may also be performed after a certain period has elapsed from the time when the remittance request information transmitted from the server 10 in step S110 was received, or the time when the remittance request indication was displayed in the display 24 in step B110, rather than immediately after either of these times.

Upon determining to perform remittance reminding (B145: YES), the controller 11 of the server 10 generates remittance reminder information based on the remittance request information received in advance. Then, the controller 21 of the terminal 20B displays a remittance reminder indication based on the generated remittance reminder information in the display 24 (B150).

In a non-limiting example, the content of the remittance reminder indication may be the same as the content of the remittance request indication, other than that the remittance reminder indication includes information (non-limiting examples of which include a text, an image, etc., indicating a remittance reminder) that enables the user to discern (recognize) that the indication is a remittance reminder.

Note that the content of the remittance request indication and the content of the remittance reminder indication may optionally be completely the same as each other.

The remittance reminder indication may be a concept including, in addition to indication of some or all pieces of information included in the received remittance reminder information, indication of information relating to the received remittance reminder information and indication of information (non-limiting examples of which include operation images such as the remittance button and the remittance icon) for implementing remittance based on the received remittance reminder information, for example.

Next, the controller 21 of the terminal 20B determines whether or not input has been made to the remittance reminder indication displayed in the display 24 (B160).

In a non-limiting example, the “input” may be an operation such as tapping (tap operation) performed on the input device (operation device).

The input may also include input to the various remittance reminder indications MS described above. The input is not limited to the tap operation performed on the remittance button. In a non-limiting example, remittance may also be implemented in response to a tap operation performed on the display region of any remittance reminder indication MS out of the various remittance reminder indications MS described above.

Upon determining that input has been made (B160: YES), the controller 21 of the terminal 20B transmits remittance settlement request information based on the remittance reminder information by means of the communication I/F 22 to the server 10 (B130).

In this case as well, the remittance settlement request information may include the remittance request management ID of the remittance request information received in advance and the to-be-remitted amount, in a non-limiting example.

The controller 11 of the server 10 determines whether or not the remittance settlement request information has been received from the terminal 20B by the communication I/F 14 (S120), and upon determining that the remittance settlement request information has been received (S120: YES), executes remittance settlement processing (S130). The remittance settlement processing is as described above.

Thereafter, the controller 11 of the server 10 transmits the remittance information described above to the terminal 20B by means of the communication I/F 14 (S140).

Also, the controller 11 of the server 10 transmits the money reception information described above to the terminal 20A by means of the communication I/F 14 (S150).

Then, the controller 11 of the server 10 ends the processing.

Upon receiving the remittance information from the server 10 by means of the communication I/F 22, the controller 21 of the terminal 20B displays the received remittance information in the display 24 (B140). Then, the controller 21 of the terminal 20B ends the processing.

Upon receiving the money reception information from the server 10 by means of the communication I/F 22 (A140: YES), the controller 21 of the terminal 20A displays the received money reception information in the display 24 (A150). Then, the controller 21 of the terminal 20A ends the processing.

### Remittance Processing (First Remittance Processing) Executed by Terminal

Processing that is executed by the controller 21 of the terminal 20 (a non-limiting example of which is the terminal 20 of the remittance requested user) includes remittance processing (hereinafter, this remittance processing executed by the terminal will be referred to as “first remittance processing”).

The first remittance processing is executed by the terminal 20 in relation to remittance from the remittance requested user (user of the terminal) to the remittance master user (first user) based on a remittance request.

In a non-limiting example, the first remittance processing may include processing for implementing remittance from the user of the terminal to the first user and processing that has something to do with remittance from the user of the terminal to the first user. Not only processing that directly relates to the remittance, but also processing that indirectly relates to the remittance may be included in the remittance processing executed by the terminal.

In the processing example described above, the following processing is included in the first remittance processing, for example: (1) Processing of transmitting the remittance settlement request information to the server 10 by means of the communication I/F 22; (2)

Processing of receiving the remittance information from the server 10 by means of the communication I/F 22; (3) Processing of displaying the received remittance information in the display 24.

### Input to Terminal

In the above-described processing, input that is made to the terminal or is made by the user of the terminal, such as the remittance request execution input or the input made to the remittance reminder indication, is described as input of an operation performed on the input device (operation device), but there is no limitation thereto.

In a non-limiting example, input of audio (including voice) to the input device (audio input device 25) may optionally be adopted instead of or in addition to input of an operation performed on the input device (operation device).

The same applies to other input that is made to the terminal or is made by the user of the terminal.

### Effects of First Example Embodiment

In an example embodiment, the terminal 20 receives remittance request information (a non-limiting example of the first information relating to a remittance request) relating to a remittance request from the remittance master user (a non-limiting example of the first user) by means of the communication I/F 22. Then, the terminal 20 displays a remittance request indication (a non-limiting example of the first indication) in the display 24.

Also, the terminal 20 displays a remittance reminder indication (a non-limiting example of the second indication) that is based on the remittance request and differs from the remittance request information, in the display 24. Then, the terminal 20 executes first remittance processing (a non-limiting example of remittance processing relating to remittance from a user of the terminal to the first user) that is based on the remittance request by means of the controller 21 based on input that is made to the remittance reminder indication (a non-limiting example of input that is made to the second indication) displayed in the display 24.

As an example of effects of the embodiment obtained with this configuration, it is possible to easily implement remittance from the user of the terminal to the first user by executing the remittance processing by means of the controller of the terminal based on input made to the second indication displayed in the display of the terminal.

Also, in an example embodiment, a configuration is described in which the remittance request indication includes information of the remittance requested amount based on the remittance request (a non-limiting example of information of an amount based on the remittance request), and the remittance reminder indication includes information of the same amount (a non-limiting example of information of the amount based on the remittance request).

As an example of effects of the embodiment obtained with this configuration, it is possible to reliably notify the user of the terminal of the amount based on the remittance request using the first indication and the second indication.

Also, in an example embodiment, a configuration is described in which the remittance request indication includes information such as the user name of the remittance master user (a non-limiting example of information of the first user), and the remittance reminder indication includes information such as the same user name (a non-limiting example of information of the first user).

As an example of effects of the embodiment obtained with this configuration, it is possible to reliably notify the user of the terminal of the information of the remittance request source user using the first indication and the second indication.

Also, in an example embodiment, a configuration is described in which the remittance request indication (a non-limiting example of the first indication) and the remittance reminder indication (a non-limiting example of the second indication) are displayed in the display 24 by the payment application (a non-limiting example of an application installed in the terminal) installed in the terminal 20.

As an example of effects of the embodiment obtained with this configuration, it is possible to make the user of the terminal recognize easily the first indication and the second indication using the application installed in the terminal.

Also, in an example embodiment, a configuration is described in which the first remittance processing includes processing of receiving the remittance information (a non-limiting example of information indicating that remittance processing based on the remittance request has been executed) by means of the communication I/F 22.

As an example of effects of the embodiment obtained with this configuration, it is possible to notify the user of the terminal that remittance processing based on the remittance request has been executed.

In an example embodiment, a configuration is described in which the first remittance processing includes processing of transmitting the remittance settlement request information (a non-limiting example of information relating to a request for remittance processing based on the remittance request) by means of the communication I/F 22.

As an example of effects of the embodiment obtained with this configuration, it is possible to request an external device to perform remittance processing based on the remittance request from the first user.

### First Modification (1)

In a case where the first remittance processing has not been executed, the terminal 20 of the remittance requested user displays, in the display 24, an indication (a non-limiting example of a fourth indication) that remittance based on the remittance request from the remittance master user has not been executed. On the other hand, in a case where the first remittance processing has been executed, the terminal 20 of the remittance requested user may optionally display, in the display 24, an indication (a non-limiting example of a fifth indication) that remittance based on the remittance request from the remittance master user has been executed.

The indication that remittance based on the remittance request from the remittance master user has not been executed may include a text such as “Remittance has not been done.” or “Unsent”, or an image (a mark, an icon, etc.) indicating the unsent state, for example.

Likewise, the indication that remittance based on the remittance request from the remittance master user has been executed may include a text such as “Remittance has been done.” or “Sent”, or an image (a mark, an icon, etc.) indicating the sent state, for example.

In this modification, the terminal 20 of the remittance requested user displays, in the display 24, an indication (a non-limiting example of the fourth indication) that remittance based on the remittance request from the remittance master user has not been executed, in the case where the first remittance processing (a non-limiting example of the remittance processing) has not been executed. On the other hand, the terminal 20 of the remittance requested user displays, in the display 24, an indication (a non-limiting example of the fifth indication) that remittance based on the remittance request from the remittance master user has been executed, in the case where the first remittance processing has been executed.

As an example of effects of the modification obtained with this configuration, it is possible to appropriately notify the user of the terminal of conditions of the remittance based on the remittance request (i.e., whether or not the remittance has been executed).

### First Modification (2)

In an example embodiment, the terminal 20 of the remittance requested user can issue a push notification as a reminder indication. The push notification can also be said to be one type of the reminder indication or one type of a reminder notification.

Other than the push notification, reminder notification processing based on the following control may also be performed, in a non-limiting example.

The controller 21 controls the audio output device 26 to output a predetermined sound.

The controller 21 controls a vibration part (not illustrated) to vibrate the casing of the terminal 20.

The controller 21 controls a light emitting part (not illustrated) to emit light in a predetermined manner.

Note that it is also possible to set a condition (hereinafter referred to as “reminder notification condition”) for issuing a reminder notification, and execute reminder notification processing when the reminder notification condition is satisfied, in addition to reaching a timing for executing terminal reminding.

Non-limiting examples of the reminder notification condition include a condition that the current time is not included in a time period in which the user is highly likely to be sleeping (such as a late-night time period (before 12 a.m. next day), a pre-dawn time period (before 3 a.m. next day), and a dawn time period (after 3 a.m. next day)).

In this case, the reminder notification condition is not satisfied and the reminder notification processing is not executed in the set time period. Thus, it is possible to prevent the reminder notification from being issued in the time period in which the user is highly likely to be sleeping.

In this modification, a configuration is described in which the terminal 20 of the remittance requested user executes the reminder notification processing by means of the controller 21 based on a set reminder notification condition (a non-limiting example of a second condition).

As an example of effects of the modification obtained with this configuration, it is possible to notify the user of the terminal of execution of terminal reminding at an appropriate timing based on the set condition.

### First Modification (3)

When remittance based on the remittance request is executed by the terminal 20 of the remittance requested user in an example embodiment, the remittance may also be executed based on input that is made to the remittance request indication displayed in the display 24, similarly to the case where remittance based a remittance reminder is executed, for example.

FIG. 1-15 is a flowchart showing an example of a flow of processing executed by the devices in this modification.

This flowchart corresponds to the portion of processing shown in FIG. 1-14 in the flowchart shown in FIGS. 1-13 and 1-14.

After step B110, the controller 21 of the terminal 20B determines whether or not input has been made to the remittance request indication displayed in the display 24 (B125).

The input of this case may be input of an operation such as tapping (tap operation) or input of audio, similarly to the above-described input made to the remittance reminder indication.

Upon determining that input has been made (B125: YES), the controller 21 of the terminal 20B proceeds to step B130.

In this modification, a configuration is described in which the terminal 20 of the remittance requested user executes processing for implementing remittance from the remittance requested user to the remittance master (a non-limiting example of the remittance processing relating to remittance from the user of the terminal to the first user), which is based on the remittance request, by means of the controller 21 based on input that is made by the remittance requested user to the remittance request indication (a non-limiting example of the first indication).

As an example of effects of the embodiment obtained with this configuration, remittance based on the remittance request can be easily implemented based on input made by the user of the terminal to the first indication.

### First Modification (4)

In an example embodiment, the first user is the user (in the above example, the user A.A) of the terminal 20, who is a general user, but there is no limitation thereto.

The first user may optionally be a business operator such as a store, rather than a general user. Non-limiting examples of the business operator of this case include business operators (stores) that are envisaged demanding payment from the user of the terminal 20 by requesting remittance, such as a business operator that sells products (or provides services) and a business operator that lends money.

In this case, these business operators obtain accounts of the payment service (payment application) in the above embodiment. The business operators can use these accounts to transmit remittance request information and remittance reminder information via the server 10 to the terminal 20 of the user (remittance requested user) from whom they demand payment.

Note that the above-described business operators (stores) may obtain general accounts for users of the terminals 20 or accounts for business operators.

In this modification, a configuration is described in which the remittance master user (a non-limiting example of the first user) is a store that sells a product relating to the remittance request.

As an example of effects of the modification obtained with this configuration, not only a general user, but also a store can request, as a user (first user), remittance from the user of the terminal.

### First Modification (5)

There may be cases where the user of the terminal 20 hesitates to send a remittance request or a remittance reminder to the remittance requested user because the user feels awkward in doing so. A non-limiting example of such a case is a case where the remittance requested user is superior to the user or is a close friend of the user.

Therefore, not the user of the terminal 20 but a user who uses a business account may request issuance of the remittance request and the remittance reminder.

A non-limiting example of the user who uses a business account has an official account (hereinafter may be denoted by “OA” as appropriate) in the service (in the above example, the payment service).

A non-limiting example of the user having the official account is the operator of the payment service. In this case, the server 10 can transmit the remittance request information and the remittance reminder information to the terminal 20 of the remittance requested user based on a request to issue a remittance request or a remittance reminder, which is received not from the user of the terminal 20 but from the operator of the payment service.

In this modification, a configuration is described in which the user requesting remittance (a non-limiting example of the first user) is a user who uses an official account (a non-limiting example of a business account).

As an example of effects of the modification obtained with this configuration, it is possible to allow the user using the business account to request remittance in place of the user who wants to request remittance, and thus improve convenience for the user.

### Second Example Embodiment

In a second embodiment, the terminal 20 of the remittance requested user displays a remittance reminder indication based on reception of remittance reminder information from the server 10. Hereinafter, this method will be referred to as “server reminding”.

Matter described in an example embodiment can also be applied to other embodiments and modifications.

Constitutional elements that are the same as those already described are denoted with the same reference numerals as those used for corresponding elements, and a redundant description thereof is omitted.

### Data Configuration

FIG. 2-1 shows an example of the configuration of second remittance request management data 157B, which is another example of the above-described remittance request management data 157 stored in the storage 15 of the server 10.

In a non-limiting example, an information type is stored in the second remittance request management data 157B in addition to and in association with the date and time, the remittance request management ID, the remittance master ID, the remittance requested ID, the remittance requested amount, and the remittance completion flag, which are included in the first remittance request management data 157A.

The information type is information for discerning whether the type of information corresponding to the remittance request management ID is a remittance request or a remittance reminder. In a non-limiting example, “request” is stored in the case of a remittance request, and “reminder” is stored in the case of a remittance reminder.

In the case where the information type of the corresponding remittance request is “request”, date and time at which the remittance request information was transmitted from the server 10 to the terminal 20 of the remittance requested user are stored as the date and time, in a non-limiting example. In the case where the information type of the corresponding remittance request is “reminder”, date and time at which the remittance reminder information was transmitted from the server 10 to the terminal 20 of the remittance requested user are stored as the date and time, in a non-limiting example.

For each remittance request management ID, the same ID, the same amount, and the same flag are stored as the remittance request management ID, the remittance requested amount, and the remittance completion flag, respectively, in remittance reminder information corresponding to remittance request information identified based on the remittance request management ID, irrespective of how many times remittance reminding has been performed.

The data of records surrounded by black frames in the drawing are non-limiting examples of data of a remittance request and a remittance reminder corresponding to each other.

### Display Screen

FIG. 2-2 shows an example of information displayed in the display 24 when the payment application is being executed in the terminal 20 of the first user (A.A).

The electronic money account balance (in this example, “\25,000”) of the first user (A.A) and icons respectively corresponding to functions executable in the payment application are displayed in the display 24.

The first user (A.A) can check whether or not remittance has been made and, in a case where remittance has been made, the user who made the remittance and the remitted amount, by causing the display 24 to display a history of money deposited into his or her account. That is, the first user can check whether or not remittance has been made in response to a remittance request.

The functions executable in the payment application include a remittance request function for requesting payment from a specified user, and the text “Remittance request” is displayed together with an icon IC1 including the mark “\”, which corresponds to the remittance request function.

When the first user (A.A) selects this icon, specifies a user (in this example, B.B) who is requested to remit, and inputs a remittance requested amount (in this example, “\3,000”), remittance request information is transmitted to the terminal 20 of the specified user (B.B), and the remittance request indications MS1 and MS2 are displayed in the display 24 of the terminal 20 of the specified user.

Information regarding the user who is requested to remit and the remittance requested amount are managed as a remittance request record in the payment application in the terminal 20 of the first user (A.A).

In the example shown in FIG. 2-2, the text “Remittance request list” is displayed together with an icon IC2 corresponding to a remittance request history viewing function.

By selecting this icon, the first user (A.A) can check individual users who were requested to remit by the first user and remittance requested amounts corresponding to the respective users.

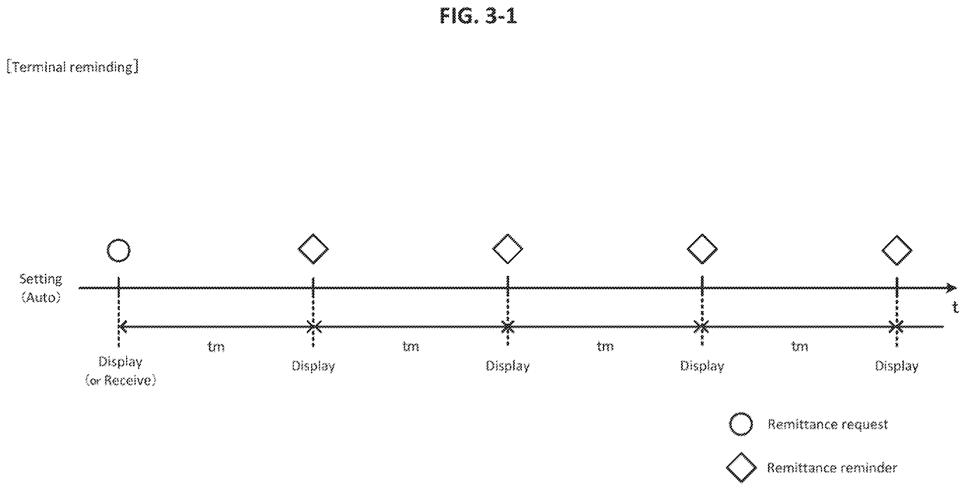

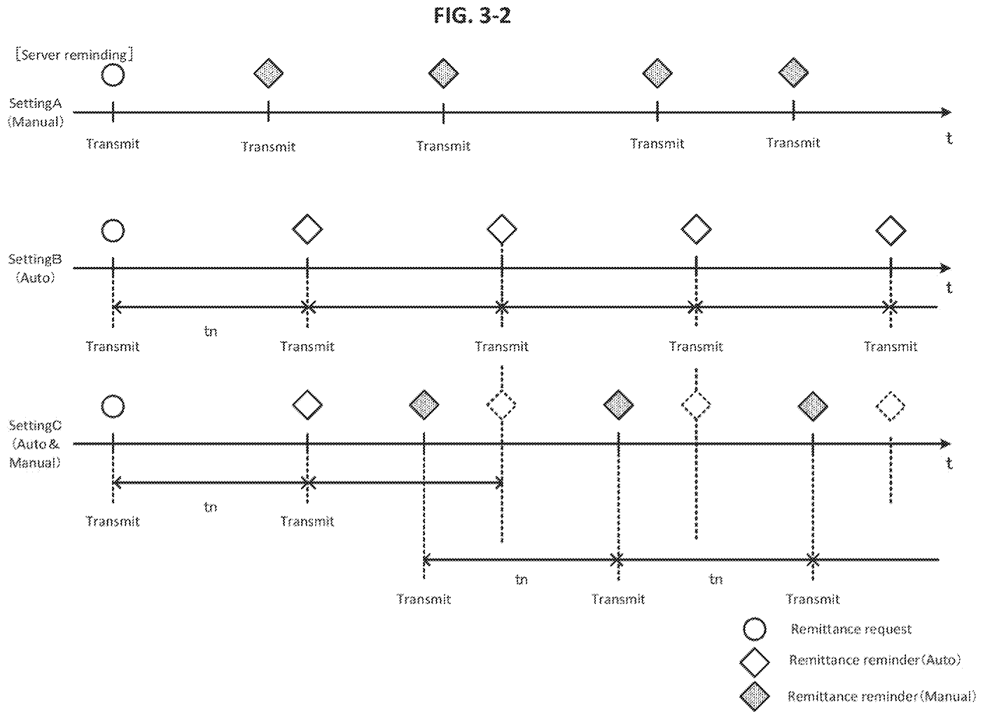

As shown in FIG. 2-3, in this example, information is displayed below the title “Remittance request list” with respect to each remittance request that was issued by the first user (A.A) in the past and for which remittance processing has not been completed, that is, for which a remittance reminder can be issued.

In this example, an icon image and the user name (in this example, B.B) of the user who was requested to remit, date and time (in this example, 2020.04.20 21:30) at which the terminal 20 of the user received remittance request information, a remittance requested amount (in this example, “\3,000”) for the user, and an icon (in this example, an icon showing the text “Receipt”) indicating that the remittance requested amount is to be received by the first user (A.A) are displayed in association with each other in a rectangular region R1.

Also, a checkbox is provided in the region R1, and when the checkbox is checked by the user, each information displayed in the region R1 is selected.

In the example shown in FIG. 2-3, a region RR showing the text “Remind” is provided at the bottom of the screen. When the first user (A.A) taps the region RR in the state where the checkbox is checked, remittance reminder information based on the information displayed in the region R1 is transmitted to the terminal 20 of the user (B.B) to whom remittance request information was transmitted.

Then, a remittance reminder indication is displayed in the display 24 of the terminal 20, which has received the remittance reminder information.

When the remittance reminder information is received by the terminal 20 of the user (B.B) or the remittance reminder indication is displayed in the terminal 20 of the user (B.B) based on reception of the remittance reminder information, a remittance reminding completion indication MS5 indicating completion of remittance reminding is displayed in the terminal 20 of the first user (A.A) as shown in FIG. 2-4.

The remittance reminding completion indication MS5 includes the user name (in this example, B.B) of the user who was requested to remit.

As shown in FIG. 2-5, a remittance reminder indication MS3A based on reception of the remittance reminder information is displayed in the terminal 20 of the user (B.B), which has received the remittance reminder information.

In a non-limiting example, the remittance reminder indication MS3A includes a message (a non-limiting example of which is “A.A”, “[Reminder received] You received a remittance request.”) that is based on reception of the remittance reminder information and indicates the user name of the first user relating to the remittance reminder.

The remittance reminder indication MS3A differs from the remittance reminder indication MS3 shown in FIG. 1-11 in that the remittance reminder indication MS3A includes the text “Reminder received” corresponding to a remittance reminder indication displayed based on received remittance reminder information, whereas the remittance reminder indication MS3 includes the text “Terminal reminder” corresponding to a remittance reminder indication displayed based on functions of the terminal itself

Also, a button BT3A for checking detailed information regarding the remittance reminder is displayed on the left of the remittance reminder indication MS3A.

The remittance reminder indication MS3A and the button BT3A are non-limiting examples of the second indication that is based on the remittance request and differs from the first indication.

The remittance reminder indication MS3A and the button BT3A are non-limiting examples of the second indication that is displayed in the display 24 based on reception, by the terminal 20, of second information based on the remittance request.

When the user taps the button BT3A showing the text “Open”, details of the remittance reminder are displayed based on functions of the payment application.

As a result of the user (B.B) tapping the button BT3A shown in FIG. 2-5, the screen shifts to the screen shown in FIG. 2-6, and a remittance reminder indication MS4A showing details of the remittance reminder is displayed.

In a non-limiting example, the remittance reminder indication MS4A includes an icon showing the text “Reminder received” based on reception of the remittance reminder information, and a message indicating the user name of the first user (a non-limiting example of which is “[Reminder received] You received a remittance request from A.A.”) based on reception of the remittance reminder information.

The remittance reminder indication MS4A differs from the remittance reminder indication MS4 shown in FIG. 1-12 in that the remittance reminder indication MS4A includes the icon showing the text “Reminder received” based on reception of the remittance reminder information, whereas the remittance reminder indication MS4 includes the icon showing the text “Terminal reminder”, which corresponds to a remittance reminder indication displayed based on functions of the terminal itself.

Also, the remittance reminder indication MS4A shown in FIG. 2-6 differs from the remittance reminder indication MS4 shown in FIG. 1-12 in that the remittance reminder indication MS4A displays “[Reminder received]”, which corresponds to a remittance reminder indication based on the remittance reminder information, before the user name (A.A) of the first user, whereas the remittance reminder indication MS4 does not include such indication.

When the user (B.B) of the terminal 20 taps link information displayed as “>Check details” in the remittance reminder indication MS4A, the screen shifts to the screen shown in FIG. 2-7.

The screen shown in FIG. 2-7 notifies the user of an event for which the user is reminded of remittance (in this example, remittance for the fee of an event held on April 20) by the remittance reminder indication MS4A. Also, the screen notifies the user (B.B) of the terminal 20 that the user is requested to make payment (in this example, with an icon showing the text “Payment”) and the amount to be paid (in this example, “\3,000”).

In the screen shown in FIG. 2-7, information relating to the remittance reminder is displayed together with an animal character in a region larger than the remittance reminder indication MS4A described above. A region RM1 is provided below this region.

Information (in this example, a message “Reminder received”, “You received a remittance request from A.A.”) indicating the user name (A.A) of the first user and the fact that a remittance request and a remittance reminder were issued from the first user, and link information (in this example, the area in which the text “>Remit” is displayed) for remitting an amount corresponding to the remittance request and the remittance reminder to the first user are displayed in the region RM1.

When the user (B.B) of the terminal 20 taps the link information for remittance, the screen shifts to the remittance screen shown in FIG. 2-8.

The icon image and the user name (A.A) of the first user, who is the remittee, a remittance amount (in this example, “\3,000”) to be remitted to the first user, an icon (in this example, an icon showing the text “Payment”) notifying the user (B.B) of the terminal 20 that the user is requested to make payment, and an amount (in this example, “\5,000”) that can be currently remitted from the user (B.B) of the terminal 20 are displayed in the remittance screen.

The amount that can be currently remitted from the user (B.B) of the terminal 20 is larger than the amount to be remitted to the first user (A.A), and accordingly, the user (B.B) of the terminal 20 can remit the amount corresponding to the remittance request information and the remittance reminder information to the first user (A.A).

When the remittance region RM2 at the bottom of the remittance screen is tapped, the remittance screen shifts to the remittance confirmation screen shown in FIG. 2-9.

In a non-limiting example, the remittance confirmation screen is superposed on the remittance screen, and includes the icon image and the user name (A.A) of the first user, who is the remittee, a to-be-remitted amount (in this example, “\3,000”) to be remitted to the first user with use of the payment application, and a confirmation button BT6 showing the text “Confirm”.

When the user (B.B) of the terminal 20 taps the confirmation button BT6, the amount (in this example, “\3,000”) displayed in the remittance confirmation screen is remitted from the account of the user (B.B) of the terminal 20 to the account of the first user (A.A).

When the remittance is complete, a remittance completion screen shown in FIG. 2-10 is displayed in the terminal 20 of the user (B.B).

In a non-limiting example, the remittance completion screen is superposed on the remittance screen, and the user name (A.A) of the first user, who is the remittee, and a message indicating completion of the remittance processing are displayed in the remittance completion screen.

### Processing

### (1) Example of Processing

FIGS. 2-11 is a flowchart showing an example of a flow of processing executed by the devices in an example embodiment.

This flowchart corresponds to the portion of processing shown in FIG. 1-14 in the flowchart shown in FIGS. 1-13 and 1-14, and shows processing in which the server 10 automatically transmits remittance reminder information to the terminal 20 (in this example, the terminal 20B) of the remittance requested user.

The controller 11 of the server 10 determines whether or not to perform remittance reminding (in an example embodiment, server reminding) for a previous remittance request (S260). Specifically, the controller determines to perform remittance reminding in a case where remittance settlement request information has not been received from the terminal 20A in step S120, in a non-limiting example.

In a non-limiting example of this case, remittance reminding may also be performed after a certain period has elapsed from the time when the remittance request information was transmitted to the terminal 20 in step S110, rather than immediately after this time.

Upon determining to perform remittance reminding (S260: YES), the controller 11 of the server 10 generates remittance reminder information for which the same ID as the remittance request management ID set in step S110 is set, and updates the second remittance request management data 157B. Then, the controller 11 of the server 10 transmits the generated remittance reminder information together with the remittance request management ID to the terminal 20B by means of the communication I/F 14 (S270). Then, the controller 11 of the server 10 proceeds to step S120.

Upon receiving the remittance reminder information from the server 10 by means of the communication I/F 22 (B240: YES), the controller 21 of the terminal 20B displays a remittance reminder indication in the display 24 (B250). Then, the controller 21 of the terminal 20B proceeds to step B160.

### (2) Another Example of Processing

FIG. 2-12 is a flowchart showing another example of the flow of processing executed by the devices in an example embodiment.

This flowchart corresponds to the portion of processing shown in FIG. 1-14 in the flowchart shown in FIGS. 1-13 and 1-14, and shows processing in which the server 10 transmits remittance reminder information to the terminal 20 (in this example, the terminal 20B) of the remittance requested user based on reception of remittance reminder transmission request information transmitted from the terminal 20 (in this example, the terminal 20A) of the remittance master user.

After step A150 shown in FIG. 1-13, the controller 21 of the terminal 20A determines whether or not to request execution of remittance reminding based on whether or not input (hereinafter referred to as “remittance reminding execution input”) for requesting execution of remittance reminding has been made to the input device (A260), in a non-limiting example.

In a non-limiting example, the remittance reminding execution input may be input of an operation or input of audio, similarly to the remittance request execution input described above.

Upon determining to request (A260: YES), the controller 21 of the terminal 20A transmits remittance reminder transmission request information to the server 10 by means of the communication I/F 22 (A270). Then, the controller 21 of the terminal 20A proceeds to step A150.

The controller 11 of the server 10 determines whether or not remittance reminder transmission request information has been received from the terminal 20A by the communication I/F 14 (S265), and upon determining that the remittance reminder transmission request information has been received (S265: YES), proceeds to step S270.

### Remittance Processing (Second Remittance Processing) Executed by Server

Processing that is executed by the controller 11 of the server 10 includes remittance processing (hereinafter, the remittance processing executed by the server will be referred to as “second remittance processing”).

The second remittance processing is executed by the server 10 in relation to remittance from the remittance requested user (user of the terminal) to the remittance master user (first user) based on a remittance request.

For example, the second remittance processing may include processing for implementing remittance from the user of the terminal to the first user and processing that has something to do with remittance from the user of the terminal to the first user. Not only processing that directly relates to the remittance, but also processing that indirectly relates to the remittance may be included in the remittance processing executed by the terminal.

In the processing example described above, the following processing is included in the second remittance processing, for example.

(1) Processing of receiving the remittance settlement request information from the terminal 20 by means of the communication I/F 14.

(2) Remittance settlement processing (including processing of adjusting electronic money account balances, or the like)

(3) Processing of transmitting remittance information and money reception information to the terminals 20 by means of the communication I/F 14.

### Effects of Second Embodiment

In an example embodiment, remittance request information (a non-limiting example of the first information) relating to a remittance request from the remittance master user (a non-limiting example of the first user) is transmitted via the server 10 to the terminal 20 of the remittance requested user based on input that is made to the terminal 20 of the remittance master user (a non-limiting example of the first user) by the remittance master user.

On the other hand, remittance reminder information (a non-limiting example of the second information) is transmitted by the server 10 to the terminal 20 of the remittance requested user, and a remittance reminder indication (a non-limiting example of the second indication) is displayed in the display 24 of the terminal 20 of the remittance requested user based on the remittance reminder information,

As an example of effects of the embodiment obtained with this configuration, the first information can be transmitted via the server to the terminal in accordance with the intention of the first user requesting remittance. Also, the second information can be transmitted from the server to the terminal, and then the second indication can be displayed in the display of the terminal based on the second information.

Also, in an example embodiment, the server 10 transmits the remittance request information (a non-limiting example of the first information relating to a remittance request) relating to the remittance request from the remittance master user (a non-limiting example of the first user) to the terminal 20 (a non-limiting example of the terminal) of the remittance requested user by means of the communication I/F 14. Also, the server 10 transmits the remittance reminder information based on the remittance request (a non-limiting example of the second information based on the remittance request) to the terminal 20 of the remittance requested user by means of the communication I/F 14. Then, the server 10 executes the second remittance processing (a non-limiting example of remittance processing that is based on the remittance request and relates to remittance from a user of the terminal to the first user) by means of the controller 11 based on input that is made to the remittance reminder indication (a non-limiting example of the second indication based on the second information) displayed in the display 24 of the terminal 20 of the remittance requested user.

As an example of effects of the modification obtained with this configuration, remittance from the user of the terminal to the first user can be easily implemented through execution of the remittance processing by the controller of the server based on input made to the second indication displayed in the display of the terminal.

### Second Modification (1)

It is possible to change designs of the user interfaces of the display screens of the payment application and functions of the payment application described in an example embodiment as appropriate.

FIG. 2-13 shows a non-limiting example of a remittance request list screen displayed in the terminal 20 of the user (B.B).

In the remittance request list screen, a history of remittance requests that were issued to the user (B.B) of the terminal in the past and for which remittance processing has not been completed is displayed below the title “Remittance request list”.

In this example, the icon image and the user name of the user A.A, an icon showing the text “Request received”, date and time (2020.04.20 21:30) at which remittance request information was received, an icon showing the text “Payment” and indicating that the user B.B is requested to make payment to the user A.A, and an amount (\3,000) to be paid to the user A.A are displayed in a region R21 based on reception of the remittance request information from the first user A.A by the user (B.B) of the terminal 20.

Also, information relating to a remittance request from another first user D.D is displayed in a region R23 based on reception of remittance request information from the user D.D by the user (B.B) of the terminal 20. In this example, date and time at which the remittance request information from the user D.D was received is 2020.04.21 08:42, and an amount to be paid to the user D.D is “\500”.

As for the remittance request from the user A.A among the plurality of first users (A.A, B.B), remittance reminder information has also been received after the terminal 20 received the remittance request information, and accordingly, the icon image and the user name of the user A.A, an icon showing the text “Reminder received”, date and time (2020.04.23 17:00) at which the remittance reminder information was received, an icon showing the text “Payment” and indicating that the user is requested to make payment to the user A.A, and the amount (\3,000) to be paid to the user A.A are displayed in a region R22 (a non-limiting example of a display region relating to remittance reminder information and corresponding to a display region relating to remittance request information) below the region R21.

The information displayed in the region R21 and the information displayed in the region R22 are based on the common remittance request information, and accordingly, both include the same icon showing the text “Payment” and indicating that the user is requested to make payment to the user A.A., and the same amount (\3,000) to be paid to the user A.A.

On the other hand, unlike the region R21, the region R22 includes an arrow indicating that the information relates to the information displayed in the region R21. Also, the icon image and the user name of the user A.A and the icon showing the text “Reminder received” that are displayed in the region R22 are respectively on the right side of the icon image and the user name of the user A.A and the icon showing the text “Request received” that are displayed in the region R21. p

In a non-limiting example, information that is displayed in the region 21 based on remittance request information received by the terminal 20 and information that is displayed in the region 22 based on remittance reminder information based on the remittance request information differ from each other in the displayed position of at least some pieces of information (non-limiting examples of which are the icon image and the user name of the first user, and the ion displayed above the icon image and the user name), and this makes it easy for the user to understand the correspondence between the remittance request and the remittance reminder.

In a non-limiting example, information that is displayed as the remittance request history can be sorted in response to an operation performed by the user of the terminal 20.

When a blank region in the screen shown in FIG. 2-13, which displays the remittance request history, is tapped by the user, a sort item selection region SR is displayed as shown in FIG. 2-14.

Information (a non-limiting example of which is the text “Sort requests”) displayed at the top of the sort item selection region SR indicates execution of a sort based on items displayed below.

Below the information described above, the following buttons are displayed: a button BTS1 for executing a sort based on date and time at which remittance request information or remittance reminder information was received; a button BTS2 for executing a sort based on the remittance amount (a non-limiting example of which is a remittance amount requested by remittance request information or remittance reminder information), and a button BTS3 for executing a sort based on user names that are registered as friends in the payment application or a messaging application associated with the payment application.

In a non-limiting example, terminals 20 that are registered as friends are enabled to transmit messages therebetween via the server 10 as a result of a user (an account) of a terminal 20 performing, using his or her terminal 20, processing for adding a user (another account) of another terminal 20 as a friend, and the server 10 executing processing (friend addition processing or friend registration processing) for adding or registering a friend. An account of an individual user in the messaging application will be referred to as a “general account”. A history of messages transmitted between terminals 20 of users who have general accounts is displayed as a talk room or the like in the display 24 of the terminal 20.

In a non-limiting example, when the user (B.B) of the terminal 20 taps the button BTS3, the information displayed as the remittance request history is sorted as shown in FIG. 2-15, and user names of users (non-limiting examples of which are A.A and D.D) who are registered as friends, out of first users (non-limiting examples of which are A.A and D.D) who have requested remittance, are displayed in the alphabetical order.

In this example, the icon image and the user name of the first user A.A are displayed in the region R21, and the icon image and the user name of the first user B.B are displayed in the region R22.

Unlike the example shown in FIG. 2-14, in the example shown in FIG. 2-15, the icon “Request received”, the ion “Reminder received”, the received date and time of the remittance request information, the received date and time of the remittance reminder information, and the information regarding the remittance amounts are not displayed as information regarding the first users after sorting.

The screen shown in FIG. 2-15 enables the user to know at least the first users who have requested remittance.

When the user (B.B) of the terminal 20 taps the region R21 corresponding to a first user (a non-limiting example of which is A.A) who is registered as a friend in the screen shown in FIG. 2-15, detailed information regarding a remittance request from the selected first user (A.A) is displayed as shown in FIG. 2-16.

Information (a non-limiting example of which is the text “List of remittance requests from A.A”) indicating a history regarding remittance requests from the selected first user

(A.A) is displayed in an upper region R20 of the screen, and a detailed history regarding remittance requests from the selected first user (A.A) is displayed below in the manner shown in FIG. 2-13.

In a non-limiting example, the information displayed in the regions R21 and R22 shown in FIG. 2-13 (a non-limiting example of an indication based on remittance request information and an indication based on remittance reminder information) is displayed in the regions R21 and R22 shown in FIG. 2-16.

Note that a history regarding remittance requests from the other first user (D.D) who is not selected is not displayed.

In a non-limiting example, when the user (B.B) of the terminal 20 taps the button BTS1 in the screen shown in FIG. 2-14, the information displayed as the remittance request history is sorted as shown in FIG. 2-17, and a history of the first users (non-limiting examples of which are A.A and D.D) who have requested remittance (a non-limiting example of the indication based on remittance request information and the indication based on remittance reminder information) is displayed based on received dates and times.

In this example, the most recent record is based on remittance reminder information (received date and time: 2020.04.23 17:00) corresponding to the remittance request for \3,000 from the first user A.A, and accordingly, the icon “Reminder received” is displayed together with the icon image and the user name of the user A.A in the top region R21.

The second most recent record is based on remittance request information (received date and time: 2020.04.21 08:42) corresponding to the remittance request for \500 from the other first user B.B, and accordingly, the icon “Request received” is displayed together with the icon image and the user name of the user B.B in the second region R22 from the top.

The third most recent record is based on remittance request information (received date and time: 2020.04.20 21:30) corresponding to the remittance request for \3,000 from the first user A.A, and accordingly, the icon “Request received” is displayed together with the icon image and the user name of the user A.A in the third region R23 from the top.

The information displayed in the region R21 and the information displayed in the region R23 both relate to the common remittance request from the first user (A.A).

However, after the remittance request information based on a first remittance request from the first user (A.A) was received, the remittance request information based on a second remittance request from the other first user (D.D) was received, and thereafter the remittance reminder information based on the first remittance request from the first user (A.A) was received, and therefore, information corresponding to the second remittance request is displayed in the region R22 between the region R21 in which information corresponding to the first remittance request is displayed and the region R23 in which information corresponding to the first remittance request is displayed.

In a non-limiting example, a friend registration confirmation screen is displayed as shown in FIG. 2-18 in the terminal 20 of the user (B.B) who is requested to remit or who is reminded of remittance. The friend registration confirmation screen is a screen for confirming whether or not the first user who issued the remittance request or the remittance reminder is registered as a friend in the payment application or the messaging application associated with the payment application.

In a non-limiting example, when the user (B.B) of the terminal 20 taps the link information for remittance displayed in the region RM1 in the screen shown in FIG. 2-7, the friend registration confirmation screen shown in FIG. 2-18 is displayed before the screen shifts to the remittance screen shown in FIG. 2-8.

In a non-limiting example, the friend registration confirmation screen is superposed on the screen shown in FIG. 2-7, and displays a message (a non-limiting example of which is “Please reconfirm whether the user requesting remittance is your friend. Execute remittance?”) for making the user (B.B) of the terminal 20 confirm whether the user (a non-limiting example of which is the first user whose user name (A.A) is displayed in the region RM1) to whom remittance is to be made is registered as a friend.

When the user (B.B) of the terminal 20 taps a confirmation button BT7 in the friend registration screen, the screen shifts to the remittance screen shown in FIG. 2-8.

As described above, even if the link information for remittance is tapped, the screen for confirming whether or not the first user issuing the remittance reminder is registered as a friend is displayed before the screen shifts to the remittance screen, and thus it is possible to prevent a situation in which remittance is carelessly made to a user who is not registered as a friend.

### Second Modification (2)

This modification relates to an example embodiment (2), and enables the terminal 20 of the remittance requested user to execute reminder notification processing based on reception of remittance reminder information. The reminder notification processing can be implemented using any of the following methods, although there is no limitation thereto.

Based on reception of remittance reminder information that is transmitted from the server 10 in the manner of push transmission, control is performed to display a push notification in the display 24.

The controller 21 controls the audio output device 26 to output a predetermined sound.

The controller 21 controls a vibration part (not illustrated) to vibrate the casing of the terminal 20.

The controller 21 controls a light emitting part (not illustrated) to emit light in a predetermined manner.

The term “push transmission” means that a push notification is issued in the transmission destination device (in this example, the terminal 20 of the remittance requested user) indicating that the information (in this example, the remittance reminder information) has been transmitted from the transmission source device (in this example, the server 10) or received by the transmission destination device.

Note that it is also possible to set a reminder notification condition similar to that described in an example embodiment (2), and execute the reminder notification processing when the reminder notification condition is satisfied, in addition when the remittance reminder information has been received.

In this modification, the terminal 20 of the remittance requested user performs the reminder notification processing (a non-limiting example of notification processing performed by the terminal) by means of the controller 21 based on reception of the remittance reminder information by the communication I/F 22. In this case, the controller 21 performs the reminder notification processing based on a set reminder notification condition (a non-limiting example of the second condition).

As an example of effects of the modification obtained with this configuration, it is possible to notify the user of the terminal of reception of the second information at an appropriate timing based on the second condition.

### Third Example Embodiment

A third embodiment relates to methods and timings for displaying or transmitting remittance reminder information.

Matter described in the third embodiment can also be applied to other embodiments and modifications.

Constitutional elements that are the same as those already described are denoted with the same reference numerals as those used for corresponding elements, and a redundant description thereof is omitted.

FIG. 3-1 shows an example of a timing chart showing a method and timings for displaying remittance reminders in the terminal 20 of the remittance requested user in an example embodiment.

The following describes timings at which remittance reminders are displayed in the terminal 20 of the remittance requested user in the case where the method of terminal reminding described in an example embodiment is applied.

In this timing chart, the horizontal axis is a time axis, and timings at which the terminal 20 of the remittance requested user displays a remittance request and remittance reminders are shown. The white circle represents remittance request information, and the white diamonds represent remittance reminder information.

There is a setting “auto” that indicates that the terminal 20 of the remittance requested user automatically displays remittance reminder information.

When this setting is applied, the terminal 20 of the remittance requested user displays remittance reminders at a set interval tm after displaying a remittance request, in a non-limiting example.

As a non-limiting example, a different configuration may optionally be adopted in which the terminal 20 of the remittance requested user displays remittance reminders at the set interval tin after receiving remittance request information from the server 10.

### Effects of Example Third Embodiment

In an example embodiment, remittance request information (a non-limiting example of the first information) is transmitted to the terminal 20 of the remittance requested user via the server 10 based on input that is made by the remittance master user (a non-limiting example of the first user) to the terminal 20 of the remittance master user.

Also, a remittance reminder indication (a non-limiting example of the second indication) is displayed in the display 24 of the terminal 20 of the remittance requested user based on a time at which a remittance request indication (a non-limiting example of the first indication) is displayed in the display 24 of the terminal 20 of the remittance requested user or a time at which the remittance request information (a non-limiting example of the first information) is received by the terminal 20 of the remittance requested user.

As an example of effects of the embodiment obtained with this configuration, the second indication can be displayed in the display of the terminal at an appropriate timing based on the time at which the first indication is displayed in the display of the terminal or the time at which the first information is received by the terminal.

Also, in an example embodiment, the terminal 20 of the remittance requested user displays a first remittance reminder indication (a non-limiting example of a third indication) in the display 24. The terminal 20 of the remittance requested user displays a second remittance reminder indication (a non-limiting example of a fourth indication) in the display 24 based on elapse of a set period from when the first remittance reminder indication is displayed.

As an example of effects of the embodiment obtained with this configuration, the fourth indication can be displayed in the display of the terminal based on display of the third indication in the display of the terminal.

### Third Modification (1)

The method of the third embodiment can be applied to the method of server reminding described in an example embodiment as well.

FIG. 3-2 is a diagram showing an example of a timing chart of server reminding in this modification.

FIG. 3-2 is to be viewed in the same manner as that of FIG. 3-1, but the grey diamonds represent manually transmitted remittance reminder information, and the white diamonds represent automatically transmitted remittance reminder information.

In the case where a setting A “manual” is applied, the server 10 transmits remittance reminder information to the terminal 20 of the remittance requested user based on remittance reminding execution input that is made to the terminal 20 of the remittance master user. Specifically, the server 10 transmits remittance reminder information to the terminal 20 of the remittance requested user based on reception of remittance reminder transmission request information from the terminal 20 of the remittance master user.

In the case where a setting B “auto” is applied, the server 10 automatically transmits remittance reminder information to the terminal 20 of the remittance requested user independently of the terminal 20 of the remittance master user. Specifically, the server 10 transmits remittance reminder information to the terminal 20 of the remittance requested user at a set interval to after transmitting remittance request information to the terminal 20 of the remittance requested user.

A setting C “auto & manual” is a combination of the settings A and B. In the case where the setting C is applied, the server 10 transmits remittance reminder information basically in accordance with the setting B (auto). However, when manual transmission of remittance reminder information is performed between automatic transmission of remittance reminder information, automatic transmission of remittance reminder information is delayed.

Specifically, in a non-limiting example, the server 10 transmits remittance reminder information to the terminal 20 of the remittance requested user basically at the set interval tn after transmitting remittance request information to the terminal 20 of the remittance requested user. However, when manual transmission of remittance reminder information is performed between automatic transmission of remittance reminder information, the server transmits remittance reminder information at the set interval tn after the most recent manual transmission of remittance reminder information, instead of the most recent automatic transmission of remittance reminder information.

In a non-limiting example, information as to which of the settings A to C is to be applied may be transmitted to the server 10 based on input that is made by the remittance master user to the terminal 20 of the remittance master user, to set the setting in the server 10.

Note that there is no limitation to this configuration, and the above-described settings may optionally be set in the server 10 based on input that is made by the operator of the payment service or an administrator of the server 10, for example.

In this modification, remittance request information (a non-limiting example of the first information) is transmitted to the terminal 20 of the remittance requested user via the server 10 based on input that is made by the remittance master user (a non-limiting example of the first user) to the terminal 20 of the remittance master user.

Also, remittance reminder information (a non-limiting example of the second information) is transmitted by the server 10 to the terminal 20 of the remittance requested user, and a remittance reminder indication (a non-limiting example of the second indication) is displayed in the display 24 of the terminal 20 of the remittance requested user based on the remittance reminder information.

As an example of effects of the embodiment obtained with this configuration, the first information can be transmitted via the server to the terminal in accordance with the intention of the first user requesting remittance. Also, the second information can be transmitted from the server to the terminal, and then the second indication can be displayed in the display of the terminal based on the second information.

Also, in this modification, a configuration is described in which remittance reminder information is transmitted to the terminal 20 of the remittance requested user based on elapse of a set period from when remittance request information is transmitted to the terminal 20 (a non-limiting example of “based on a time at which the first information is transmitted to the terminal or a time at which the first information is received by the terminal”).

As an example of effects of the embodiment obtained with this configuration, the second information can be transmitted to the terminal at an appropriate timing based on the time at which the first information is transmitted to the terminal or the time at which the first information is received by the terminal.

Also, in this modification, the terminal 20 of the remittance requested user receives, by means of the communication I/F 22, first remittance reminder information (a non-limiting example of third information that is based on the remittance request) that is transmitted from the terminal 20 of the remittance master user (a non-limiting example of the first user) based on input that is made by the remittance master user to the terminal 20 of the remittance master user. Then, the terminal 20 of the remittance requested user displays a first remittance reminder indication (a non-limiting example of a third indication) in the display 24. In a non-limiting example of this case, second remittance reminder information (a non-limiting example of the second information) is transmitted to the terminal 20 based on elapse of a set period from when the first remittance reminder information is transmitted.

As an example of effects of the embodiment obtained with this configuration, the second information based on the remittance request can be appropriately transmitted to the terminal based on transmission of the third information based on the remittance request to the terminal.

### Third Modification (2)

In the method of terminal reminding (setting: auto) described in the third embodiment, when the remittance reminder information is displayed for the second time and thereafter, the remittance reminder information may be displayed at set intervals that are different from the interval after which the remittance reminder information is displayed for the first time.

Specifically, in a non-limiting example, the terminal 20 of the remittance requested user displays the first remittance reminder when a first set period has elapsed from the time at which the remittance request is displayed or the remittance request information is received.

The terminal 20 of the remittance requested user displays the second remittance reminder when a second set period has elapsed from the time at which the first remittance reminder is displayed.

Also, the terminal 20 of the remittance requested user displays the third remittance reminder when a third set period has elapsed from the time at which the second remittance reminder is displayed, and so on.

In a non-limiting example of this case, the first set period may be the longest among the set periods.

For example, the first set period may be 24 hours, and the other set periods (the second set period, the third set period, . . . ) may be shorter than 24 hours. In this case, all the other set periods may be the same as each other or different from each other.

In a non-limiting example of the case where the other set periods are different from each other, the set periods may be reduced as the number of times of display of the remittance reminder increases.

Specifically, in a non-limiting example, the first set period may be 24 hours, the second set period may be 18 hours, the third set period may be 12 hours, and so on.

In this case, time intervals (display time intervals) between indications relating to the remittance request become shorter stepwise, and accordingly, it is possible to make the remittance requested user recognize that the remittance has not been done and urge the remittance requested user to remit soon.

Conversely, the first set period may optionally be the shortest among the set periods.

The above description can be applied similarly to time intervals (transmission time intervals) of transmission of the remittance reminder information in the method of server reminding shown in FIG. 3-2.

Also, in the case where the setting C (auto & manual) shown in FIG. 3-2 is applied and manual transmission of remittance reminder information is performed between automatic transmission of remittance reminder information, which is performed by the server 10, automatic transmission of remittance reminder information may optionally be skipped rather than being delayed.

### Fourth Example Embodiment

A fourth embodiment relates to conditions for performing remittance reminding.

Matter described in an example embodiment can also be applied to other embodiments and modifications.

Constitutional elements that are the same as those already described are denoted with the same reference numerals as those used for corresponding elements, and a redundant description thereof is omitted.

In an example embodiment, a case is described in which the method of terminal reminding described in an example embodiment is applied, and the terminal 20 of the remittance requested user determines whether or not a remittance reminding condition is satisfied to perform terminal reminding.

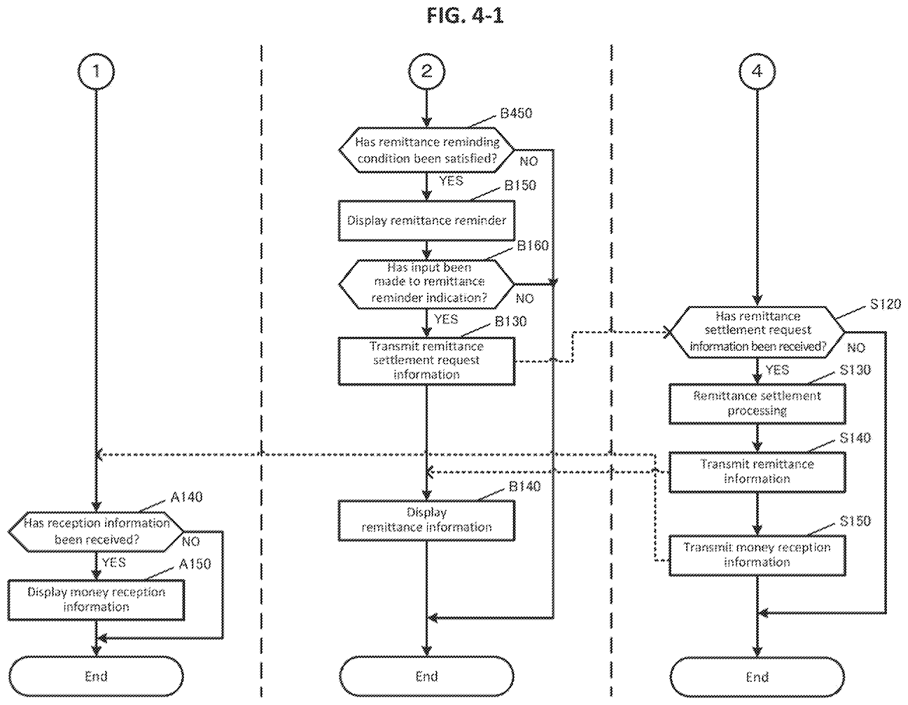

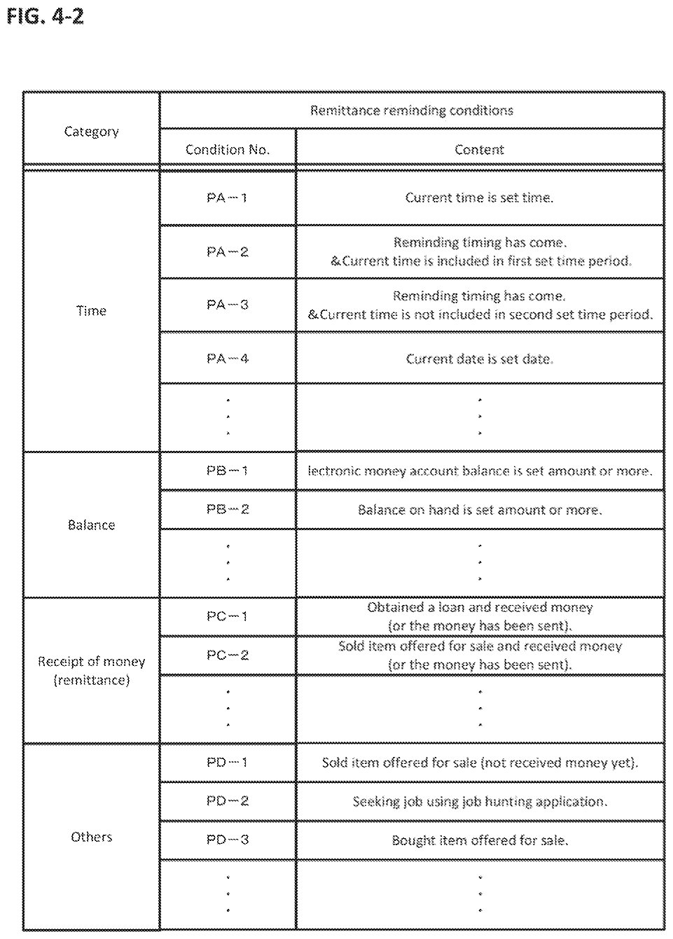

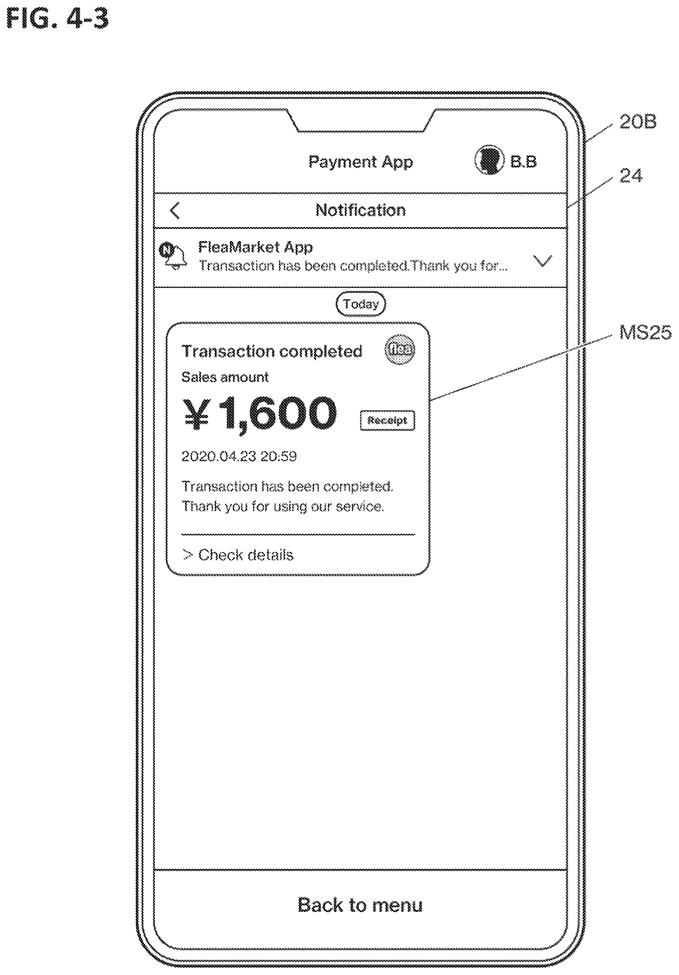

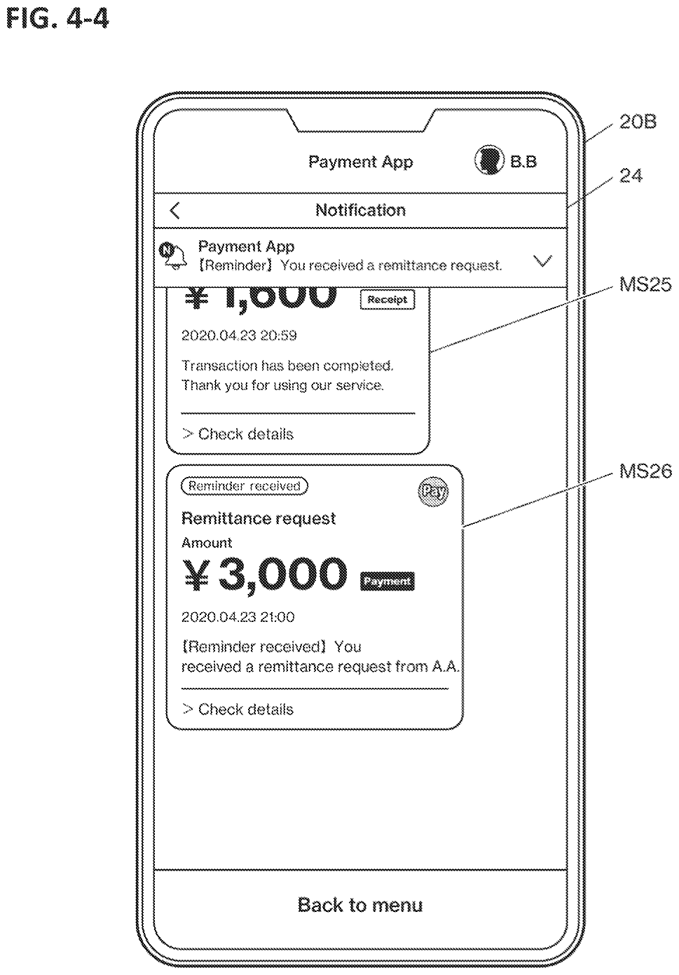

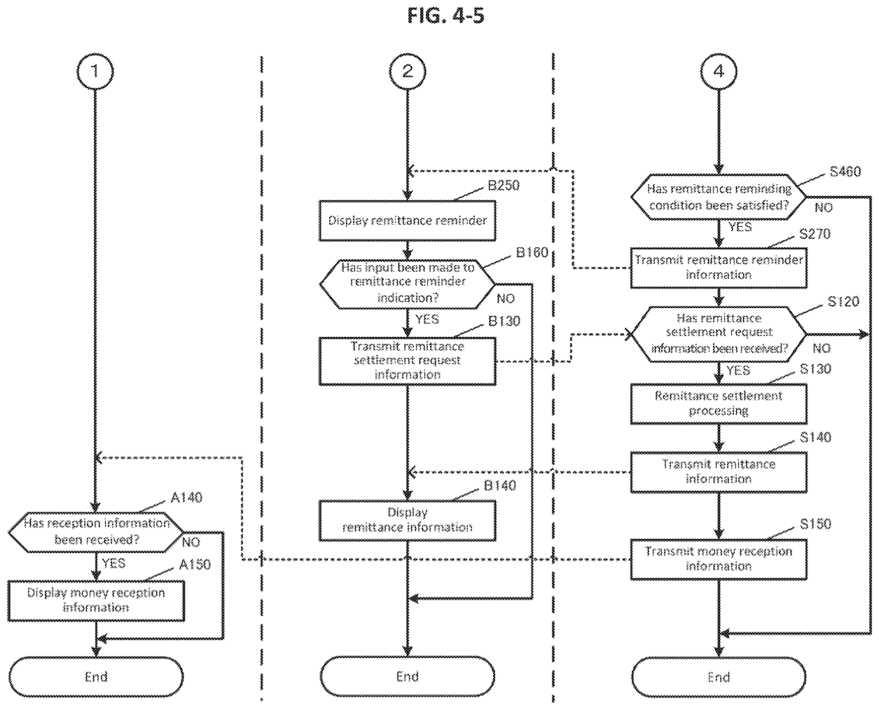

FIGS. 4-1 is a flowchart showing an example of a flow of processing executed by the devices in an example embodiment.

This flowchart corresponds to the portion of processing shown in FIG. 1-14 in the flowchart shown in FIGS. 1-13 and 1-14.

After step B140 shown in FIG. 1-13, the controller 21 of the terminal 20B determines whether or not a remittance reminding condition is satisfied (B450). Upon determining that the condition is satisfied (B450: YES), the controller 21 of the terminal 20B proceeds to step B150.

FIG. 4-2 is a diagram showing an example of remittance reminding condition data in which remittance reminding conditions according to the present embodiment are defined.

In a non-limiting example of, the remittance reminding conditions are defined in association with categories in the remittance reminding condition data.

Non-limiting examples of the categories include categories based on a plurality of different concepts, such as “time”, “balance”, “receipt of money (remittance)”, and “others”.

In a non-limiting example, each remittance reminding condition includes a condition number denoting the condition and the content of the remittance reminding condition having the condition number.

The following describes specific examples.

### (1) Category “Time”

As for condition No. “PA−1”, “the current time is set time” is defined as the content of the remittance reminding condition. Any time (non-limiting examples of which include midnight and noon) of every day may be set as the set time.

This condition means that a remittance reminder indication is displayed in the display 24 at the set time every day to notify the user that the remittance has not been done.

In this case, the controller 21 of the terminal 20 determines whether or not the time measured by the clock 29A is the set time, and upon determining that the measured time is the set time, displays a remittance reminder indication in the display 24.

As for condition No. “PA−2”, “a reminding timing has come and the current time is included in a first set time period” is defined as the content of the remittance reminding condition. Any time period of every day may be set as the first set time period.

This condition means that, when a timing for performing terminal reminding has come and the current time is included in the set time period, a remittance reminder indication is displayed in the display 24 to notify the user that the remittance has not been done.

In a non-limiting example, the first set time period may be a time period in which the user is highly likely to view the terminal 20, such as a time period from 9 p.m. to midnight in which the user is usually spending free time at home.

In the case where this condition is applied, terminal reminding can be performed at the timings described in the third embodiment (FIG. 3-1), for example.

In this case, the controller 21 of the terminal 20 determines whether or not it is a timing for performing terminal reminding. If it is a timing for performing terminal reminding, the controller determines whether or not the time measured by the clock 29A is included in the first set time period, and upon determining that the measured time is included in the first set time period, displays a remittance reminder indication in the display 24.

As for condition No. “PA−3”, “a reminding timing has come and the current time is not included in a second set time period” is defined as the content of the remittance reminding condition. Any time period of every day may be set as the second set time period.

This condition means that, when a timing for performing terminal reminding has come and the current time is not included in the set time period, a remittance reminder indication is displayed in the display 24 to notify the user that the remittance has not been done.

In a non-limiting example, the second set time period may be a time period in which the user is unlikely to view the terminal 20, such as a late-night time period (before 12 a.m. next day), a pre-dawn time period (before 3 a.m. next day), and a dawn time period (after 3 a.m. next day), in which the user is highly likely to be sleeping.

In the case where this condition is applied as well, terminal reminding can be performed at the timings described in the third embodiment (FIG. 3-1), for example.

In this case, the controller 21 of the terminal 20 determines whether or not it is a timing for performing terminal reminding. If it is a timing for performing terminal reminding, the controller determines whether or not the time measured by the clock 29A is included in the second set time period, and upon determining that the measured time is not included in the second set time period, displays a remittance reminder indication in the display 24.

As for condition No. “PA−4”, “the current date is set date” is defined as the content of the remittance reminding condition. Any date (non-limiting examples of which include “15^{th} of every month” and “25^{th} of every month”) may be set as the date of this case.

This condition means that a remittance reminder indication is displayed in the display 24 on the set date to notify the user that the remittance has not been done.

In a non-limiting example, the set date may be a date on which the remittance requested user has money to spare, such as a date (payday) on which the remittance requested user receives his or her wages or salary.

In this case, the controller 21 of the terminal 20 determines whether or not the current date is the set date based on time measurement information output from the clock 29A, and upon determining that the current date is the set date, displays a remittance reminder indication in the display 24.

### (2) Category “Balance”

As for condition No. “PB−1”, “the electronic money account balance is set amount or more” is defined as the content of the remittance reminding condition. Any amount (a non-limiting example of which is “\30,000”) may be set as the set amount.

This condition means that a remittance reminder indication is displayed in the display 24 to notify the user that the remittance has not been done, at a timing when the electronic money account balance has reaches or exceeds the set amount.

In a non-limiting example, the set amount may be a large amount to some extent, such as at least twice as much as the largest amount of remittance requested amounts for the remittance requested user, or at least 30,000 yen.

In this case, the controller 21 of the terminal 20 inquires the electronic money account balance of the user of the terminal 20 itself by means of the communication I/F 22, in a non-limiting example. Upon receiving the inquiry about the electronic money account balance from the terminal 20 by means of the communication I/F 14, the controller 11 of the server 10 transmits information of the electronic money account balance of the user to the terminal 20 by means of the communication I/F 14.

The controller 21 of the terminal 20 determines whether or not the electronic money account balance is equal to or more than the set amount based on the received information of the electronic money account balance, and upon determining that the balance is equal to or more than the set amount, displays a remittance reminder indication in the display 24.

As for condition No. “PB−2”, “the balance on hand is set amount or more” is defined as the content of the remittance reminding condition. Any amount (a non-limiting example of which is “\30,000”) may be set as the set amount.

This condition means that a remittance reminder indication is displayed in the display 24 to notify the user that the remittance has not been done when a balance on hand that is input to the terminal 20 by the user is equal to or more than the set amount.

In this case, the controller 21 of the terminal 20 makes the user input the balance on hand by displaying, in the display 24, a screen for prompting the user to input the balance on hand, for example. Then, the controller determines whether or not the input balance on hand is equal to or more than the set amount, and upon determining that the balance on hand is equal to or more than the set amount, displays a remittance reminder indication in the display 24.

### (3) Category “Receipt of Money (Remittance)”

As for condition No. “PC−1”, “obtained a loan and received money” is defined as the content of the remittance reminding condition.

This condition means that a remittance reminder indication is displayed in the display 24 to notify the user that the remittance has not been done, at a timing when money is deposited into the electronic money account or a bank account of the user as a result of the user using a loan service that is provided by an operator of the loan service, for example, and enables the user to obtain a loan with use of a loan application or the like relating to physical money or electronic money, for example.

In a non-limiting example, the operator of the loan service may be the same as or different from the operator of the payment application or the operator of the messaging service described above.

In the case where the operator of the loan service is a different operator, the operator of the loan service may associate with the operator of the payment application or the operator of the messaging service and provide information regarding the amount of the loan or the like of the user of the terminal 20 to the operator of the payment application or the operator of the messaging service by transmitting the information to the server 10, for example.

In a non-limiting example, the remittance reminding condition may be a condition that the remittance requested user has obtained money to spare as a result of money being deposited (remitted) from the operator of the loan service into the bank account (a non-limiting example of which is a net bank account) of the remittance requested user or the electronic money account of the remittance requested user in the payment application.

In this case, the controller 21 of the terminal 20 determines whether or not the user has received money by obtaining a loan, based on information (including notification) transmitted from the server 10, in a non-limiting example. Upon determining that the user has received money, the controller displays a remittance reminder indication in the display 24.

As for condition No. “PC−2”, “sold an item offered for sale and received money” is defined as the content of the remittance reminding condition.

This condition means that a remittance reminder indication is displayed in the display 24 to notify the user that the remittance has not been done, at a timing when money is deposited into the electronic money account of the user as a result of an item offered for sale by the user being purchased through a flea market service that is provided by an operator of a flea market service, for example, and enables the user to offer items for sale and to buy items with use of an application such as a flea market application (hereinafter referred to as a “flea market app”), for example.

In a non-limiting example, the remittance reminding condition may be a condition that the remittance requested user has obtained money to spare as a result of money being deposited (remitted) from the flea market app into the electronic money account of the remittance requested user in the payment application.

In this case, the controller 21 of the terminal 20 determines whether or not the user has received money as a result of selling an item offered for sale in the flea market app, based on information (including notification) transmitted from the server 10. Upon determining that the user has received money, the controller displays a remittance reminder indication in the display 24.

### (4) Category “Others”

As for condition No. “PD−1”, “sold an item offered for sale (not received money yet)” is defined as the content of the remittance reminding condition.

This condition means that a remittance reminder indication is displayed in the display 24 to notify the user that the remittance has not been done, at a timing when an item offered for sale by the user in the flea market app or the like is purchased (a timing when money has not been deposited into the electronic money account yet).

For example, when an item offered for sale by the remittance requested user in the flea market app or the like is purchased, it can be expected that money will be deposited into the electronic money account of the remittance requested user from the flea market app as a result of the item being purchased, although the money has not been deposited yet. Accordingly, such a case where it can be expected that the remittance requested user will obtain money to spare can be defined as the content of the remittance reminding condition.

In this case, the controller 21 of the terminal 20 determines whether or not an item offered for sale has been purchased in the flea market app based on information (including notification) transmitted from the server 10, and upon determining that the item has been purchased, displays a remittance reminder indication in the display 24.

As for condition No. “PD-2”, “seeking a job using a job hunting application” is defined as the content of the remittance reminding condition.

This condition means that a remittance reminder indication is displayed in the display 24 to notify the user that the remittance has not been done, at a predetermined timing (non-limiting examples of which include a timing when the user applies for entry to a company and a timing when the user gets an unofficial job offer from a company through a job hunting application) when the user is seeking a job using a service such as a job hunting service (job hunting application).

When the remittance requested user is seeking a job using a job hunting service or the like, for example, it can be expected that the user will get wages and obtain money to spare after being hired, and accordingly, such a case can be defined as the content of the remittance reminding condition.

In this case, the controller 21 of the terminal 20 determines whether or not the job hunting application is being executed in the terminal 20 itself, and upon determining that the application is being executed, displays a remittance reminder indication in the display 24.

As for condition No. “PD−3”, “purchased an item offered for sale in the flea market app” is defined as the content of the remittance reminding condition.

This condition means that a remittance reminder indication is displayed in the display 24 to notify the user that the remittance has not been done, at a timing when the user has purchased an item offered for sale using the service of the flea market app or the like.

Such a case where the remittance requested user has purchased an item using the flea market app or the like, for example, and the remittance requested user can be thought to have money to spare can be defined as the content of the remittance reminding condition.

In this case, the controller 21 of the terminal 20 determines whether or not the user has purchased an item offered for sale in the flea market app based on information (including notification) transmitted from the server 10, and upon determining that the user has purchased an item, displays a remittance reminder indication in the display 24.

In a non-limiting example, the remittance reminding conditions described above may be set by the terminal 20 of the remittance requested user based on input that is made by the remittance requested user to the terminal 20 of the remittance requested user, and may be stored in the storage 28 of the terminal 20 of the remittance requested user.

Note that there is no limitation to this configuration, and the remittance reminding conditions described above may optionally be set by the terminal 20 of the remittance master user based on input that is made by the remittance master user to the terminal 20 of the remittance master user, for example. In a non-limiting example of this case, the remittance reminding condition set by the terminal 20 of the remittance master user may be transmitted to the terminal 20 of the remittance requested user via the server 10 and stored in the storage 28 of the terminal 20 of the remittance requested user.

Also, the terminal 20 of the remittance requested user may determine whether or not one of the remittance reminding conditions described above is satisfied, or determine whether or not two or more conditions are satisfied. That is, the determination may also be performed with respect to a combination of two or more conditions.

### Display Screen

FIG. 4-3 shows an example in which a user (B.B) who received remittance request information but has not completed remittance yet carried out a transaction using the flea market app described above, and the account of the user (B.B) received money corresponding to the sales amount.

The terminal 20 of the user (B.B) receives a message MS25 indicating that the transaction carried out through the payment application has been completed, from an official account of the payment application.

In a non-limiting example, this message MS25 includes the text “Transaction completed” indicating that the transaction has been completed, the sales amount (in this example, “\1,600”) of the transaction, an icon showing the text “Receipt” indicating that the sales amount is to be received by the user (B.B), and date and time (in this example, 2020.04.23 20:59) at which the transaction was completed.

In the case where this message MS25 is displayed, it is highly likely that at least the amount corresponding to the sales amount is in the electronic money account of the user (B.B).

Subsequently, the terminal 20 of the user (B.B) receives a message MS26 indicating reception of remittance reminder information from the official account of the payment application as shown in FIG. 4-4.

The content of the message MS26 is the same as the content of the remittance reminder indication MS4A described above, other than that the message MS26 includes an icon image of the official account rather than the icon image of the first user (A.A).

In a non-limiting example, the terminal 20 receives the message MS26 immediately after receiving the message MS25. Therefore, it can be said that it is highly likely that the user (B.B) will check the message MS26 in the state where at least the amount corresponding to the sales amount is in the electronic money account of the user (B.B).

In a non-limiting example, by displaying this message MS26, it is possible to prompt the user (B.B) to remit immediately after money is deposited into the account of the user (B.B).

### Effects of Fourth Example Embodiment

In an example embodiment, a configuration is described in which a remittance reminder indication (a non-limiting example of the second indication) is displayed in the terminal 20 of the remittance requested user based on a remittance reminding condition (a non-limiting example of a first condition).

As an example of effects of the embodiment obtained with this configuration, the second indication based on a remittance request can be appropriately displayed in the display of the terminal based on the set first condition.

Also, in an example embodiment, a configuration is described in which the remittance reminding condition includes a condition of a point in time, a time period, a date, an elapsed time, or the like (a non-limiting example of a condition relating to time).

As an example of effects of the embodiment obtained with this configuration, the second indication based on the remittance request can be appropriately displayed in the display of the terminal based on the condition relating to time.

Also, in an example embodiment, a configuration is described in which the remittance reminding condition includes a condition of a point in time or a period of time set by the terminal 20 (a non-limiting example of the terminal) of the remittance requested user.

As an example of effects of the embodiment obtained with this configuration, the second indication based on the remittance request can be displayed in the display of the terminal at an appropriate timing in accordance with the intention of the remittance requested user.

Also, in an example embodiment, a configuration is described in which the remittance reminding condition includes a condition of a point in time or a period of time set by the terminal 20 of the remittance master user (a non-limiting example of a terminal of the first user).

As an example of effects of the embodiment obtained with this configuration, the second indication based on the remittance request can be displayed in the display of the terminal at an appropriate timing in accordance with the intention of the first user requesting remittance.

Also, in an example embodiment, a configuration is described in which the remittance reminding condition includes a condition relating to a balance such as the electronic money account balance or a balance on hand of the remittance requested user (a non-limiting example of a balance associated with the user of the terminal).

As an example of effects of the embodiment obtained with this configuration, the second indication based on the remittance request can be displayed in the display of the terminal at an appropriate timing according to the balance of the remittance requested user.

Also, in an example embodiment, a configuration is described in which the remittance reminding condition includes a condition relating to reception of money by (or remittance to) the remittance requested user.

As an example of effects of the embodiment obtained with this configuration, the second indication based on the remittance request can be displayed in the display of the terminal based on the condition relating to remittance to the user of the terminal.

Also, in an example embodiment, a configuration is described in which the condition relating to reception of money by (or remittance to) the remittance requested user includes reception of money (or remittance) as a result of the remittance requested user obtaining a loan.

As an example of effects of the embodiment obtained with this configuration, the second indication based on the remittance request can be displayed in the display of the terminal at a timing when the user of the terminal is highly likely to have money to spare by obtaining a loan.

Also, in an example embodiment, a configuration is described in which the condition relating to reception of money by (or remittance to) the remittance requested user includes reception of money by (or remittance to) the remittance requested user from a purchaser who purchased an item offered for sale by the remittance requested user.

As an example of effects of the embodiment obtained with this configuration, the second indication based on the remittance request can be displayed in the display of the terminal at a timing when the user of the terminal is highly likely to have money to spare as a result of an item offered for sale by the user of the terminal being purchased and the user receiving money from the purchaser (or the money being remitted from the purchaser to the user).

Also, in an example embodiment, a configuration is described in which the remittance request condition includes a condition relating to purchase of an item offered for sale by the remittance requested user.

As an example of effects of the embodiment obtained with this configuration, the second indication based on the remittance request can be displayed in the display of the terminal based on the expectation that the user of the terminal will obtain money to spare as a result of selling an item offered for sale by the user of the terminal.

### Fourth Modification (1)

A configuration is also possible in which the server 10 determines whether or not a remittance reminding condition is satisfied and performs server reminding using the method described in an example embodiment.

In this case, conditions similar to the remittance reminding conditions shown as examples in the table of FIG. 4-2 can be basically applied. However, in this modification, not the terminal 20 but the server 10 determines whether or not the remittance reminding conditions are satisfied.

The controller 11 of the server 10 can make determination on the conditions in the category “time” based on time measurement information output from the clock 19.

In a non-limiting example of such a case, the timings of server reminding described in an example embodiment (1) (FIG. 3-2) may be applied as reminding timings of the case where the condition No. “PA−2” or “PA−3” is applied.

The controller 11 of the server 10 can make determination on the conditions in the category “balance” based on information of the electronic money account balance of the user of the terminal 20, which is stored and managed in the storage 15, or information of a balance on hand of the user of the terminal 20, which is input to the terminal 20 and transmitted to the server 10.

The controller 11 of the server 10 can make determination on the conditions in the category “receipt of money (remittance)” based on updating of information of the electronic money account balance of the user of the terminal 20, which is stored and managed in the storage 15, through remittance settlement processing.

As for the conditions in the category “others”, if the flea market service is provided as a part of the payment service, the controller 11 of the server 10 can make determination on the condition No. “PD−1” by detecting an item offered for sale by the user of the terminal 20 being purchased with use of the flea market service.

If the business operator providing the flea market service is different from the business operator providing the payment service, in order to enable the controller 11 of the server 10 to make determination, a configuration can be adopted in which the controller 11 can obtain information indicating that an item offered for sale by the user of the terminal 20 is purchased, from a server device or the like of the business operator providing the flea market service.

If the job hunting service is provided as a part of the payment service, the controller 11 of the server 10 can make determination on the condition No. “PD−2” by detecting the user of the terminal 20 searching for job offer information with use of the job hunting service.

If the business operator providing the job hunting service is different from the business operator providing the payment service, in order to enable the controller 11 of the server 10 to make determination, a configuration can be adopted in which the controller 11 can obtain information indicating that the user of the terminal 20 is using the job hunting service, from a server device or the like of the business operator providing the job hunting service.

If the flea market service is provided as a part of the payment service, the controller 11 of the server 10 can make determination on the condition No. “PD−3” by detecting the user of the terminal 20 purchasing an item offered for sale with use of the flea market service.

If the business operator providing the flea market service is different from the business operator providing the payment service, in order to enable the controller 11 of the server 10 to make determination, a configuration can be adopted in which the controller 11 can obtain information indicating that the user of the terminal 20 purchased an item offered for sale, from the server device or the like of the business operator providing the flea market service.

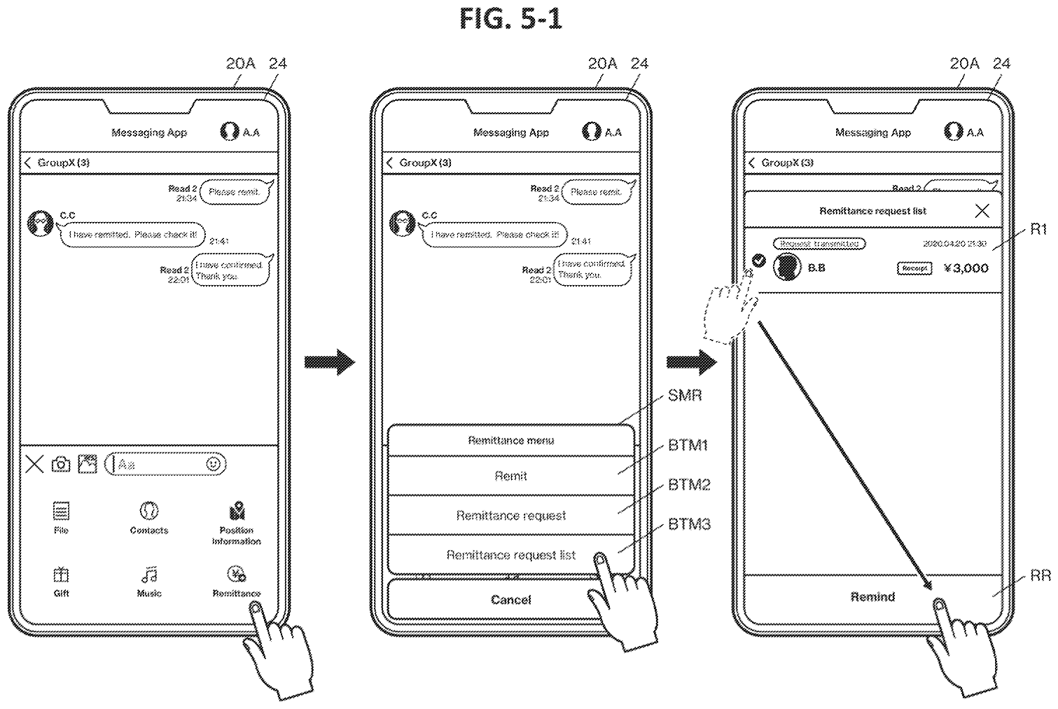

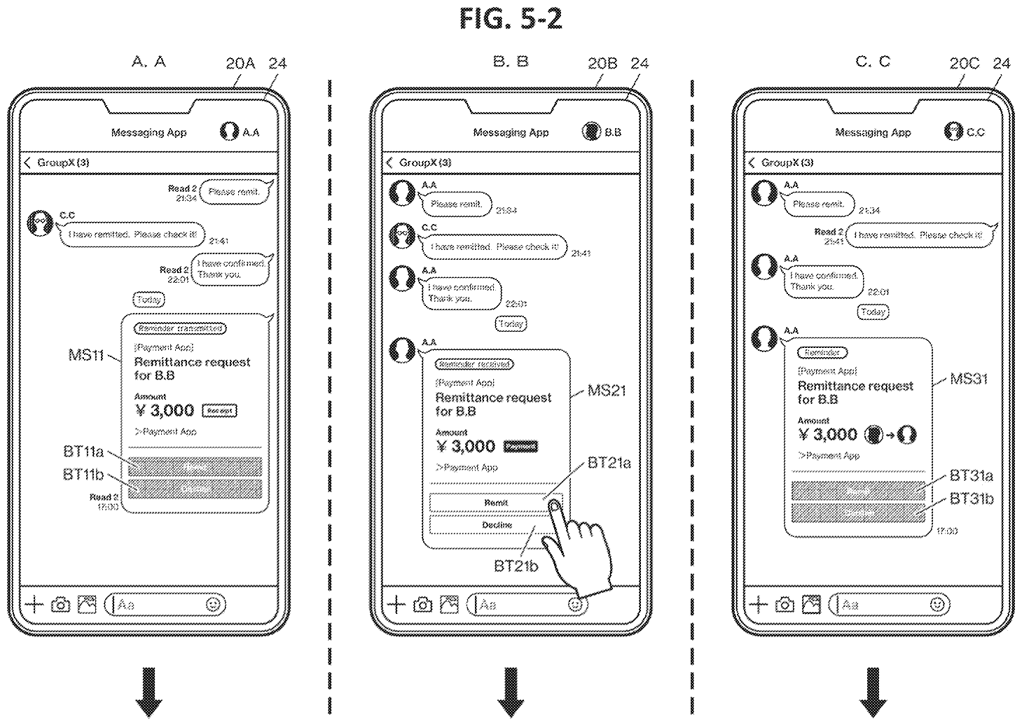

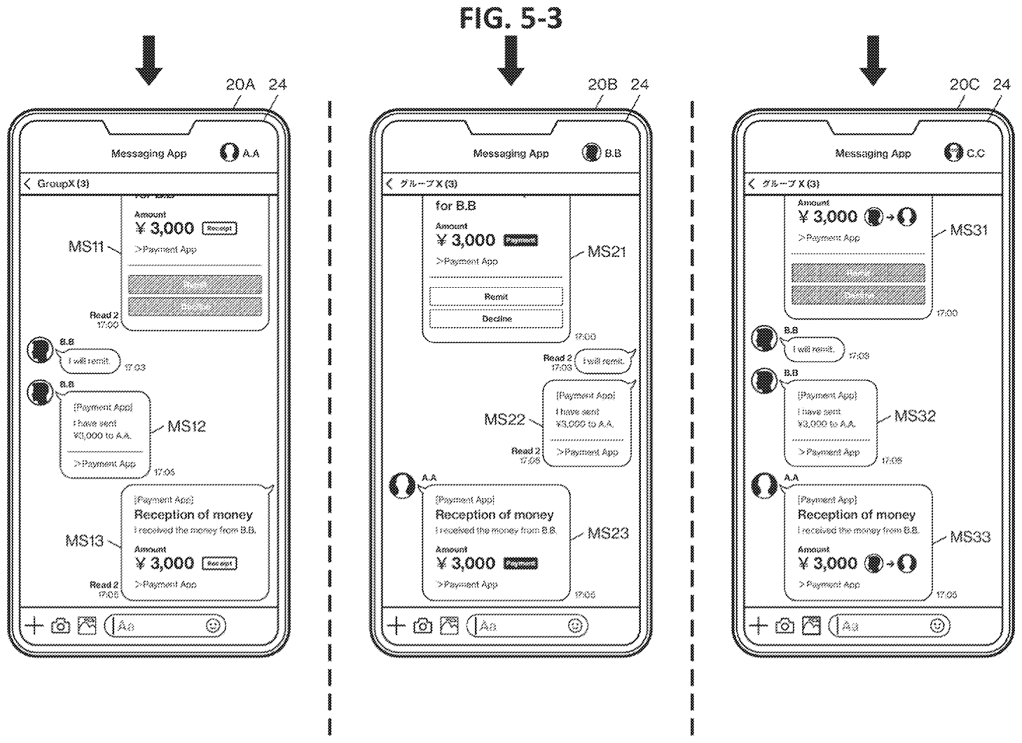

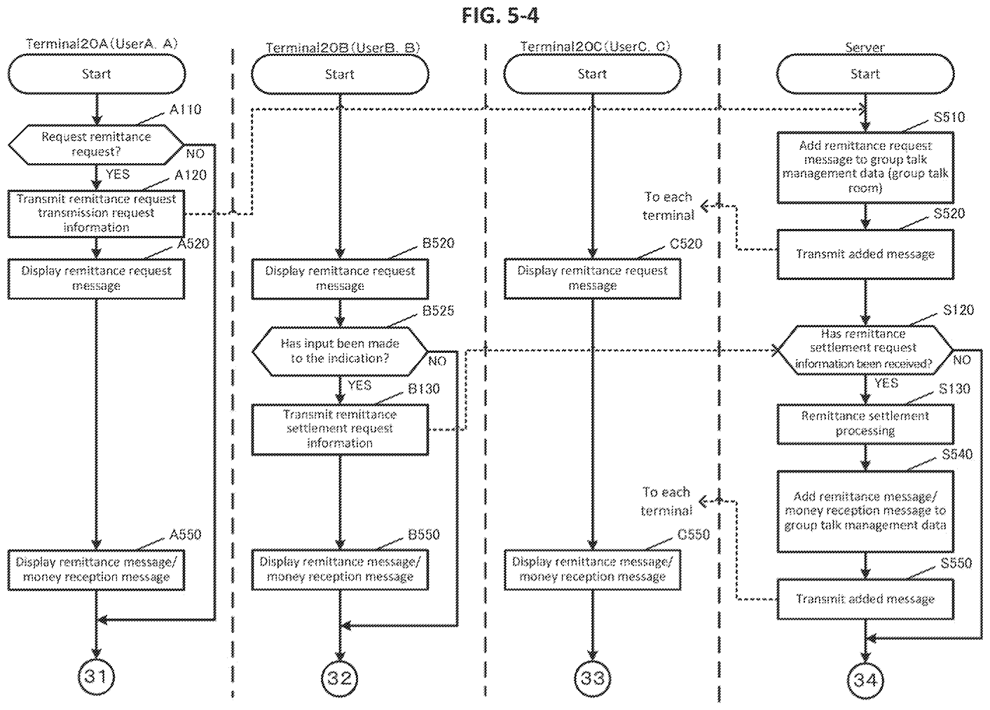

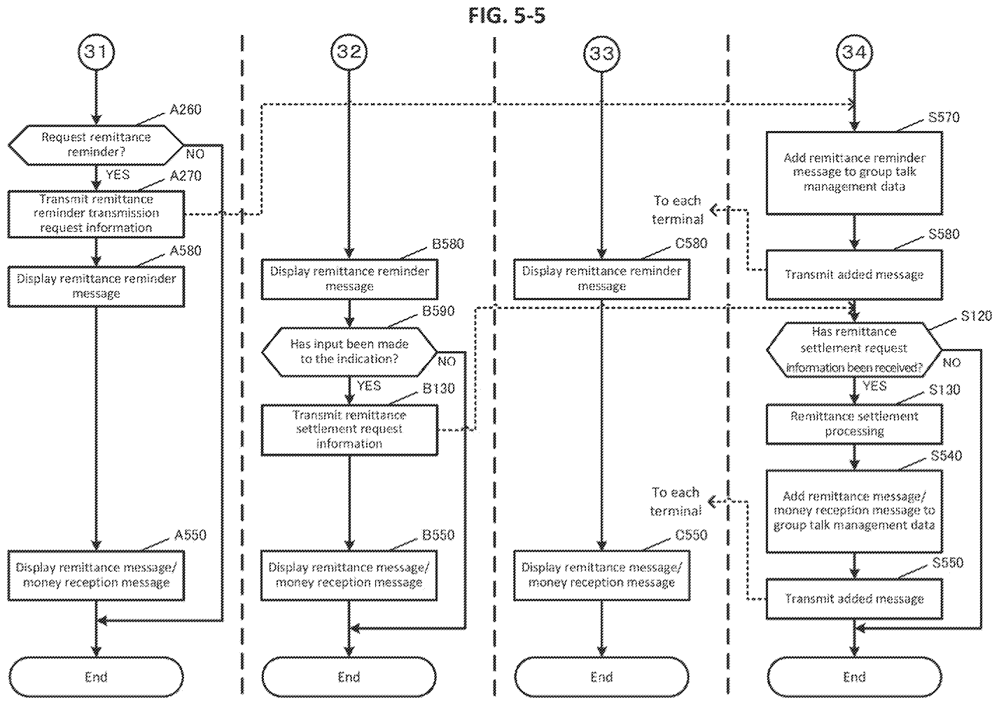

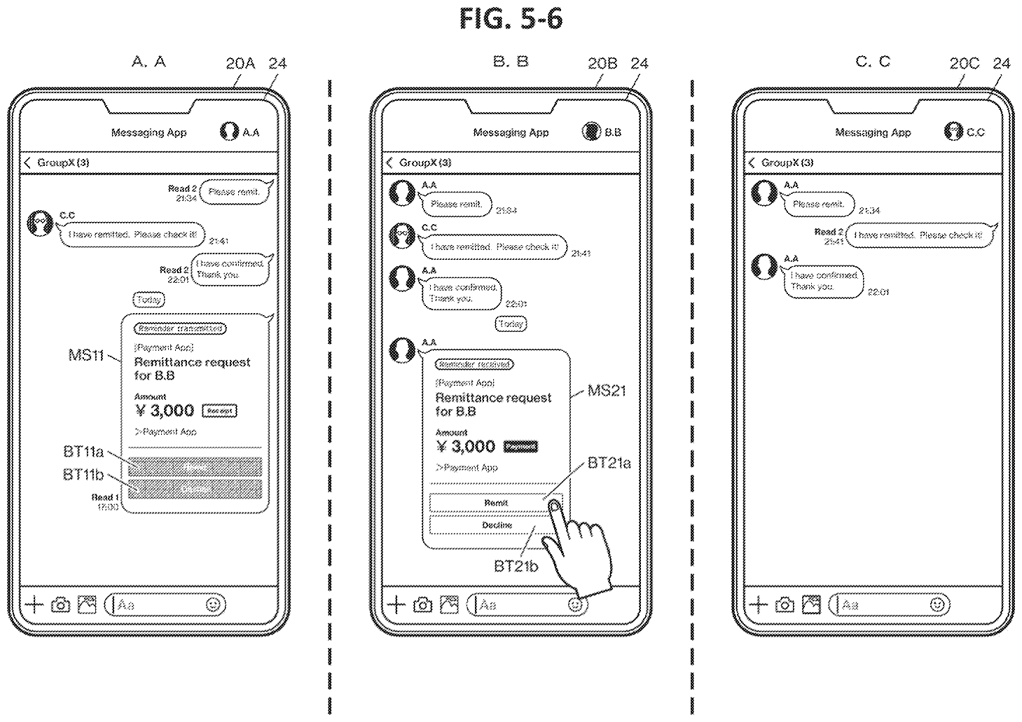

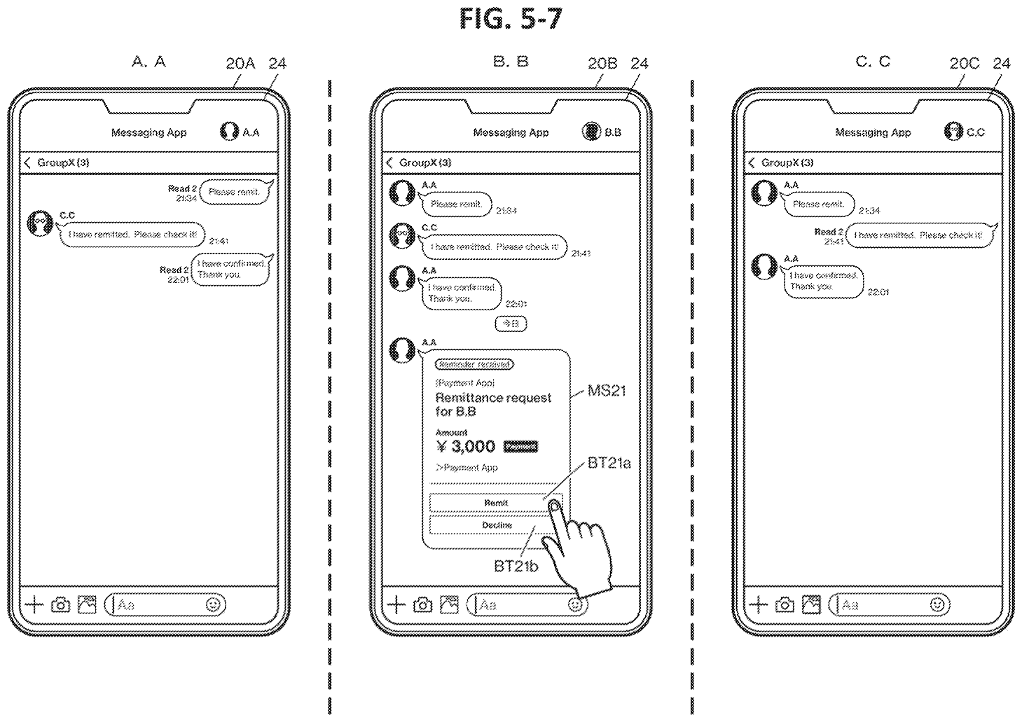

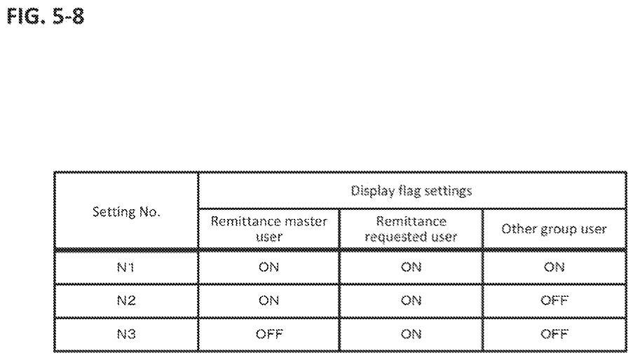

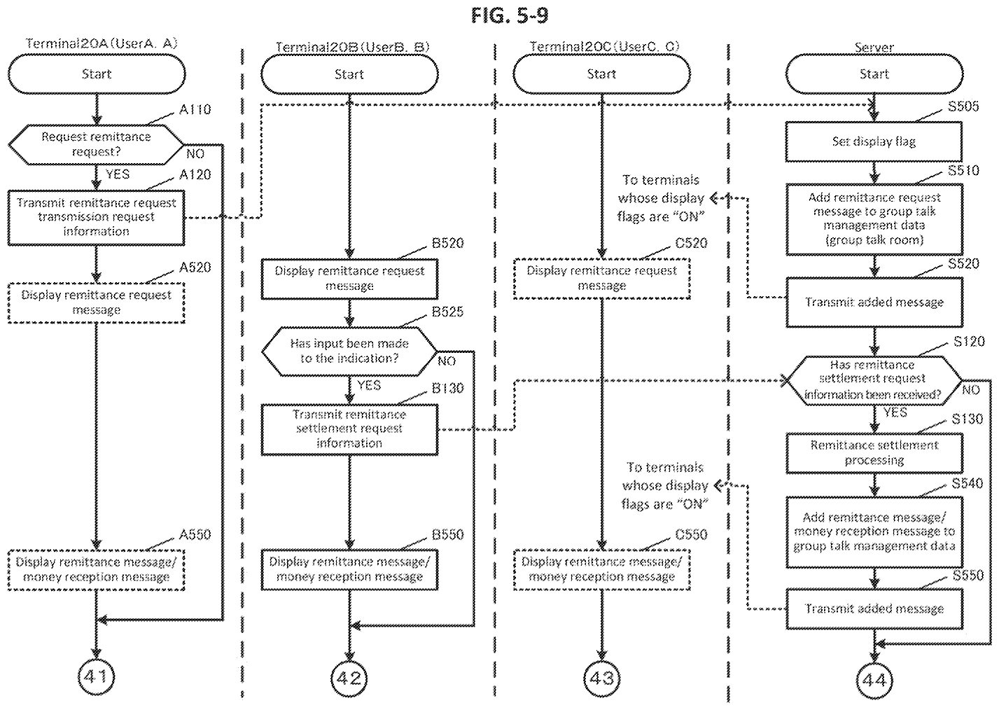

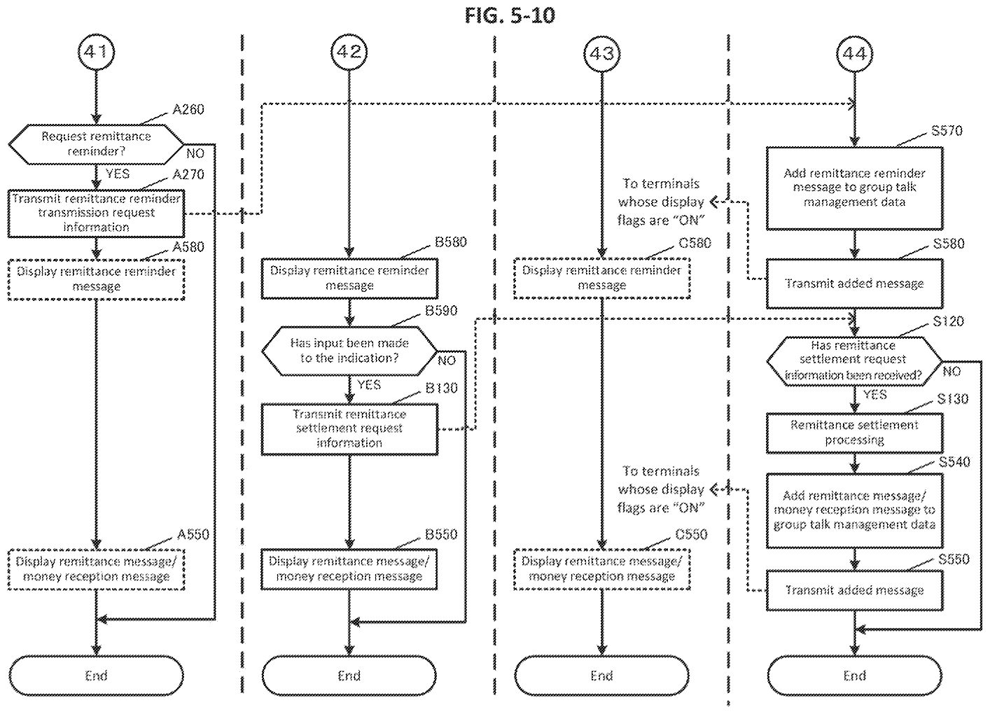

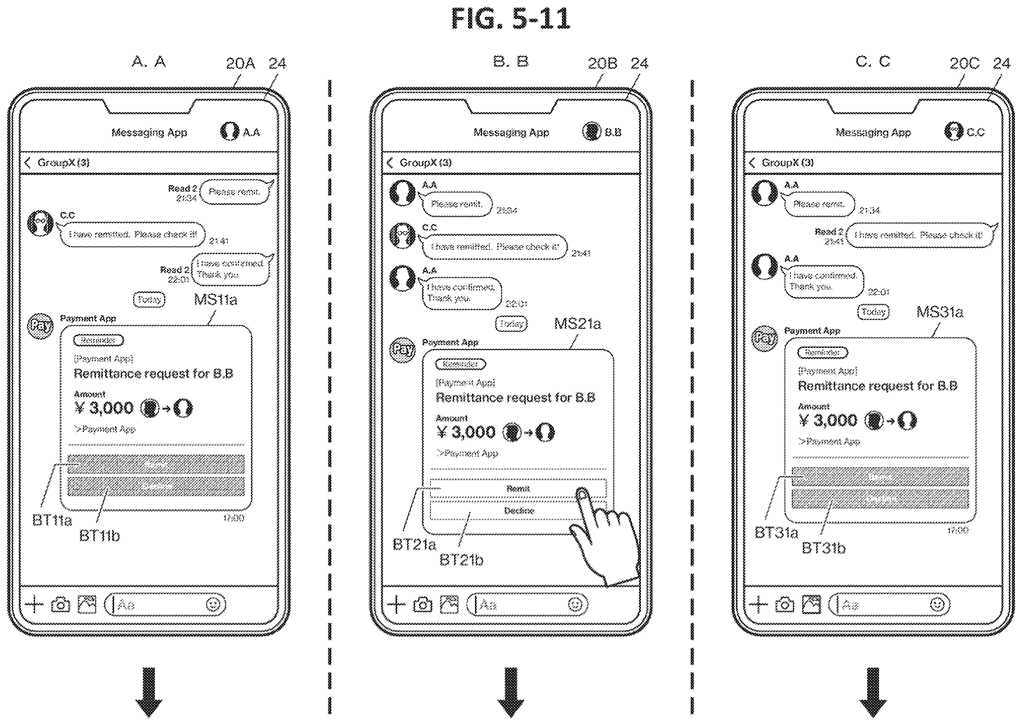

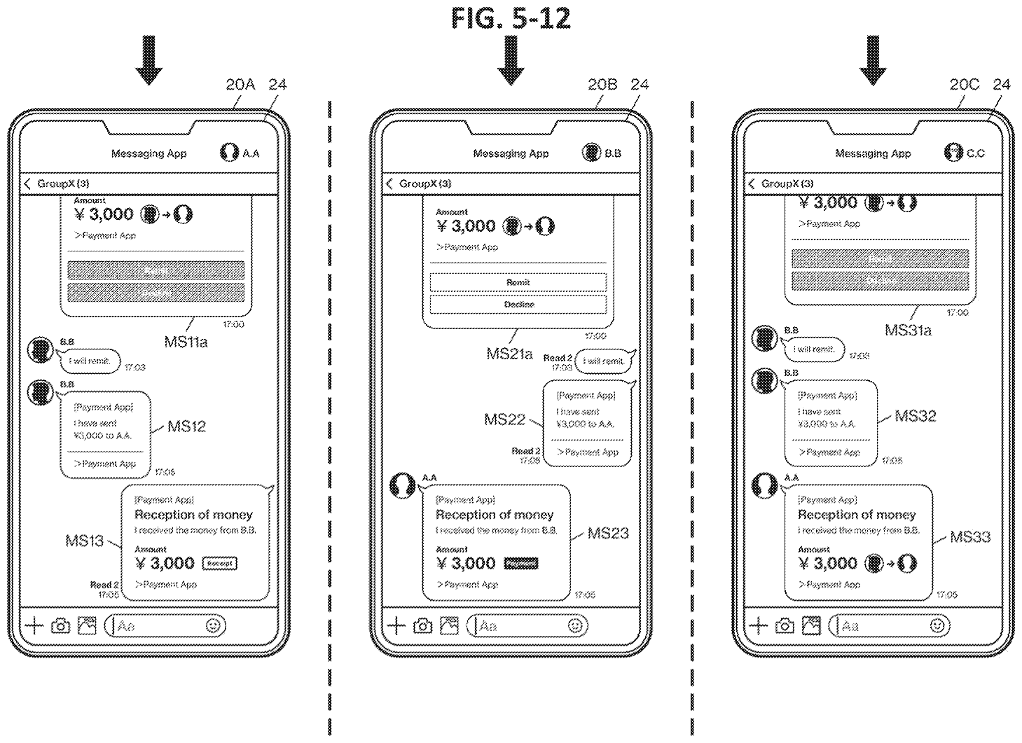

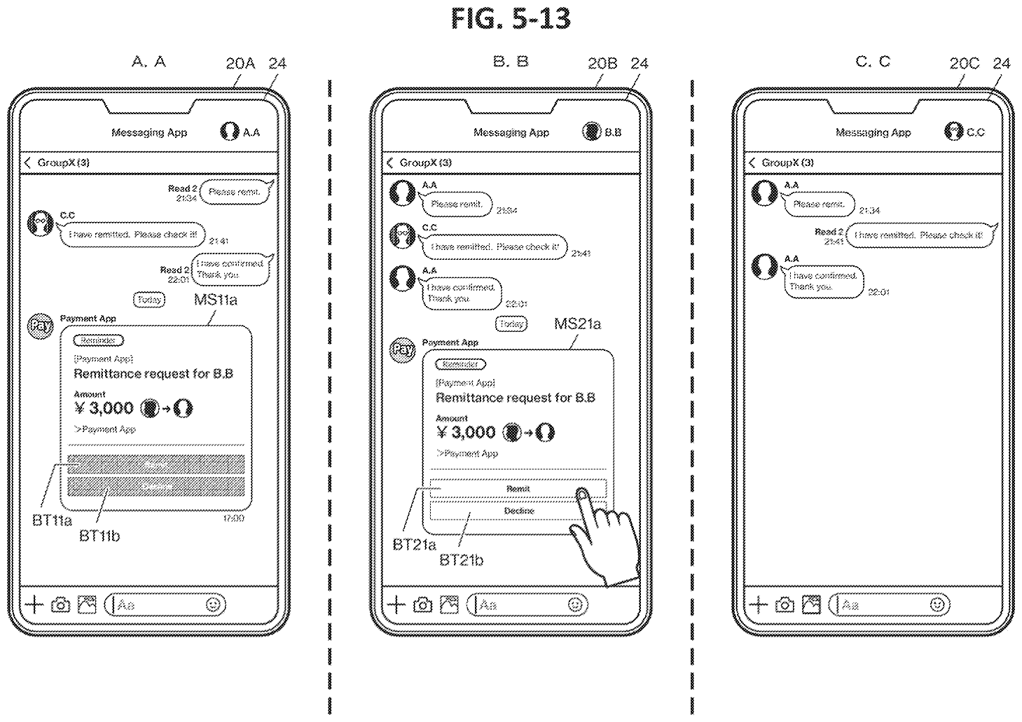

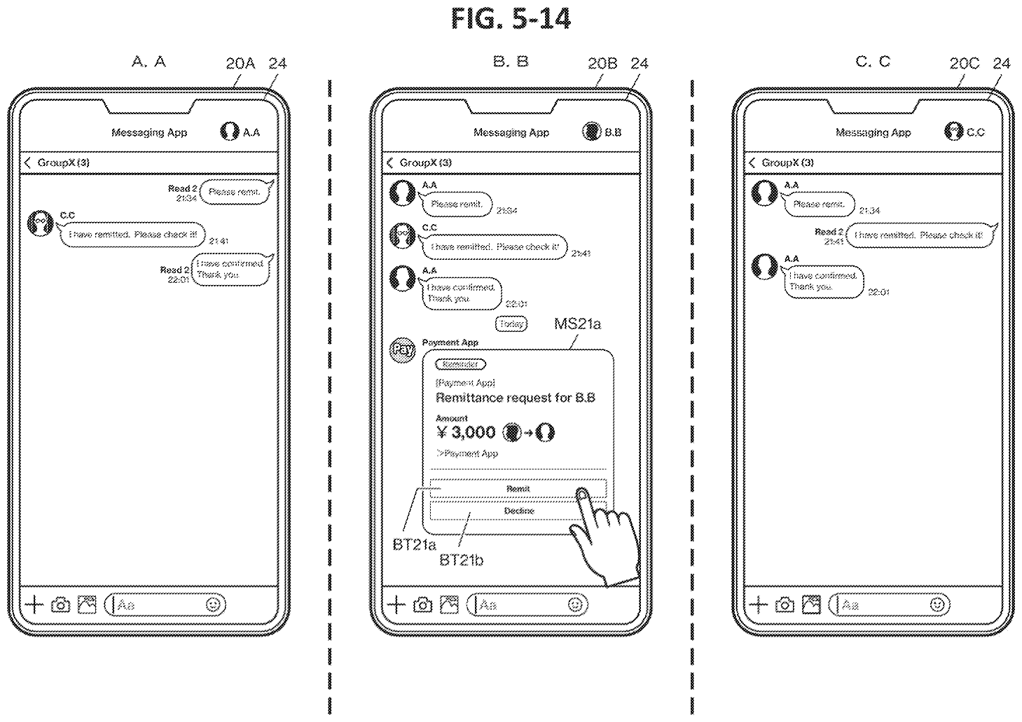

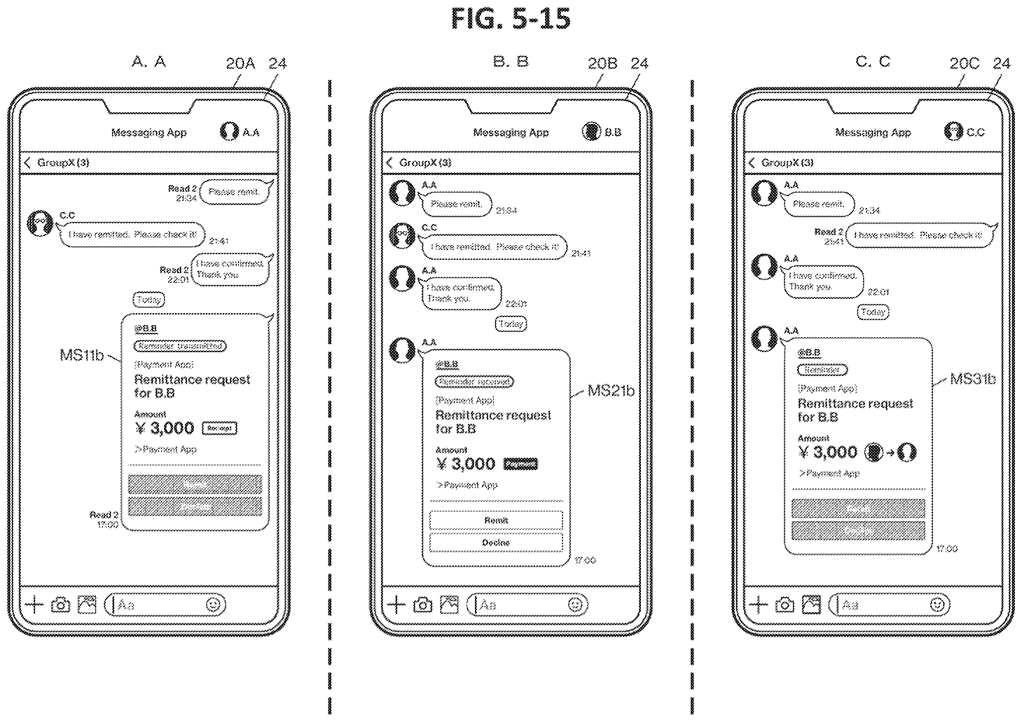

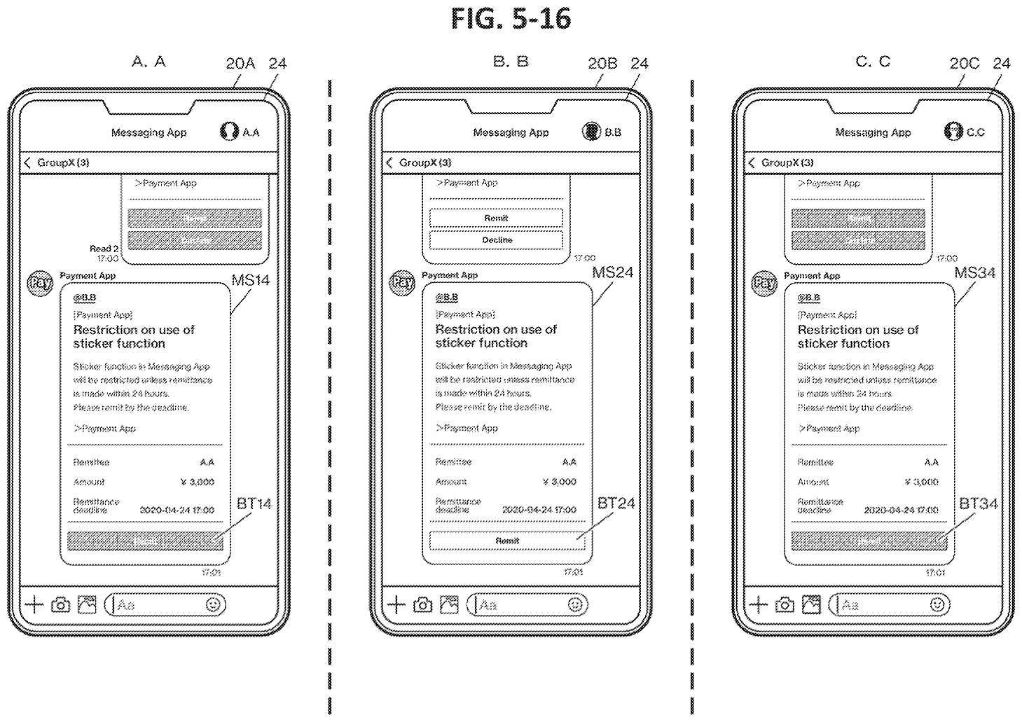

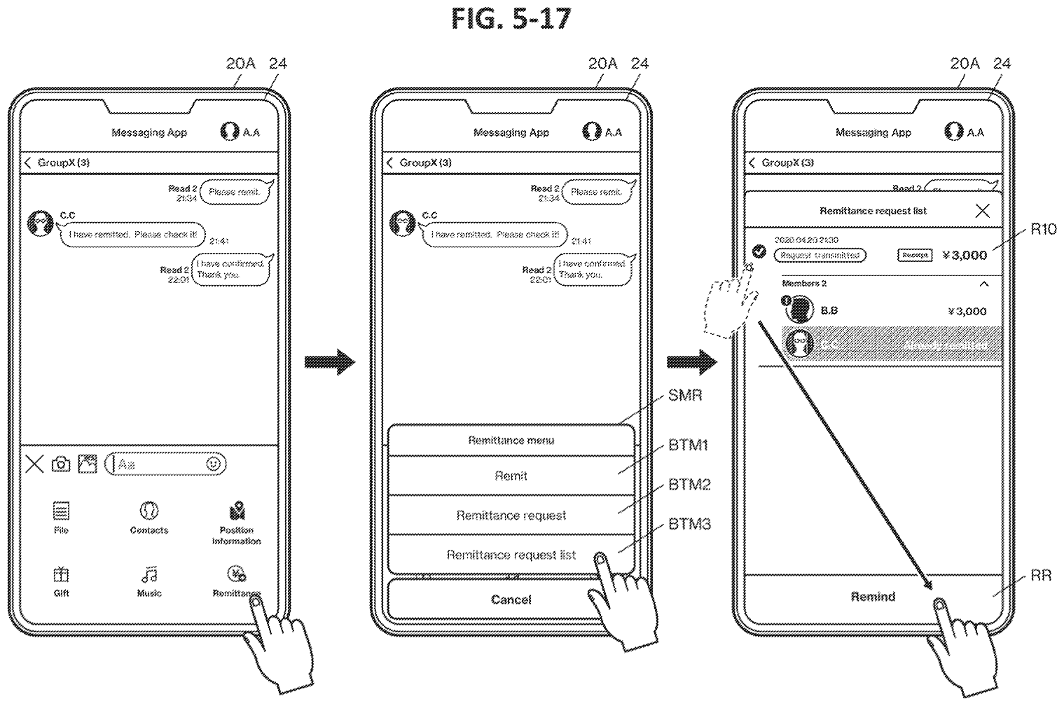

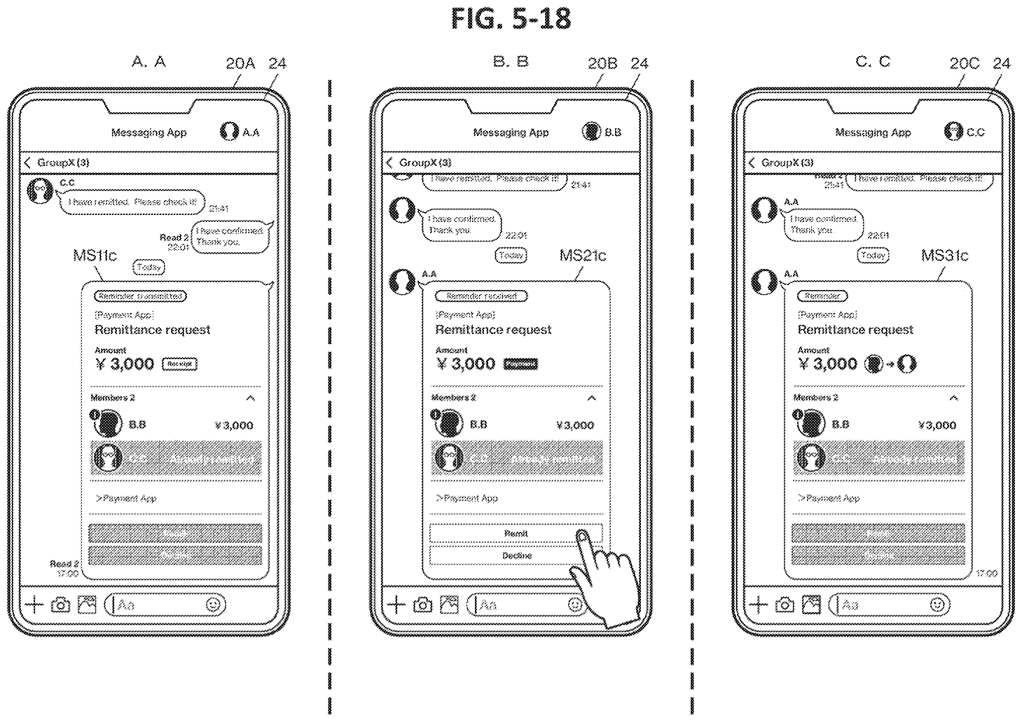

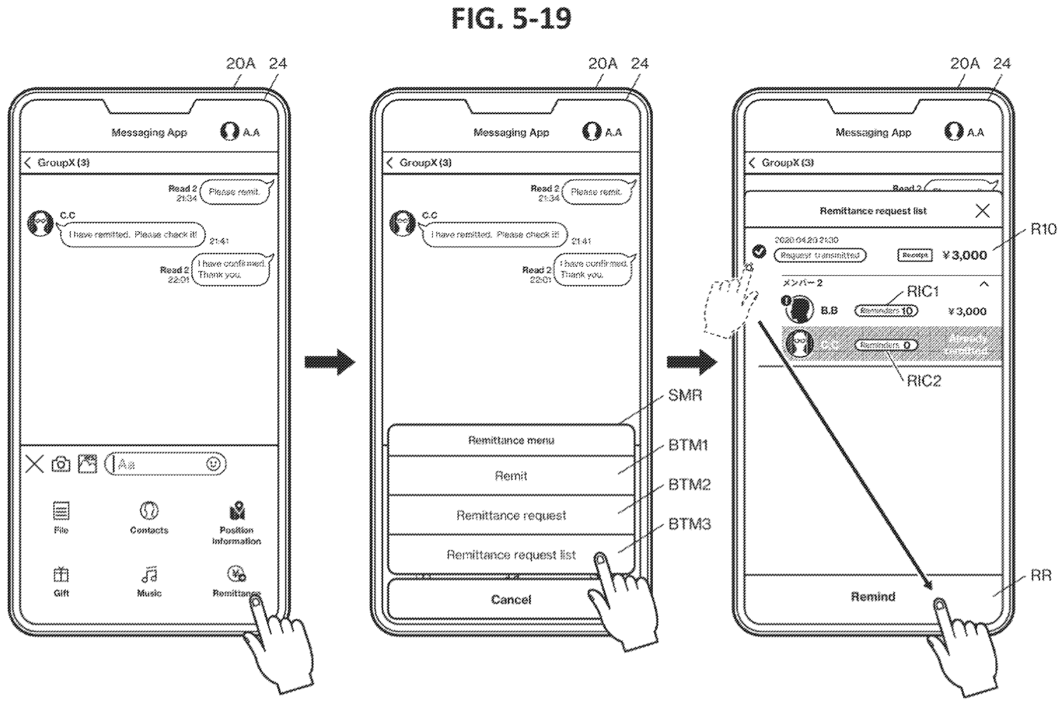

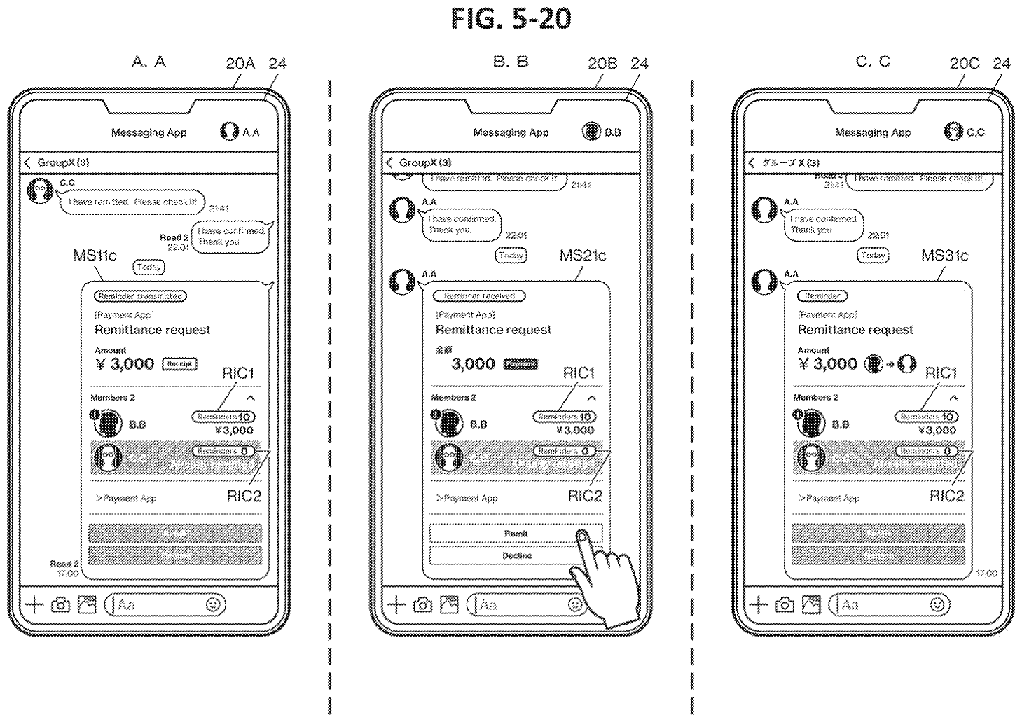

FIG. 4-5 is a flowchart showing an example of a flow of processing executed by the devices in this modification.

The portion of processing shown in FIG. 4-1 is modified in this flowchart.

After step S150 shown in FIG. 1-13, the controller 11 of the server 10 determines whether or not a remittance reminding condition is satisfied (S460). Upon determining that the condition is satisfied (S460: YES), the controller 11 of the server 10 proceeds to step S270.

Upon receiving remittance reminder information from the server 10 by means of the communication I/F 22, the controller 21 of the terminal 20B executes the processing in step B250.

In this modification, the terminal 20 of the remittance requested user receives remittance reminder information (a non-limiting example of the second information based on the remittance request) by means of the communication I/F 22 based on whether or not the remittance reminding condition (a non-limiting example of the first condition) is satisfied. Then, a remittance reminder indication is displayed in the display 24 of the terminal 20 of the remittance requested user based on reception of the remittance reminder information.

As an example of effects of the embodiment obtained with this configuration, the second information based on the remittance request can be received and displayed by the terminal based on the first condition. Also, the terminal need not determine whether or not the first condition is satisfied, and accordingly, a processing load on the terminal can be reduced.

### Fourth Modification (2)

In an example embodiment (1), the remittance reminding conditions on which the controller 11 of the server 10 makes determination may optionally include “reception of remittance reminder transmission request information from the terminal of the remittance master user”.

Processing of this case can be implemented by combining the processing shown in FIG. 2-12 and the processing shown in FIG. 4-5.

### Fifth Example Embodiment

In a fifth embodiment, the remittance request indication and the remittance reminder indication described above are displayed in a chat room that can be used in a chat service.

Matter described in an example embodiment can also be applied to other embodiments and modifications.

Constitutional elements that are the same as those already described are denoted with the same reference numerals as those used for corresponding elements, and a redundant description thereof is omitted.

In an example embodiment, a case is described as an example in which the remittance request indication and the remittance reminder indication are displayed by a messaging application installed in the terminal 20 with use of a chat service, which is a messaging service (a non-limiting example of which is an instant messaging service: IMS).

Also, a talk room is described as an example of a chat room in the case where the messaging service (messaging application) is applied.

### Display Screen

In the following example, the users A.A, B.B, and C.C who are users of the messaging application and also users of the payment application belong to a group X and are registered as friends of each other.

In the example shown in FIG. 5-1, messages transmitted between friends in a talk room (a non-limiting example of a chat room) of the group X are displayed in the display 24 of the terminal 20 of the user A.A.

In this example, the user A.A requested remittance from the users B.B and C.C by sending a message, and the message has been read by the users B.B and C.C (Read 2).

That is, the user A.A is an example of the first user requesting remittance, and the users B.B and C.C are examples of users of terminals 20 that received remittance request information.

In this example, the user C.C of one of the terminals 20 replied that the user C.C has remitted, but the user B.B of the other terminal 20 has not replied.

When the user A.A taps a remittance icon at the lower right among icons displayed in the lower portion of the talk room, a remittance item selection region SMR is displayed on the talk room.

At the top of the remittance item selection region SMR, information (a non-limiting example of which is the text “Remittance menu”) is displayed indicating that processing based on functions relating to remittance will be executed when buttons shown below are operated.

A button BTM1 for sending money to other users, a button BTM2 for transmitting remittance request information to other users, and a button BTM3 for displaying a remittance request history are displayed below the above information.

In a non-limiting example, when the user A.A, who is the first user, taps the button BTM3, a history of past remittance requests from the user A.A for which remittance processing has not been completed is displayed on the talk room.

In this example, the first user (A.A) transmitted remittance request information to the user B.B of the terminal 20, but remittance processing relating to this remittance request has not been completed. Therefore, the icon image and the user name of the user B.B, an icon showing the text “Request transmitted”, date and time (2020.04.20 21:30) at which the remittance request information was transmitted, an icon showing the text “Receipt” indicating that the user A.A is to be paid by the user B.B, and an amount (\3,000) to be received from the user B.B are displayed in the region R1.

Also, a region RR showing the text “Remind” is provided at the bottom of the screen in this example. When the first user (A.A) checks a checkbox in the region R21, information displayed in the region R21 is selected.

When the region RR is tapped in this state, remittance reminder information based on the information displayed in the region R1 is transmitted to the terminal 20 of the user (B.B) to whom the remittance request information was transmitted.

FIG. 5-2 shows a non-limiting example of a relationship between a message displayed in the terminal 20 of the first user (A.A) belonging to the group X, a message displayed in the terminal 20 of the user (B.B) to whom a remittance reminder is issued from the first user, and a message displayed in the terminal 20 of the user (C.C) to whom a remittance reminder is not issued from the first user.

In the terminal 20 of the first user (A.A), a message MS11 is displayed as a message transmitted by the first user (A.A), based on transmission of the remittance reminder information to the terminal 20 of the user B.B.

In a non-limiting example, the message MS11 includes an icon showing the text “Reminder transmitted” and indicating that the remittance reminder information has been transmitted to a user in the group, the text “[Payment App]” indicating that this message is based on functions of the payment application, the user name of the user in the group who received the remittance reminder information (in this example, the text “Remittance request for B.B”), the remittance amount (in this example, \3,000) requested by the remittance reminder information, and an icon showing the text “Receipt” and indicating that the user (A.A) is to be paid.

In a non-limiting example, a remittance button BT11a showing the text “Remit” and a button BT11b showing the text “Decline” are displayed below the message MS11.

Here, even if the first user (A.A) taps the remittance button BT11a, the screen does not shift to the remittance screen and the remittance processing is not executed because the remittee associated with this message MS11 is the first user (A.A).

Accordingly, the remittance button BT11a is displayed in an unselectable manner because the remittance processing is not executed in response to an operation performed on the button.

Also, even if the first user (A.A) taps the button BT11b, a message indicating a decline to remit is not transmitted to another user because the remittee associated with this message MS11 is the first user (A.A).

Accordingly, the button BT11b is displayed in an unselectable manner because the message is not transmitted in response to an operation performed on the button.

In the terminal 20 of the user B.B who received the remittance reminder information, a message MS21 is displayed as a message from the first user (A.A), based on transmission of the remittance reminder information from the first user (A.A).

In a non-limiting example, the message MS21 includes an icon showing the text “Reminder received” and indicating that the remittance reminder information has been received from a user in the group, the text “[Payment App]” indicating that this message is based on functions of the payment application, the user name of the user (himself or herself) in the group who received the remittance reminder information (in this example, the text “Remittance request for B.B”), the remittance amount (in this example, \3,000) requested by the remittance reminder information, and an icon showing the text “Payment” and indicating that the user (B.B) is requested to make payment.

In a non-limiting example, a remittance button BT21a showing the text “Remit” and a button BT21b showing the text “Decline” are displayed below the message MS21.

When the user (B.B) of the terminal 20 taps the remittance button BT21a, the screen shifts to the remittance screen described above, and the remittance processing can be executed.

That is, the remittee associated with this message MS21 is the first user (A.A) whose icon image and user name are displayed in correspondence with the message MS21, and accordingly, an amount corresponding to the remittance requested amount (in this example, \3,000) is remitted from an account of the user B.B to an account of the user A.A in response to an operation performed on the remittance button 21a.

Accordingly, unlike the remittance button BT11a described above and a remittance button 31a described below, the remittance button BT21a is displayed in a selectable manner because the remittance processing is executed in response to an operation performed on the button.

Also, when the user (B.B) of the terminal 20 taps the button BT21b, a message indicating a decline to remit is transmitted to the first user (A.A) associated with the message MS21.

Accordingly, unlike the button BT1 lb described above and a button 31b described below, the button BT21b is displayed in a selectable manner because the message is transmitted in response to an operation performed on the button.

In the terminal 20 of the other user (C.C) who is neither the first user (A.A) nor the user (B.B) to whom the remittance reminder is issued, a message MS31 is displayed as a message transmitted by the first user (A.A), based on transmission of the remittance reminder information from the first user A.A to the user B.B.

In a non-limiting example, the message MS31 includes an icon showing the text “Reminder” and indicating that the remittance reminder information has been transmitted from a user (first user A.A) to another user (B.B) other than himself or herself, the text “[Payment App]” indicating that this message is based on functions of the payment application, the user name of the user in the group who received the remittance reminder information (in this example, the text “Remittance request for B.B”), the remittance amount (in this example, \3,000) requested by the remittance reminder information, the icon image of the first user (A.A), and the icon image of the user (B.B) who received the remittance reminder information.

Note that an arrow directed from the icon image of the first user (A.A) to the icon image of the user (B.B) who received the remittance reminder information is displayed. This enables the other user (C.C) to recognize that the remittance reminder information has been transmitted from the user (A.A) to the user (B.B) other than himself or herself

Also, in a non-limiting example, the message MS31 does not include the icon showing the text “Reminder transmitted”, which is included in the message MS11, and the icon showing the text “Reminder received”, which is included in the message MS21. This enables the user (C.C) to recognize that the remittance reminder relating to the message MS31 is neither issued from himself or herself to another user nor issued from another user to himself or herself

In a non-limiting example, a remittance button BT31a showing the text “Remit” and a button BT3lb showing the text “Decline” are displayed both in an unselectable manner below the message MS31.

Next, the following describes an example of a case where the user (B.B) who received the remittance reminder information paid the remittance requested amount, with reference to FIG. 5-3.

When processing for remitting to the first user (A.A) is completed as a result of the remittance button BT2la being tapped by the user (B.B) to whom the remittance reminder was issued, a message MS12 is displayed as a message from the user (B.B) who completed the remittance, in the terminal 20 of the first user (A.A) as shown in FIG. 5-3.

In a non-limiting example, the message MS12 includes the text “[Payment App]” and a message (in this example, the text “I have sent ¥3,000 to A.A.”) indicating the user name of the first user, the remittance requested amount remitted to the first user, and completion of payment of the remittance requested amount.

Also, a message MS13 is displayed as a message from the first user (A.A) himself or herself.

In a non-limiting example, the message MS13 includes the text “[Payment App]”, a message (in this example, “Reception of money”, “I received the money from B.B.”) indicating the user name of the user to whom the remittance reminder was issued and reception of the remittance requested amount from that user, the remittance requested amount (in this example, \3,000), and an icon showing the text “Receipt” and indicating that the user (A.A) received the remittance requested amount.

On the other hand, in the terminal 20 of the user (B.B) who was reminded of remittance and paid the amount specified by the remittance reminder information, a message MS22 is displayed as a message from the user (B.B) himself or herself

In a non-limiting example, the content of the message MS22 is the same as the content of the message MS12.

Also, a message MS23 is displayed as a message from the first user (A.A). The message MS23 differs from the message MS13 in that the message MS23 includes an icon showing the text “Payment” and indicating that the user (B.B) himself or herself paid the remittance requested amount, and does not include the icon showing the text “Receipt”.

In the terminal 20 of the other user (C.C) who is neither the first user (A.A) nor the user to whom the remittance reminder was issued, a message MS32 is displayed as a message from the user (B.B) who paid the amount specified by the remittance reminder information.

In a non-limiting example, the content of the message MS32 is the same as the content of the message MS12.

Also, a message MS33 is displayed as a message from the first user (A.A). The message MS33 differs from the messages MS13 and MS23 in that the message MS33 does not include the icon showing the text “Receipt” and the icon showing the text “Payment”, and includes, instead of these icons, the icon image of the first user (A.A) and the icon image of the user (B.B) to whom the remittance reminder was issued.

Note that an arrow directed from the icon image of the first user (A.A) other than the user (C.C) himself or herself to the icon image of the user (B.B) other than the user (C.C) himself or herself is displayed. This enables the other user (C.C) to recognize that the remittance reminder information was transmitted from the user (A.A) to the user (B.B) other than himself or herself.

### Processing

FIGS. 5-4 and 5-5 show a flowchart showing an example of a flow of processing executed by the devices in an example embodiment.

The flowchart shown in FIGS. 1-13 and 1-14 is modified in this flowchart so as to display the remittance request information and the remittance reminder information in the talk room.

Upon receiving remittance request transmission request information from the terminal 20A by means of the communication I/F 14, the controller 11 of the server 10 updates group talk management data (group talk room) of group members including at least the users A.A, B.B, and C.C by adding a remittance request message thereto (S510).

In this example, a group talk room including the three users is described as an example, but the talk room may optionally include only the two users A.A and B.B. That is, the talk room is only required to include at least two users (the remittance master user and the remittance requested user) who are concerned with the remittance.

Thereafter, the controller 11 of the server 10 transmits the added remittance request message to each of the terminals 20A, 20B, and 20C by means of the communication I/F 14 (S520).

Upon receiving the message, the terminals 20A, 20B, and 20C display the received remittance request message in the group talk room by means of the respective controllers 21 (A520, B520, C520).

The controller 21 of the terminal 20B determines whether or not input has been made to the remittance request message displayed in the group talk room (B525), and upon determining that input has been made (B525: YES), proceeds to step B130.

After step S130, the controller 11 of the server 10 updates the group talk management data described above by adding a remittance message or a money reception message thereto (S540).

Thereafter, the controller 11 of the server 10 transmits the added remittance message or money reception message to each of the terminals 20A, 20B, and 20C by means of the communication I/F 14 (S550).

Upon receiving the message, the terminals 20A, 20B, and 20C display the received remittance message or money reception message in the group talk room by means of the respective controllers 21 (A550, B550, C550).

Upon receiving remittance reminder transmission request information from the terminal 20A by means of the communication I/F 14 after step S550, the controller 11 of the server 10 updates the group talk management data described above by adding a remittance reminder message thereto (S570).

Thereafter, the controller 11 of the server 10 transmits the added remittance reminder message to each of the terminals 20A, 20B, and 20C by means of the communication I/F 14 (S580).

Upon receiving the message, the terminals 20A, 20B, and 20C display the received remittance reminder message in the group talk room by means of the respective controllers 21 (A580, B580, C580).

The controller 21 of the terminal 20B determines whether or not input has been made to the remittance reminder message displayed in the group talk room (B590), and upon determining that input has been made, proceeds to step B130.

### Effects of Fifth Example Embodiment

In an example embodiment, a configuration is described in which a remittance request message (a non-limiting example of the first indication based on the first information) and a remittance reminder message (a non-limiting example of the second indication that is based on the remittance request and differs from the first indication) are displayed in the display 24 of the terminal 20 of the remittance requested user by the messaging application (a non-limiting example of an application) installed in the terminal 20.

As an example of effects of the embodiment obtained with this configuration, it is possible to make the user of the terminal recognize the first information and the second information using the application installed in the terminal.

Also, in an example embodiment, the terminal 20 of the remittance requested user displays, in the display 24, a group talk room (a non-limiting example of a chat room) including at least the remittance requested user (a non-limiting example of the user of the terminal) and the remittance master user (a non-limiting example of the first user). The remittance request message and the remittance reminder message are displayed in this group talk room.

As an example of effects of the embodiment obtained with this configuration, it is possible to effectively make the user of the terminal recognize the first information and the second information by displaying the first information and the second information in the chat room including at least the user of the terminal and the first user.

### Fifth Modification (1)

In an example embodiment, the remittance request message and the remittance reminder message are displayed in the group talk room displayed in the terminals 20 of all the users included in a group, but there is no limitation to this configuration.

A configuration is also possible in which the remittance request message and the remittance reminder message are not displayed in the group talk room displayed in the terminal 20 of a user included in the group.

### Display Screen

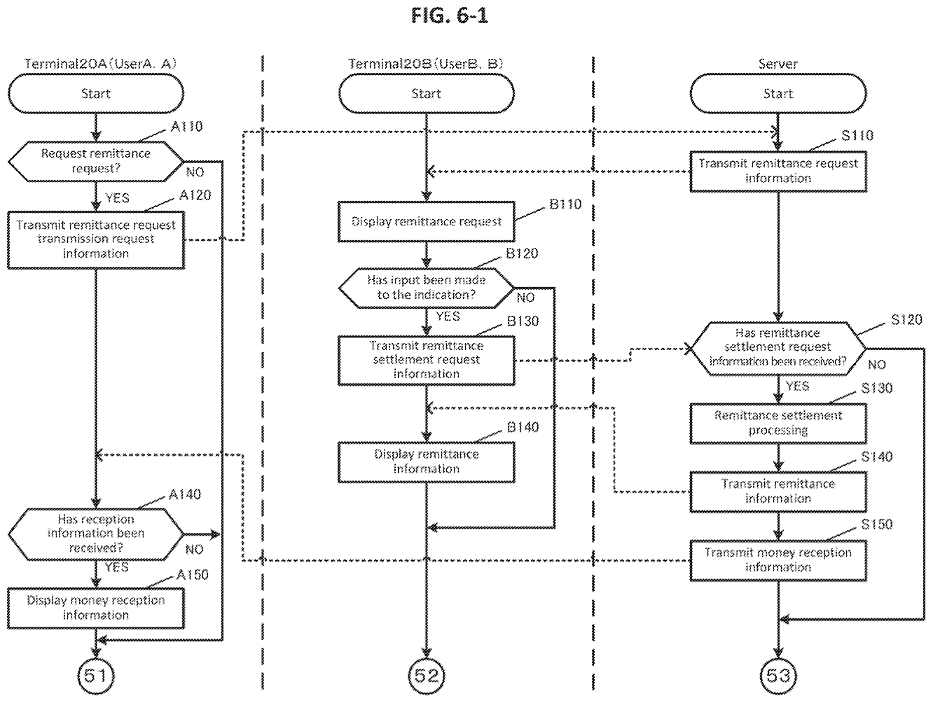

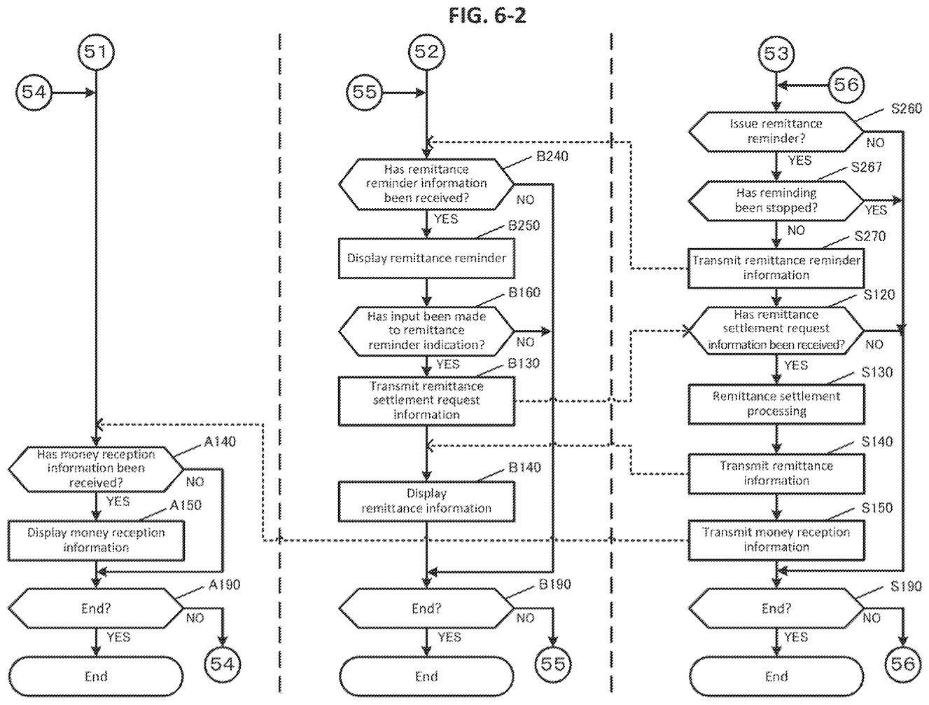

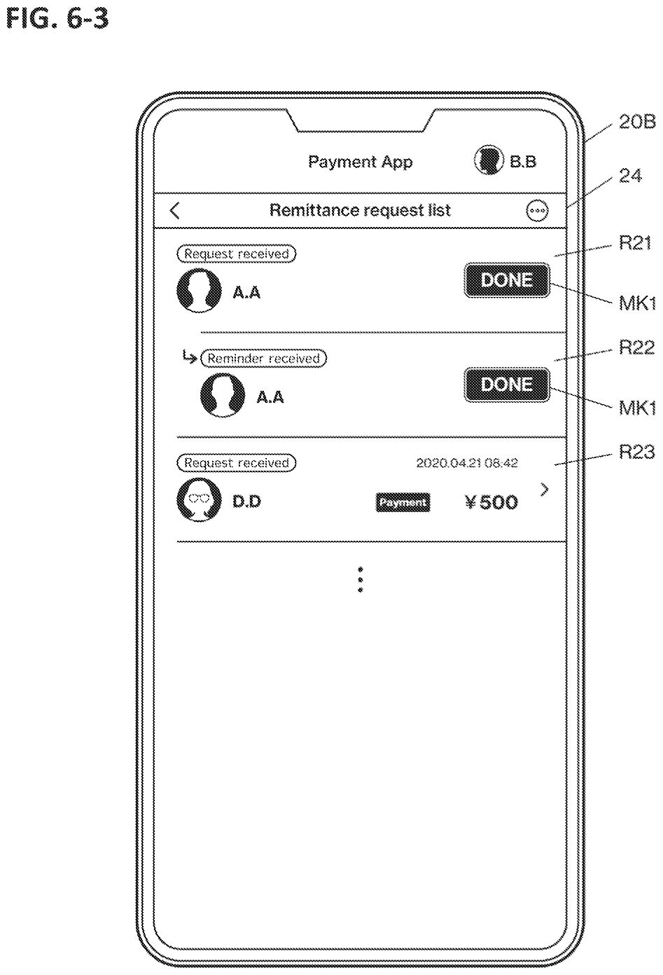

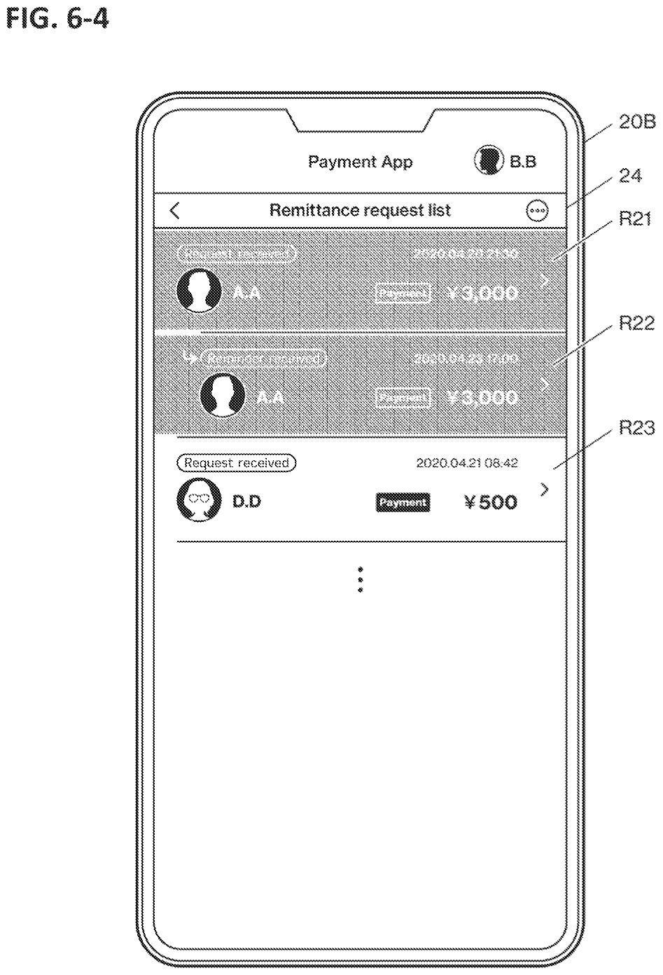

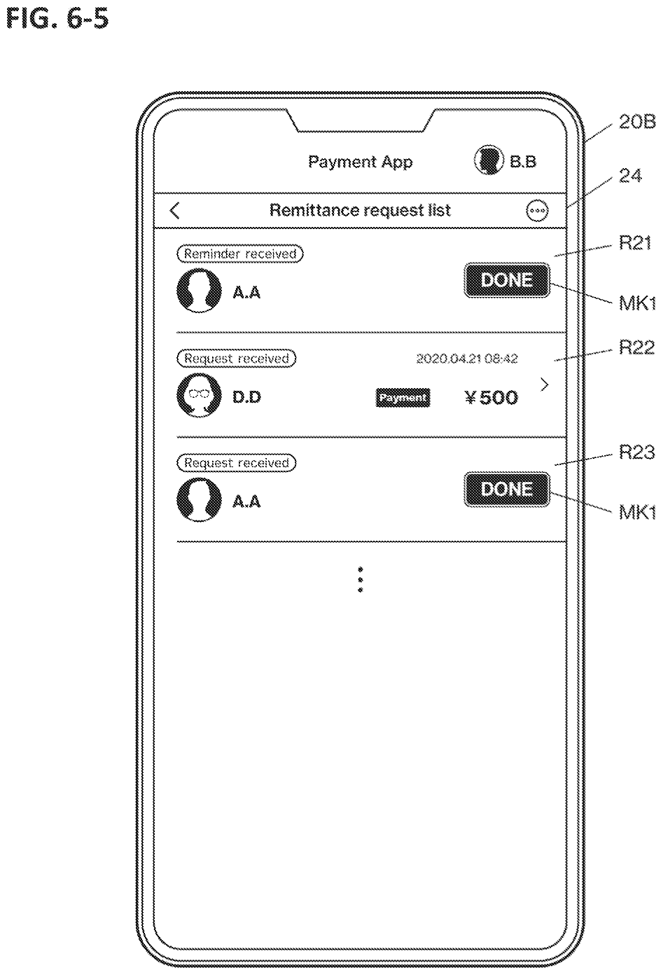

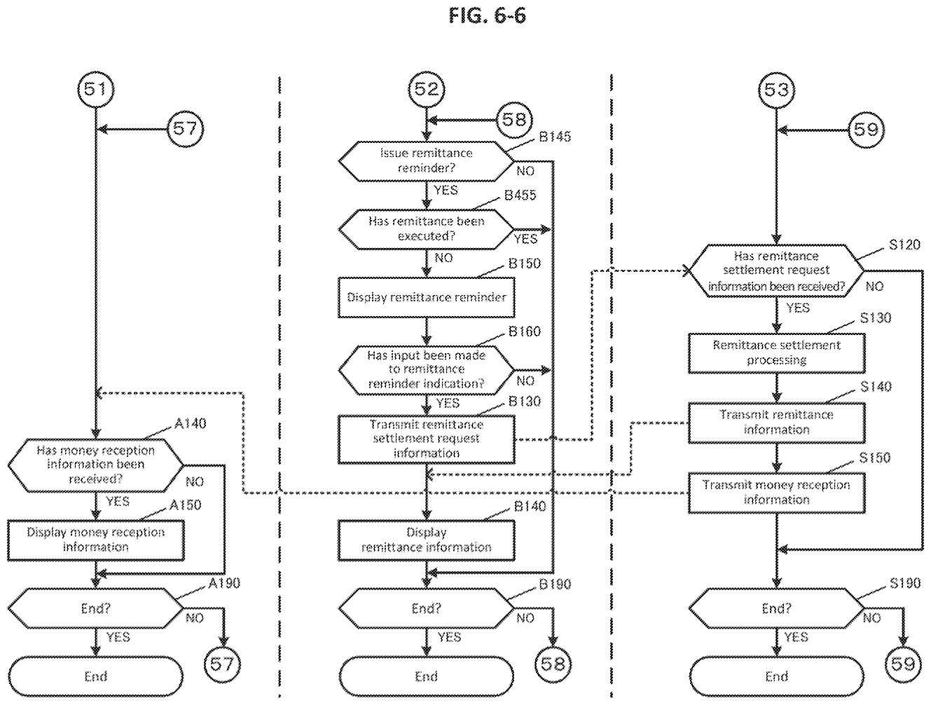

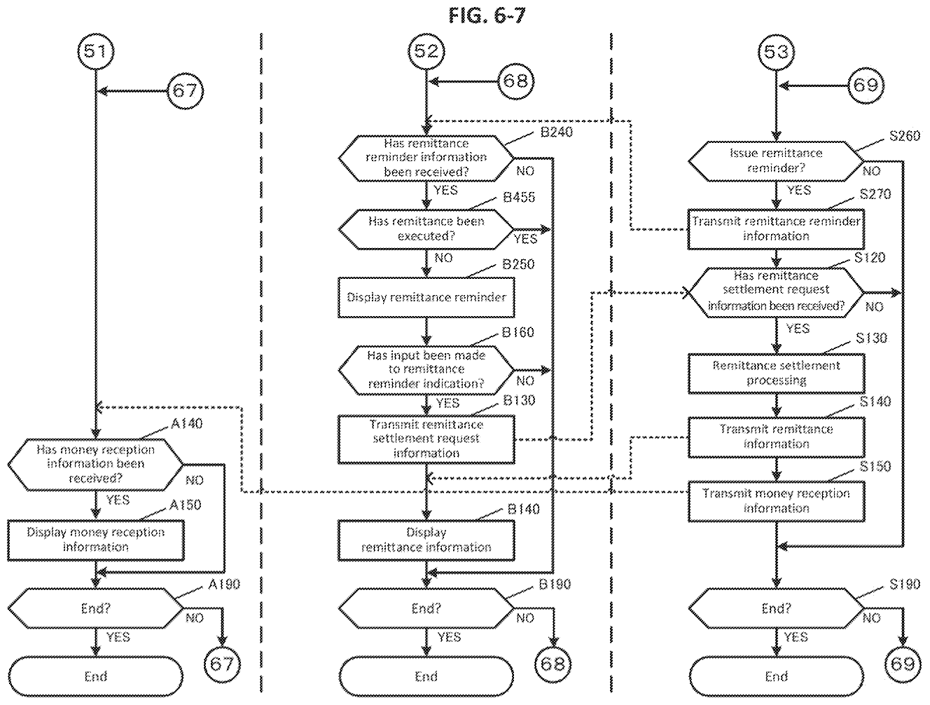

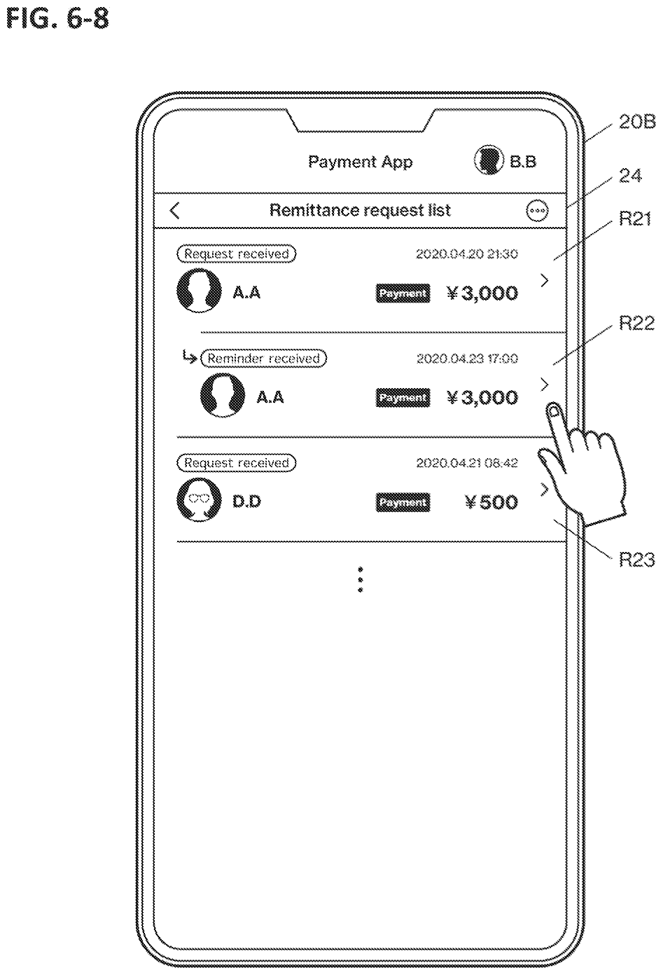

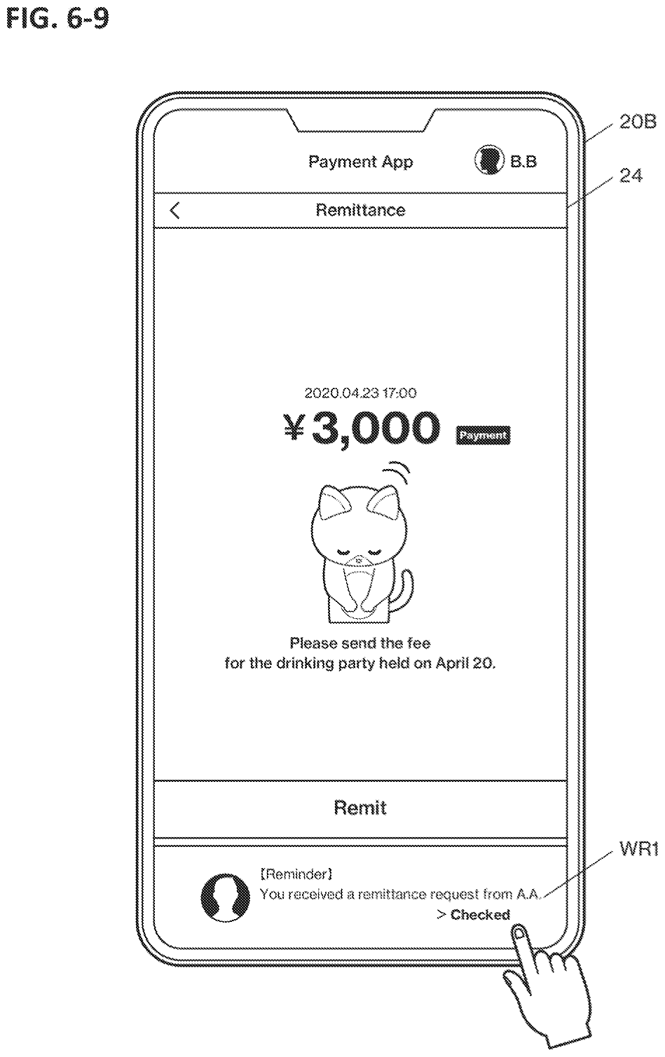

FIG. 5-6 shows a modification of the example shown in FIG. 5-2.

The first user (A.A) can view the message MS11 of himself or herself (A.A) in the talk room displayed in his or her terminal 20.

Also, the user (B.B) to whom the remittance reminder is issued can view the message MS21 from the first user (A.A) in the talk room displayed in his or her terminal 20.

On the other hand, the other user (C.C) who is neither the first user (A.A) nor the user receiving the remittance reminder cannot view the message MS31 from the first user (A.A) in the talk room displayed in his or her terminal 20.

As described above, a configuration is also possible in which, among the users belonging to the same group (X), the other user (C.C) who is neither the first user (A.A) issuing the remittance reminder nor the user (B.B) receiving the remittance reminder cannot view the message relating to the remittance reminder in the talk room.

FIG. 5-7 shows a modification of the example shown in FIG. 5-2.

The user (B.B) receiving the remittance reminder can view the message MS21 from the first user (A.A) in the talk room displayed in his or her terminal 20.

On the other hand, the first user (A.A) cannot view the message MS11 of himself or herself (A.A) in the talk room displayed in his or her terminal 20.

Also, the other user (C.C) who is neither the first user (A.A) nor the user receiving the remittance reminder cannot view the message MS31 from the first user (A.A) in the talk room displayed in his or her terminal 20.

As described above, a configuration is also possible in which, among the users belonging to the same group (X), users other than the user (B.B) who receives the remittance reminder, including the first user (A.A), cannot view the message relating to the remittance reminder.

### Data Configuration

FIG. 5-8 is a diagram showing an example of a table showing a method for displaying a remittance request message and a remittance reminder message in this modification.

In a non-limiting example, display flags are set in association with setting numbers in this table.

The display flags indicate whether or not a remittance request message and a remittance reminder message are displayed in the group talk room that is displayed in the display 24 of the terminal 20 of the corresponding user.

In a non-limiting example, the display flags include a display flag for the remittance master user (in this example, the user A.A), a display flag for the remittance requested user (in this example, the user B.B), and a display flag for another group user (in this example, the user C.C).

The following specifically describes the table.

In a setting No. 1, the display flags for the remittance master user, the remittance requested user, and the other group user are all set to “ON”.

This means that a remittance request message and a remittance reminder message are displayed in the group talk room that is displayed in the terminals 20 of all users included in the same group, irrespective of whether or not the users are concerned with the remittance request.

In a setting No. 2, the display flags of the remittance master user and the remittance requested user are set to “ON” and the display flag of the other group user is set to “OFF”.

This means that a remittance request message and a remittance reminder message are displayed in the group talk room that is displayed in the terminals 20 of the remittance master user and the remittance requested user who are concerned with the remittance request, but the remittance request message and the remittance reminder message are not displayed in the group talk room that is displayed in the terminal 20 of the other group user who is not concerned with the remittance request.

In a setting No. 3, the display flags of the remittance master user and the remittance requested user are set to “ON” and the display flag of the other group user is set to “OFF”.

This means that a remittance request message and a remittance reminder message are displayed in the terminals 20 of the remittance master user and the remittance requested user who are concerned with the remittance request, but the remittance request message and the remittance reminder message are not displayed in the terminal 20 of the other group user who is not concerned with the remittance request.

### Processing

FIGS. 5-9 and 5-10 show a flowchart showing an example of a flow of processing executed by the devices in this modification.

The flowchart shown in FIGS. 5-4 and 5-5 is modified in this flowchart so as to perform processing in accordance with the table described above.

Here, a case is described as an example in which the server 10 sets the display flags based on input that is made to the terminal 20 of the remittance master user.

In step A120, the controller 21 of the terminal 20A transmits remittance request transmission request information that includes information for requesting the server to set the display flags by means of the communication I/F 22 to the server 10.

The controller 11 of the server 10 sets the display flags based on the information included in the remittance request transmission request information received from the terminal 20A and requesting the server to set the display flags (S505).

In step 5520, the controller 11 of the server 10 transmits the added remittance request message to the terminals 20 whose display flags are set to “ON” by means of the communication I/F 14.

Upon receiving the remittance request message, each terminal 20 whose display flag is set to “ON” displays the received remittance request message in the group talk room displayed in the display 24.

Likewise, in step 5550, the controller 11 of the server 10 transmits the added remittance message and/or money reception message to the terminals 20 whose display flags are set to “ON” by means of the communication I/F 14.

Upon receiving the remittance message and/or money reception message, each terminal 20 whose display flag is set to “ON” displays the received remittance message and/or money reception message in the group talk room displayed in the display 24.

Likewise, in step 5580, the controller 11 of the server 10 transmits the added remittance reminder message to the terminals 20 whose display flags are set to “ON” by means of the communication I/F 14.

Upon receiving the remittance reminder message, each terminal 20 whose display flag is set to “ON” displays the received remittance reminder message in the group talk room displayed in the display 24.

Note that, in the above processing, the server 10 sets the display flags based on input that is made to the terminal 20 of the remittance master user, but there is no limitation to this configuration.

Alternatively, a configuration may optionally be adopted in which the server 10 sets the display flags based on input that is made to the terminal 20 of the remittance requested user.

In the above processing, the common display flag is set for the remittance request message and the remittance reminder message, but there is no limitation to this configuration.

Alternatively, a configuration may optionally be adopted in which display flags are individually set for the remittance request message and the remittance reminder message.

In an example of such a case, the display flags of the setting No. 1 may be applied to the remittance request message, and the display flags of the setting No. 2 or 3 may be applied to the remittance reminder message.

In this modification, a configuration is described in which the group talk room described above includes at least the remittance requested user (a non-limiting example of the user of the terminal), the remittance master user (a non-limiting example of the first user), and another group user (a non-limiting example of a second user who is different from the first user), and the remittance reminder message is not displayed in the group talk room that is displayed in the terminal 20 of the other group user.

As an example of effects of the modification obtained with this configuration, it is possible to avoid the second information based on the remittance request from being known by a user who does not relate to the remittance request, i.e., who is not concerned with the remittance request.

Also, in this modification, a configuration is described in which the remittance reminder message is not displayed in the group talk room that is displayed in the terminal 20 of the remittance master user.

The first user is the user requesting remittance, and knows at least the fact that he or she requested remittance from the user of the terminal with use of the first information. Accordingly, it is possible to avoid a situation in which information unnecessary for the first user is displayed in the terminal of the first user by preventing the second indication based on the remittance request from being displayed in the chat room displayed in the terminal of the first user.

### Fifth Modification (2)

In an example embodiment, a message displayed in the group talk room based on remittance reminder information may optionally be displayed as a message from the official account of the payment application, rather than a message from the first user.

FIGS. 5-11 and 5-12 show a modification of the example shown in FIGS. 5-2 and 5-3.

In the example shown in FIGS. 5-2 and 5-3, the messages MS11, MS21, and MS31 from the first user (A.A) to the user (B.B) to whom the remittance reminder is issued are each displayed as a message from the first user (A.A).

In a non-limiting example, the message MS11 is displayed as a message from the first user (A.A) himself or herself in the terminal 20 of the first user (A.A), the message MS21 is displayed in association with the icon image of the first user (A.A) in the terminal 20 of the user (B.B) to whom the remittance reminder is issued, and the message MS31 is displayed in association with the icon image of the first user (A.A) in the terminal 20 of the other user (C.C) as well.

That is, the messages based on remittance reminder information are each displayed as a message from the first user (A.A) who performed an operation for transmitting the remittance reminder information.

In FIGS. 5-11 and 5-12, a message that is based on remittance reminder information is displayed as a message from the official account of the payment application, rather than a message from the first user (A.A), in a non-limiting example.

As shown in FIG. 5-11, in each of the terminals 20 of the users A.A, B.B, and C.C, a message that is based on the remittance reminder information issued from the first user (A.A) to another user (B.B) is displayed in association with an icon image (in this example, an image including the text “Pay”) of the official account of the payment application in the talk room, in a non-limiting example.

A message MS11a is displayed in the terminal 20 of the first user A.A, a message MS21a is displayed in the terminal 20 of the user B.B to whom the remittance reminder is issued, and a message MS31a is displayed in the terminal 20 of the other user C.C.

The messages MS11a, MS21a, and MS31a are the same as each other except for the display manner of the buttons, and all the messages are associated with the icon image of the official account of the payment application.

In a non-limiting example, the messages MS11a, MS21a, and MS31a include an icon showing the text “Reminder”, and do not include the icon showing the text “Reminder transmitted”, which is included in the message MS11, and the icon showing the text “Reminder received”, which is included in the message MS21.

Also, in a non-limiting example, the messages MS11a, MS21a, and MS31a include the icon image of the first user (A.A), the icon image of the user (B.B) to whom the remittance reminder is issued, and an arrow directed from the icon image of the first user (A.A) to the icon image of the user (B.B).

The messages do not include the icon showing the text “Receipt”, which is included in the message MS11, and the icon showing the text “Payment”, which is included in the message MS21.

In a non-limiting example, other pieces of information included in the messages MS11a, MS21a, and MS31a are the same as the other pieces of information included in the messages MS11, MS12, and MS13, respectively.

In a non-limiting example, the message MS11a includes the remittance button BT11a and the button BT11b that are displayed in the unselectable manner. Also, the message MS21a includes the remittance button BT21a and the button BT21b that are displayed in the selectable manner. Also, the message MS31a includes the remittance button BT31a and the button BT31b that are displayed in the unselectable manner.

When processing for remitting to the first user (A.A) is completed as a result of the remittance button BT21a being tapped by the user (B.B) to whom the remittance reminder was issued, a message MS12 is displayed as a message from the user (B.B) who completed the remittance, and a message MS13 is displayed as a message from the first user (A.A) himself or herself in the terminal 20 of the first user (A.A) as shown in FIG. 5-12.

Also, in the terminal 20 of the user (B.B) who completed the remittance, a message MS22 is displayed as a message from himself or herself, and a message MS23 is displayed as a message from the first user (A.A).

Also, in the terminal 20 of the other user (C.C), a message MS32 is displayed as a message from the user (B.B) who completed the remittance, and a message MS33 is displayed as a message from the first user (A.A).

The content of the messages MS12 and MS13, the messages MS22 and MS23, and the messages MS32 and MS33 is the same as that in the example shown in FIG. 5-3.

In the non-limiting example shown in FIGS. 5-11 and 5-12, the remittance reminder indication that is based on a remittance request from the first user (A.A) to the user B.B is displayed as a message from the official account of the payment application, and this mitigates the impression that the remittance reminder indication is displayed based on an operation performed by the first user (A.A).

On the other hand, after the remittance processing is completed, the messages MS12, MS22, and MS23 indicating completion of the remittance are each displayed as a message from the user (B.B) who was requested to remit, and the messages MS13, MS23, and MS33 indicating reception of the remittance requested amount are each displayed as a message from the first user (A.A), and thus a relationship between the users is clarified.

FIG. 5-13 shows a modification of the example shown in FIG. 5-11.

The first user (A.A) can view the message MS11a from the official account in the talk room displayed in his or her terminal 20.

Also, the user (B.B) to whom the remittance reminder is issued can view the message MS21a from the official account in the talk room displayed in his or her terminal 20.

On the other hand, the other user (C.C) who is neither the first user (A.A) nor the user receiving the remittance reminder cannot view the message MS31a from the official account in the talk room displayed in his or her terminal 20.

As described above, a configuration is also possible in which, among the users belonging to the same group (X), the other user (C.C) who is neither the first user (A.A) issuing the remittance reminder nor the user (B.B) receiving the remittance reminder cannot view the message relating to the remittance reminder in the talk room.

FIG. 5-14 shows a modification of the example shown in FIG. 5-11.

The user (B.B) to whom the remittance reminder is issued can view the message MS21a from the official account in the talk room displayed in his or her terminal 20.

On the other hand, the first user (A.A) cannot view the message MS11a from the official account in the talk room displayed in his or her terminal 20.

Also, the other user (C.C) who is neither the first user (A.A) nor the user receiving the remittance reminder cannot view the message MS31a from the official account in the talk room displayed in his or her terminal 20.

As described above, a configuration is also possible in which, among the users belonging to the same group (X), users other than the user (B.B) who receives the remittance reminder, including the first user (A.A), cannot view the message relating to the remittance reminder.

### Fifth Modification (3)

At least either the remittance request message or the remittance reminder message displayed in the group talk room in an example embodiment may optionally be a message that is based on a mention function of the messaging application.

FIG. 5-15 is a diagram showing an example of the group talk room of this case.

In a non-limiting example, when a message (a non-limiting example of the remittance reminder indication) that is based on remittance reminder information is displayed in the talk room, the mention function of the messaging application automatically works and displays “@user name”, which is underlined to be emphasized.

Here, the mention function is a function of the messaging application for transmitting a message (contents) to a specified user.

Note that an emphasized notification indicating reception of the message may optionally be displayed in the terminal of the user who received the message through the mention function.

In a non-limiting example, the user name of a user who is specified, by the first user (A.A), as the user of the terminal 20 in which the remittance reminder indication is to be displayed (e.g., a user who is associated with a remittance request history on which a drag operation is performed) is displayed as the “user name” in “@user name”.

For example, the user name is included in the remittance reminder indication (non-limiting examples of which are the messages MS11b, MS21b, and MS31b).

In the example shown in FIG. 5-15, as a message to the user B.B who is specified by the mention function, a message MS11b is displayed in the terminal 20 of the first user (A.A), a message MS21b is displayed in the terminal 20 of the user (B.B) to whom the remittance reminder is issued, and a message MS31b is displayed in the terminal 20 of the other user (C.C).

“@B.B” is displayed based on the mention function at the head of each of the messages MS11b, MS21b, and MS31b, indicating that the message is directed to the user B.B.

In this modification, a configuration is described in which the remittance reminder message includes at least information specifying the remittance requested user (a non-limiting example of information indicating the user of the terminal) with use of the mention function.

As an example of effects of the modification obtained with this configuration, the second indication including the information indicating the user of the terminal can reliably make the user of the terminal recognize that the indication is directed to himself or herself.

### Fifth Modification (4)

The remittance reminder message displayed in the group talk room in the display 24 of the terminal 20 of the remittance requested user may be displayed in a manner different from the display manner of the remittance reminder message displayed in the group talk room in the display 24 of the terminal 20 of a group user other than the remittance requested user and the remittance master user.

In this case, it is possible to adopt not only the configuration in which the content of some text included in the message is changed or the display manner (selectable or unselectable) of a button included in the message is changed as in the examples shown in the display screens, but also a configuration in which details of the content of the message are displayed in the terminal 20 of a concerned party, but the content of the message displayed in the terminal 20 of a user who is not a concerned party is simplified. It is also possible to display the message in different colors.

In this modification, a configuration is described in which a display manner (a non-limiting example of a first display manner) of the remittance reminder message in the group talk room displayed in the terminal 20 of the remittance requested user (a non-limiting example of the terminal) is different from a display manner (a non-limiting example of a second display manner) of the remittance reminder message in the group talk room displayed in the terminal 20 of a group user (a non-limiting example of a terminal of the second user) other than the remittance requested user and the remittance master user.

As an example of effects of the embodiment obtained with this configuration, the difference between the first display manner and the second display manner enables the user of the terminal to recognize that he or she is concerned with the remittance request, and enables the second user to recognize that he or she is not concerned with the remittance request.

### Fifth Modification (5)

In a case where the remittance requested user does not make payment, some functions of the messaging application may optionally be restricted.

In the example shown in FIG. 5-16, as a message from the official account of the payment application, a message MS14 is displayed in the terminal 20 of the first user (A.A), a message MS24 is displayed in the terminal 20 of the user (B.B) to whom a remittance reminder was issued, and a message MS34 is displayed in the terminal 20 of the other user (C.C).

“@B.B” is displayed based on the mention function at the head of each of the messages MS14, MS24, and MS34, indicating that the message is directed to the user B.B (in this example, the user to whom the remittance reminder was issued).

In a non-limiting example, in each of the messages MS14, MS24, and MS34, the text “[Payment App]”, information indicating a function of which use will be restricted in the messaging application and conditions of the restriction of use (in this example, the text “Sticker function in Messaging App will be restricted unless remittance is made within 24 hours.” and the text “Please remit by the deadline.”), the user name (in this example, A.A) of the first user, who is the remittee, the remittance requested amount (in this example, “\3,000”), and a remittance deadline (in this example, 2020-04-24 17:00) are displayed, and a remittance button is displayed below.

The remittance button BT14 included in the message MS14 and the remittance button BT34 included in the message MS34 are displayed in an unselectable manner, and the remittance button BT24 included in the message MS24 is displayed in a selectable manner.

### Fifth Modification (6)

Information regarding a user who has already remitted may optionally be included in a reminder indication displayed in the terminal 20 of a user who has not remitted yet.

In the example shown in FIG. 5-17, messages transmitted between friends are displayed in the talk room of the group X in the display 24 of the terminal 20 of the user A.A, similarly to the example shown in FIG. 5-1.

In this example, the user C.C of one of the terminals 20 replied that the user C.C has remitted, but the user B.B of the other terminal 20 has not replied.

In a non-limiting example, when the first user A.A taps the button BTM3, a history of past remittance requests from the user A.A to the plurality of users (B.B and C.C) including at least one user who has not completed payment processing is displayed on the talk room.

In this example, the first user (A.A) transmitted remittance request information regarding a common event (in this example, an event of which the fee is \3,000) to the plurality of users (B.B and C.C). Remittance processing relating to the remittance request for one (B.B) of the users has not been completed, whereas remittance processing relating to the remittance request for the other user (C.C) has been completed, and accordingly, information regarding both users is displayed in a region R10.

In a non-limiting example, date and time at which the remittance request information was transmitted, an icon showing the text “Request transmitted”, an icon showing the text “Receipt” and indicating that the user is to be paid by each of the plurality of users (A.A and B.B), and an amount (\3,000) to be received from each of the plurality of users (A.A and B.B) are displayed in the region R10.

Information (in this example, “Members 2”) indicating the number of users who are requested to remit is displayed below the above information, and furthermore, both information regarding the user (B.B) who has not remitted yet and information regarding the other user (C.C) who has already remitted are displayed.

In a non-limiting example, the remittance requested amount (in this example, \3,000) is displayed in association with the icon image and the user name of the user (B.B) based on the fact that the first user (A.A) transmitted the remittance request information to the user (B.B) but remittance processing relating to the remittance request has not been completed.

Also, in a non-limiting example, information (in this example, the text “Already remitted”) indicating completion of the remittance is displayed in association with the icon image and the user name of the other user (C.C) based on the fact that the first user (A.A) transmitted the remittance request information to the other user (C.C) and remittance processing relating to the remittance request has been completed.

The background of the information regarding the user (B.B) is white, whereas the background of the information regarding the other user (C.C) is black, and this difference in the display manner makes it easy to distinguish the former information and the latter information.

When the first user (A.A) checks a checkbox in the region R10, information displayed in the region R10 is selected.

When the region RR is tapped in this state, remittance reminder information based on the information displayed in the region R10 is transmitted to the terminal 20 of the user (B.B) who has not remitted.

The example shown in FIG. 5-18 differs from the example shown in FIG. 5-2 in that the remittance reminder indication based on the remittance reminder information includes information regarding the other user (C.C) who has already paid.

A message MS11c is displayed in the terminal 20 of the first user (A.A), a message MS21c is displayed in the terminal 20 of the user (B.B), and a message MS31c is displayed in the terminal 20 of the other user (C.C).

In all of the messages MS11c, MS21c, and MS31c, information (in this example, “Members 2”) indicating the number of users who are requested to remit based on the common event is displayed, and furthermore, both information regarding the user (B.B) who has not remitted yet and information regarding the other user (C.C) who has already remitted are displayed.

In a non-limiting example, it is possible to prompt the user (B.B) to remit by including information regarding the other user (C.C) who has already remitted with respect to the same event in the remittance reminder indication displayed in the terminal 20 of the user (B.B) who has not remitted yet with respect to that event.

FIGS. 5-19 and 5-20 show a modification of the example shown in FIGS. 5-17 and 5-18.

FIGS. 5-19 and 5-20 differ from FIGS. 5-17 and 5-18 in that the number of times remittance reminding has been performed (a non-limiting example of the number of times a remittance reminder indication directed to the user has been displayed in the terminal 20 of the user) is shown with respect to each of the plurality of users (B.B and C.C) to whom the remittance request information has been transmitted, in a non-limiting example.

In the example shown in FIGS. 5-19 and 5-20, an icon RIC1 showing the number of times remittance reminding has been performed (a non-limiting example of which is the number of times a remittance reminder indication directed to the user B.B has been displayed in the terminal 20 of the user B.B, which is 10 in this example) is displayed in association with the icon image and the user name of the user (B.B) who has not remitted in response to a remittance request relating to an event, and an icon RIC2 showing the number of times remittance reminding has been performed (a non-limiting example of which is the number of times a remittance reminder indication directed to the user C.C has been displayed in the terminal 20 of the user C.C, which is 0 in this example) is displayed in association with the icon image and the user name of the other user C.C who has already remitted in response to a remittance request relating to the same event.

In a non-limiting example, the indication described above makes each user compare the number of times the user has been reminded with the number of times another user has been reminded, and compare the numbers of times other users have been respectively reminded, and accordingly, each user becomes cautious not to get a remittance reminder as far as possible.

Next, the following describes embodiments in which a remittance reminder is kept from being issued to the remittance requested user. Keeping a remittance reminder from being issued may also be referred to as “stopping remittance reminding”.

Methods for stopping remittance reminding are roughly sorted into the following two methods.

The server 10 stops transmitting remittance reminder information.

The terminal 20 stops displaying a remittance reminder indication.

Each method will be described below.

### Sixth Example Embodiment

In a sixth embodiment, the server 10 stops transmitting remittance reminder information to the terminal 20 of the remittance requested user.

Matter described in an example embodiment can also be applied to other embodiments and modifications.

Constitutional elements that are the same as those already described are denoted with the same reference numerals as those used for corresponding elements, and a redundant description thereof is omitted.

The two patterns (pattern A and pattern B) described above are conceivable as non-limiting examples of methods with which the server 10 manages remittance requests.

In the case where “pattern A” is applied, the server 10 does not delete a remittance request for which remittance has been completed, but rather leaves the remittance request, and stops transmitting remittance reminder information corresponding to the remittance request to the terminal 20 of the remittance requested user.

In the case where “pattern B” is applied, the server 10 deletes a remittance request for which remittance has been completed. Since the remittance request is deleted, transmission of remittance reminder information is consequently stopped.

### Processing

FIGS. 6-1 and 6-2 show a flowchart showing an example of a flow of processing executed by the devices in an example embodiment.

This flowchart is based on the processing of server reminding, which proceeds from the processing shown in FIG. 1-13 to the processing shown in FIG. 2-11, in a non-limiting example.

Upon determining to perform remittance reminding (S260: YES), the controller 11 of the server 10 determines whether or not reminding has been stopped for the corresponding remittance request (S267). Specifically, the controller refers to the second remittance request management data 157B, in a non-limiting example, and if the remittance completion flag associated with the corresponding remittance request management ID is set to “ON”, determines that reminding has been stopped.

Upon determining that reminding has not been stopped (S267: NO), the controller 11 of the server 10 proceeds to step 5270.

In this case, control is performed to transmit remittance reminder information from the server 10 to the terminal 20B.

On the other hand, upon determining that reminding has been stopped (S267: YES), the controller 11 of the server 10 proceeds to step S190.

In this case, control is performed so as not to transmit remittance reminder information from the server 10 to the terminal 20B.

In the processing described above, the remittance reminder information may be transmitted twice or more times from the server 10 to the terminal 20B. In such a case, when remittance settlement processing is executed by the server 10 based on input that is made to any of the remittance reminder indications displayed in the display 24 of the terminal 20B in the above processing, control is performed so as not to transmit remittance reminder information any more from the server 10 to the terminal 20.

### Effects of Sixth Example Embodiment

In an example embodiment, the server 10 receives remittance request information (a non-limiting example of first information relating to a settlement request) from the remittance master user (a non-limiting example of the first user) by means of the communication I/F 14 from the terminal 20 of the remittance master user. Then, the server 10 performs transmission control relating to transmission of remittance reminder information that is based on the remittance request (a non-limiting example of second information that is based on the remittance request) to the terminal 20 of the remittance requested user, by means of the controller 11, based on execution of second remittance processing that is based on the remittance request (a non-limiting example of remittance processing relating to remittance to the first user).

As an example of effects of the embodiment obtained with this configuration, the transmission control relating to transmission of the second information based on the remittance request to the terminal is performed based on execution of the remittance processing that is based on the remittance request and relates to remittance to the first user, and accordingly, it is possible to make the user of the terminal appropriately perform remittance to the first user.

Also, in an example embodiment, a configuration is described in which the remittance request information includes information of the remittance requested amount, and the remittance reminder information includes information of the same amount.

As an example of effects of the embodiment obtained with this configuration, it is possible to reliably notify the user of the terminal of the amount based on the remittance request using the first information and the second information.

Also, in an example embodiment, a configuration is described in which the server 10 performs control to transmit the remittance reminder information to the terminal 20 of the remittance requested user by means of the communication I/F 14 in a case where the second remittance processing has not been executed, and performs control so as not to transmit the remittance reminder information to the terminal 20 of the remittance requested user by means of the communication I/F 14 in a case where the second remittance processing has been executed.

As an example of effects of the embodiment obtained with this configuration, the second information can be transmitted to the terminal in the case where the remittance processing has not been executed, and the second information can be kept from being transmitted to the terminal in the case where the remittance processing has been executed.

Also, in an example embodiment, a configuration is described in which a remittance request indication (a non-limiting example of a first indication based on the first information) is displayed in the terminal 20 of the remittance requested user, and the second remittance processing is executed based on input that is made by the remittance requested user of the terminal 20 to the remittance request indication.

As an example of effects of the embodiment obtained with this configuration, the first indication based on the first information is displayed in the terminal, and the remittance processing can be executed easily based on input made to the first indication by the user of the terminal. Also, a combination of this configuration and the above configuration enables the server to perform control so as not to transmit the second information to the terminal based on execution of the remittance processing based on input made to the first indication.

Also, in an example embodiment, the server 10 transmits remittance reminder information based on the remittance request (a non-limiting example of third information based on the remittance request) by means of the communication I/F 14 to the terminal 20 of the remittance requested user. A remittance reminder indication (a non-limiting example of a third indication based on the third information) is displayed in the terminal 20 of the remittance requested user, and the second remittance processing is executed based on input that is made by the remittance requested user to the remittance reminder indication.

As an example of effects of the embodiment obtained with this configuration, the remittance processing can be executed based on input made to the third indication that is based on the third information. Also, a combination of this configuration and the above configuration makes it possible to keep the second information from being transmitted to the terminal in the case where the remittance processing has been executed based on input made to the third indication.

Also, in an example embodiment, a configuration is described in which the transmission control executed by the server 10 includes control for transmitting second remittance reminder information (a non-limiting example of fourth information based on the remittance request) to the terminal 20 of the remittance requested user in a case where first remittance reminder information (a non-limiting example of the second information) has been transmitted to the terminal 20 of the remittance requested user by the communication I/F 14 of the server 10, a first remittance reminder indication (a non-limiting example of a second indication based on the second information) is displayed in the terminal 20 of the remittance requested user, and the second remittance processing is executed based on input that is made by the remittance requested user to the first remittance reminder indication.

As an example of effects of the embodiment obtained with this configuration, even when the second information based on the remittance request has been transmitted from the server to the terminal, the fourth information based on the remittance request can be transmitted from the server to the terminal separately from the second information. Also, even when the fourth information based on the remittance request has been transmitted from the server to the terminal, remittance from the user of the terminal to the first user can be implemented based on input that is made by the user of the terminal to the second indication displayed in the terminal based on the second information.

Also, in an example embodiment, a configuration is described in which the second remittance processing (a non-limiting example of the remittance processing) relates to remittance from the remittance requested user (a non-limiting example of the user of the terminal) to the remittance master user (a non-limiting example of the first user).

As an example of effects of the embodiment obtained with this configuration, the server can implement the remittance from the user of the terminal to the first user through the remittance processing.

### Sixth Modification (1)

In an example embodiment, pattern B (in which remittance requests are deleted) may also be applied.

In a non-limiting example of this case, after executing remittance through remittance settlement processing, the server 10 deletes records associated with the remittance request management ID for which remittance has been executed, from the second remittance request management data 157B. Consequently, not only the remittance request but also remittance reminders corresponding to the remittance request are deleted.

### Sixth Modification (2)

In the case where pattern A (in which remittance requests are not deleted but are left) is applied, remittance requests that are stored and managed by the server 10 are not deleted. Accordingly, when a request to view the remittance requests is issued from the terminal 20 to the server 10, information regarding remittance requests for which remittance has already been done can be viewed in the terminal 20.

The information regarding remittance requests for which remittance has already been done may optionally be displayed in a display manner that is different from a display manner of information regarding remittance requests for which remittance has not been done.

In a non-limiting example, the controller 11 of the server 10 transmits a page (a remittance request list page) showing information of a remittance request list to the terminal 20, based on a request from the terminal 20.

In this case, the controller 11 of the server 10 sets the remittance request list page to be transmitted to the terminal 20B based on remittance completion flags that are set in association with corresponding remittance request management IDs in the second remittance request management data 157B.

Specifically, in a non-limiting example, the controller sets and transmits a remittance request list page in which remittance request information and remittance reminder information for which the remittance completion flag is set to “OFF” are displayed in a default display manner, whereas the display manner of remittance request information and remittance reminder information for which the remittance completion flag is set to “ON” is changed to indicate completion of remittance (for example, by greying out or adding a remittance completion mark).

FIG. 6-3 is a diagram showing an example of the remittance request list screen that is displayed in the display 24 of the terminal 20B in an example embodiment and corresponds to the screen shown in FIG. 2-13.

In this example, a completion mark MK1 including the text “DONE” is displayed as information indicating completion of remittance, for remittance request information displayed in the region R21 and remittance reminder information corresponding to the remittance request and displayed in the region R22.

Note that the display manner indicating completion of remittance is not limited to this example.

In a non-limiting example, the regions R21 and R22 of the remittance request list screen displayed in the layout shown FIG. 6-3 may be greyed out as shown in FIG. 6-4 to distinguish the information displayed in these regions from remittance requests and remittance reminders for which remittance has not been done.

Alternatively, in a remittance request list screen that is displayed in a layout different from that shown in FIG. 6-3, such as the screen shown in FIG. 2-17 in which information is displayed based on the received date and time, the completion mark MK1 may be displayed in the region R21 and the region R23 as shown in FIG. 6-5, for example.

Alternatively, these regions may be greyed out.

### Sixth Modification (3)

As described above, the terminal 20 can also stop remittance reminding by stopping displaying a remittance reminder indication.

The following describes a case where the method of terminal reminding is applied.

FIG. 6-6 is a flowchart showing an example of a flow of processing executed by the devices in this modification.

This flowchart is based on the processing of terminal reminding shown in FIGS. 1-13 and 1-14, in a non-limiting example.

Upon determining to perform remittance reminding (B145: YES), the controller 21 of the terminal 20B determines whether or not remittance based on a received remittance request has been executed (B455).

Upon determining that remittance has not been executed (B455: NO), the controller 21 of the terminal 20B proceeds to step B150.

In this case, the controller 21 of the terminal 20B executes control to display a remittance reminder indication in the display 24.

On the other hand, upon determining that remittance has been executed (B455: YES), the controller 21 of the terminal 20B proceeds to step B190.

In this case, the controller 21 of the terminal 20B executes control so as not to display a remittance reminder indication in the display 24.

In the processing described above, the remittance reminder indication may be displayed twice or more times in the display 24 of the terminal 20B.

In such a case, when remittance is executed based on input that is made to any of the remittance reminder indications displayed in the display 24 of the terminal 20 in the above processing, control is performed so as not to display remittance reminder information any more in the display 24 of the terminal 20B.

In this modification, the terminal 20 of the remittance requested user receives remittance request information (a non-limiting example of first information relating to a remittance request) from the remittance master user (a non-limiting example of a first user) by means of the communication I/F 22. Then, the terminal 20 of the remittance requested user displays a remittance request indication (a non-limiting example of a first indication based on the first information) in the display 24. Then, the terminal 20 of the remittance requested user performs display control relating to display of a remittance reminder indication based on the remittance request (a non-limiting example of a second indication that is based on the remittance request) in the display 24 by means of the controller 21 based on execution of first remittance processing that is based on the remittance request (a non-limiting example of remittance processing relating to remittance to the first user).

As an example of effects of the embodiment obtained with this configuration, the display control relating to display of the second indication based on the remittance request in the display of the terminal is executed based on execution of remittance processing that is based on the remittance request and relates to remittance to the first user, and accordingly, it is possible to make the user of the terminal appropriately perform remittance to the first user.

Also, in this modification, a configuration is described in which, in a case where the first remittance processing has not been executed, the display control is performed to display the remittance reminder indication in the display 24, and in a case where the first remittance processing has not been executed, the display control is performed so as not to display the remittance reminder indication in the display 24.

As an example of effects of the embodiment obtained with this configuration, whether or not to display the second information can be appropriately switched based on whether or not the remittance processing has been executed.

Also, in this modification, a configuration is described in which an indication (a non-limiting example of the first indication) based on the remittance request information (a non-limiting example of the first information) is displayed in the terminal 20 of the remittance requested user, and the first remittance processing is executed based on input that is made by the remittance requested user to the indication (a non-limiting example of input that is made by a user of the terminal to the first indication).

As an example of effects of the modification obtained with this configuration, the first indication based on the first information is displayed in the terminal, and the remittance processing can be executed easily based on input made to the first indication by the user of the terminal. Also, a combination of this configuration and the above configuration enables the terminal to perform control so as not to display the second indication in the display based on execution of the remittance processing based on input made to the first indication.

### Sixth Modification (4)

This modification relates to an example embodiment (3). The terminal 20 can stop remittance reminding in the method of server reminding as well by stopping displaying a remittance reminder indication. That is, a configuration is also possible in which the server 10 does not stop transmitting remittance reminder information, but the terminal 20 stops displaying the remittance reminder indication.

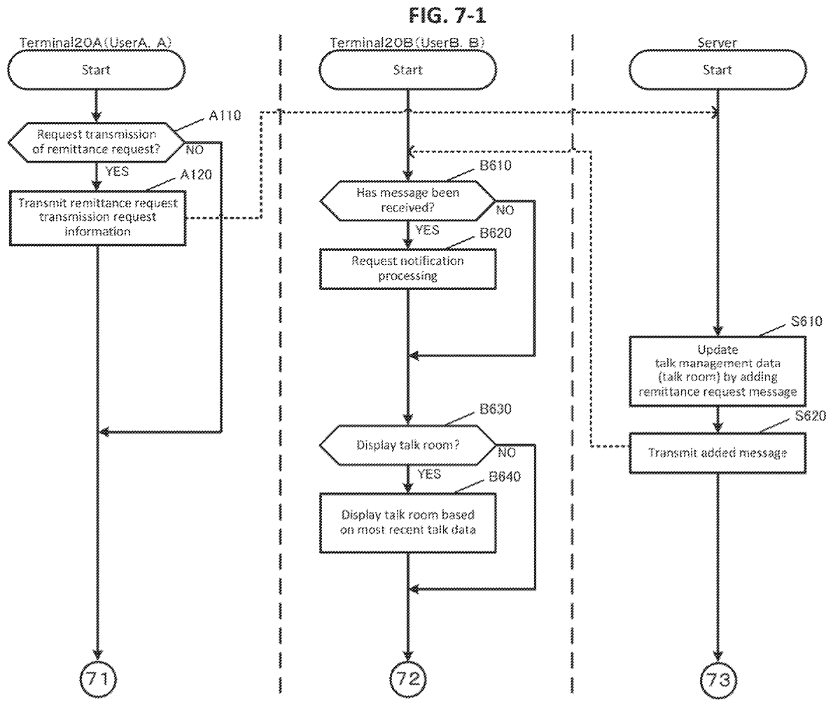

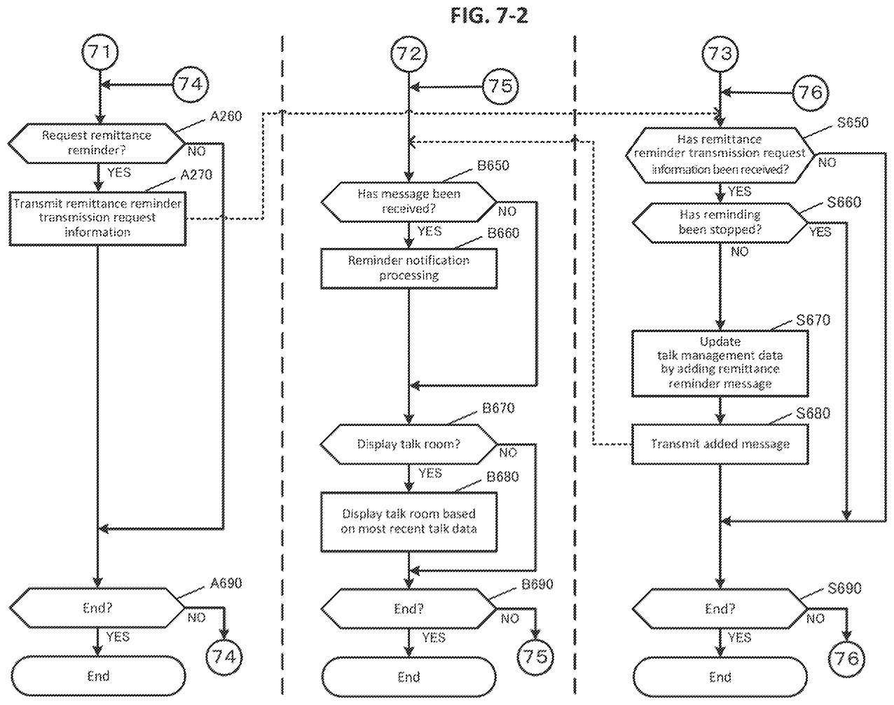

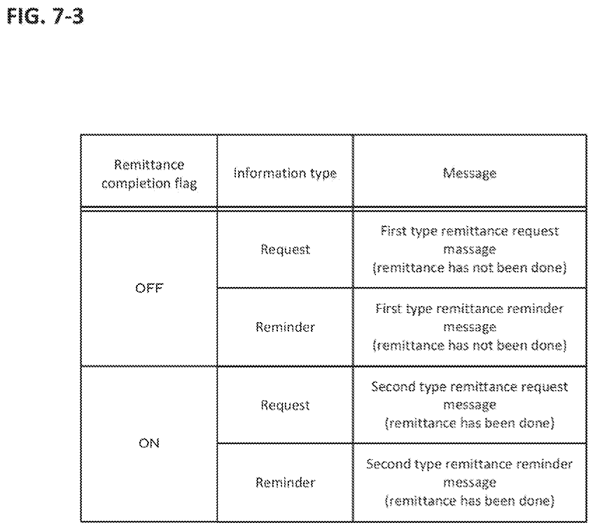

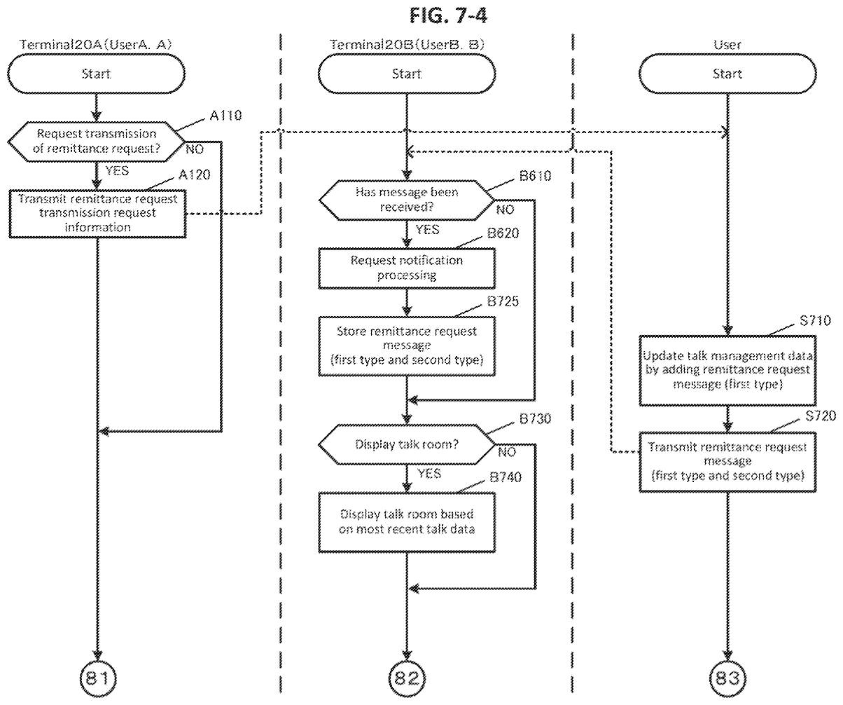

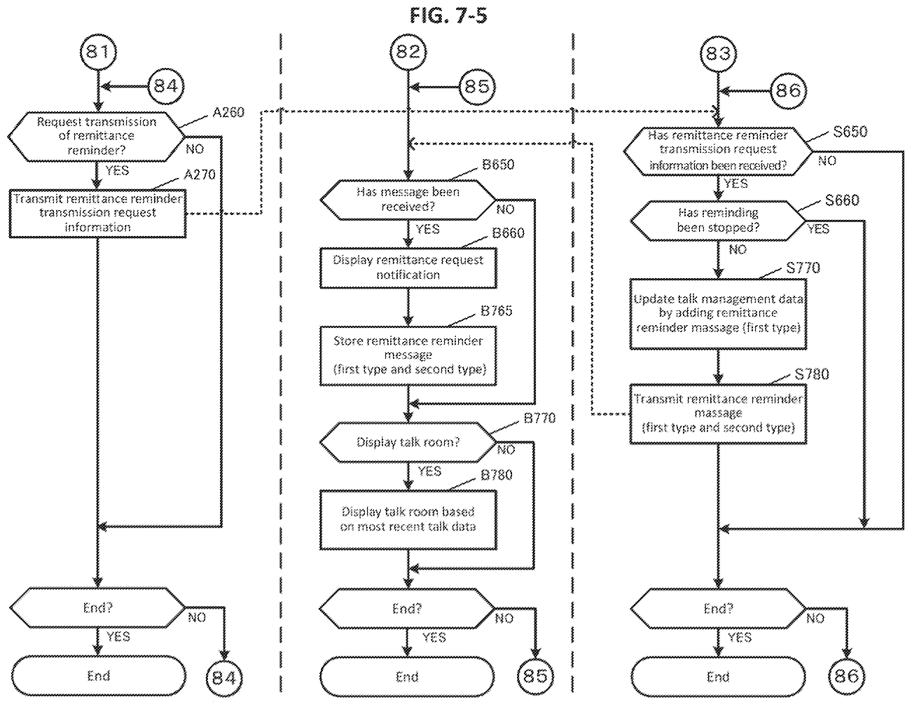

FIG. 6-7 is a flowchart showing an example of a flow of processing executed by the devices in this modification.

Upon determining in step B240 that remittance reminder information has been received from the server 10 (B240: YES), the controller 21 of the terminal 20B determines whether or not remittance based on the corresponding remittance request has been executed (B455).

Upon determining that remittance has not been executed (B455: NO), the controller 21 of the terminal 20B proceeds to step B250.

In this case, the controller 21 of the terminal 20B executes control to display a remittance reminder indication in the display 24 based on the remittance reminder information transmitted from the server 10.

On the other hand, upon determining that remittance has been executed (B455: YES), the controller 21 of the terminal 20B proceeds to step B190.

In this case, although the remittance reminder information has been transmitted from the server 10, the controller 21 of the terminal 20B executes control so as not to display a remittance reminder indication based on the remittance reminder information in the display 24.

### Sixth Modification (5)

Furthermore, a configuration is also possible in which the server 10 stops transmitting remittance reminder information based on a request from the terminal 20 of the remittance requested user.

Specifically, in a non-limiting example, when a remittance reminder from the user A.A is tapped as shown in FIG. 6-8 in a state where a remittance request list is displayed in the display 24 of the terminal 20B of the remittance requested user B.B, a remittance screen shown in FIG. 6-9 is displayed.

A check information display region WR1 for notifying the server 10 that the content of the remittance reminder has been checked is provided in a lower portion of the remittance screen. In the check information display region WR1 of this example, a link including the text “Checked” is displayed together with the text “[Reminder] You received a remittance request from A.A.”. When this link is tapped, remittance reminder check information indicating that the content of the remittance reminder has been checked is transmitted from the terminal 20B to the server 10.

The server 10 stops transmitting remittance reminder information based on reception of the remittance reminder check information from the terminal 20B.

### Seventh Example Embodiment

In a seventh embodiment, the remittance request indication and the remittance reminder indication in an example embodiment are displayed in a chat room.

Matter described in an example embodiment can also be applied to other embodiments and modifications.

Constitutional elements that are the same as those already described are denoted with the same reference numerals as those used for corresponding elements, and a redundant description thereof is omitted.

### Processing

FIGS. 7-1 and 7-2 show a flowchart showing an example of a flow of processing executed by the devices in an example embodiment.

Note that the following description and diagrams referred to below are focused on processing that is performed when an added message is displayed in a talk room that is displayed in the terminal 20B, and description of display of the talk room in the terminal 20A is omitted to simplify the description.

Upon receiving remittance request transmission request information from the terminal 20A by means of the communication I/F 14, the controller 11 of the server 10 updates talk management data (talk room) of the users A.A and B.B by adding a remittance request message thereto (S610).

Then, the controller 11 of the server 10 transmits the added remittance request message to the terminal 20B by means of the communication I/F 14 (S620).

The controller 21 of the terminal 20B determines whether or not the remittance request message has been received from the server 10 by the communication I/F 22 (B610), and upon determining that the message has been received (B610: YES), executes request notification processing (B620).

The request notification processing can be implemented using the same method as that of the reminder notification processing described above, in a non-limiting example.

Thereafter, the controller 21 of the terminal 20B determines whether or not to display a talk room in the display 24 based on whether or not input for displaying the talk room has been made to the input device (B630). Upon determining to display the talk room (B630: YES), the controller displays the talk room in the display 24 based on the most recent talk data stored in the storage 28 (B640).

The controller 11 of the server 10 determines whether or not remittance reminder transmission request information has been received from the terminal 20A by the communication I/F 14 (S650), and upon determining that the information has been received (S650: YES), determines whether or not reminding has been stopped based on a set remittance completion flag (S660).

Upon determining that the remittance completion flag is “OFF” and reminding has not been stopped (S660: NO), the controller 11 of the server 10 updates the talk management data (talk room) of the users A.A and B.B by adding a remittance reminder message thereto (S670).

Then, the controller 11 of the server 10 transmits the added remittance reminder message to the terminal 20B by means of the communication I/F 14 (S680).

Thereafter, the controller 11 of the server 10 determines whether or not to end the processing (S690), and upon determining to continue the processing (S690: NO), returns to step S650. On the other hand, upon determining to end the processing (S690: YES), the controller ends the processing.

The controller 21 of the terminal 20B determines whether or not the remittance reminder message has been received from the server 10 by the communication I/F 22 (B650), and upon determining that the message has been received (B650: YES), executes reminder notification processing (B660).

The above-described method can be applied to the reminder notification processing, in a non-limiting example.

Thereafter, the controller 21 of the terminal 20B determines whether or not to display the talk room in the display 24 based on whether or not input for displaying the talk room has been made to the input device (B670). Upon determining to display the talk room (B670: YES), the controller displays the talk room in the display 24 based on the most recent talk data stored in the storage 28 (B680).

Thereafter, the controller 21 of the terminal 20B determines whether or not to end the processing (B690), and upon determining to continue the processing (B690: NO), returns to step B650. On the other hand, upon determining to end the processing (B690: YES), the controller ends the processing.

### Effects of Seventh Example Embodiment

In an example embodiment, a configuration is described in which a remittance request indication (a non-limiting example of the first indication based on the first information) is displayed in a talk room (a non-limiting example of a chat room) including at least the remittance requested user (a non-limiting example of the user of the terminal) and the remittance master user (a non-limiting example of the first user) in the terminal 20.

As an example of effects of the embodiment obtained with this configuration, it is possible to notify at least the user of the terminal and the first user of the first information easily and appropriately by displaying the first information in the chat room.

### Seventh Modification

Similarly to an example embodiment (1), in the case where pattern A described above is applied, information regarding remittance requests for which remittance has already been done may optionally be displayed in a display manner that is different from the display manner of information regarding remittance requests for which remittance has not been done.

In some messaging applications, talk information is saved independently in the server 10 and the terminal 20.

In a non-limiting example of such a case, a message that is saved in the server 10 is automatically deleted when a certain period (a non-limiting example of which is a few weeks) has elapsed from when the message is transmitted to the terminal 20, but a message that is saved in the terminal 20 remains as is unless the user deletes the message.

In this case, a history of messages basically remains without being deleted in the terminal 20, and accordingly, the user of the terminal 20 can view past remittance request messages and past remittance reminder messages based on data saved in the terminal 20.

Therefore, in this modification, the display manner of information relating to a remittance request is changed using a method described below.

FIG. 7-3 is a diagram showing an example of a table showing this method.

In a non-limiting example, remittance completion flags, information types, and messages are set in association with each other in this table.

The remittance completion flags include “OFF” and “ON”.

The information types indicate types of corresponding messages, and “request” and “reminder” are set as the information types in association with each of the remittance completion flags “OFF” and “ON”, in a non-limiting example.

Messages that are displayed in the talk room of the terminal 20 according to the corresponding remittance completion flag “ON” or “OFF” are set as the messages.

The following specifically describes the table.

### (1) Remittance Completion Flag “OFF”

A “first type remittance request message (remittance has not been done)” is set as the message of the information type “request”. This means that the first type remittance request message is displayed as a remittance request message in the talk room when the remittance completion flag is “OFF”, i.e., when remittance has not been completed.

A “first type remittance reminder message (remittance has not been done)” is set as the message of the information type “reminder”. This means that the first type remittance reminder message is displayed as a remittance reminder message in the talk room when the remittance completion flag is “OFF”, i.e., when remittance has not been completed.

### (2) Remittance Completion Flag “ON”

A “second type remittance request message (remittance has been done)” is set as the message of the information type “request”. This means that the second type remittance request message is displayed as a remittance request message in the talk room when the remittance completion flag is “ON”, i.e., when remittance has been completed.

A “second type remittance reminder message (remittance has been done)” is set as the message of the information type “reminder”. This means that the second type remittance reminder message is displayed as a remittance reminder message in the talk room when the remittance completion flag is “ON”, i.e., when remittance has been completed.

That is, a remittance request message and a remittance reminder message are displayed in a first display manner (a non-limiting example of which is a default display manner) when remittance has not been completed, but the display manner of these messages is changed from the first display manner to a second display manner (a non-limiting example of which is a display manner indicating completion of remittance) after remittance has been completed.

FIGS. 7-4 and 7-5 show a flowchart showing an example of a flow of processing executed by the devices in an example embodiment.

Upon receiving remittance request transmission request information from the terminal 20A by means of the communication I/F 14, the controller 11 of the server 10 updates talk management data (talk room) of the users A.A and B.B by adding a first type remittance request message as a remittance request message thereto (S710).

Thereafter, the controller 11 of the server 10 transmits the first type remittance request message and a second type remittance request message as remittance request messages to the terminal 20B by means of the communication I/F 14 (S720).

After step B620, the controller 21 of the terminal 20B stores the received remittance request messages (the first type and the second type) in the storage 28 (B725).

Thereafter, the controller 21 of the terminal 20B determines whether or not to display a talk room in the display 24 based on whether or not input for displaying the talk room has been made to the input device (B730). Upon determining to display the talk room (B730: YES), the controller displays the talk room in the display 24 based on the most recent talk data (B740).

Specifically, the controller displays the first type remittance request message as a remittance request message in the talk room.

Upon determining in step 5660 that reminding has not been stopped (S660: NO), the controller 11 of the server 10 updates the talk management data (talk room) of the users A.A and B.B by adding a first type remittance reminder message as a remittance reminder message thereto (S770).

Thereafter, the controller 11 of the server 10 transmits the first type remittance reminder message and a second type remittance reminder message as remittance reminder messages to the terminal 20B by means of the communication I/F 14 (S780).

After step B660, the controller 21 of the terminal 20B stores the received remittance reminder messages (the first type and the second type) in the storage 28 (B765).

Thereafter, the controller 21 of the terminal 20B determines whether or not to display the talk room in the display 24 based on whether or not input for displaying the talk room has been made to the input device (B770). Upon determining to display the talk room (B770: YES), the controller displays the talk room in the display 24 based on the most recent talk data (B780).

Specifically, in a case where remittance information has not been received from the server 10, for example, the controller displays the first type remittance request message and the first type remittance reminder message as the remittance request message and the remittance reminder message corresponding to each other, among messages in the talk room.

On the other hand, in a case where remittance information has been received from the server 10, the controller displays the second type remittance request message and the second type remittance reminder message as the remittance request message and the remittance reminder message corresponding to each other.

### Eighth Example Embodiment

An eighth embodiment relates to a case where remittance is executed not via a remittance request or a remittance reminder.

A case is envisaged in which the remittance requested user remits to the remittance master user using an independent remittance function of the payment application after checking a remittance request indication or a remittance reminder indication or without checking these indications.

In such a case, the server 10 cannot determine (identify) the remittance request management ID for which remittance reminding needs to be stopped.

Matter described in an example embodiment can also be applied to other embodiments and modifications.

Constitutional elements that are the same as those already described are denoted with the same reference numerals as those used for corresponding elements, and a redundant description thereof is omitted.

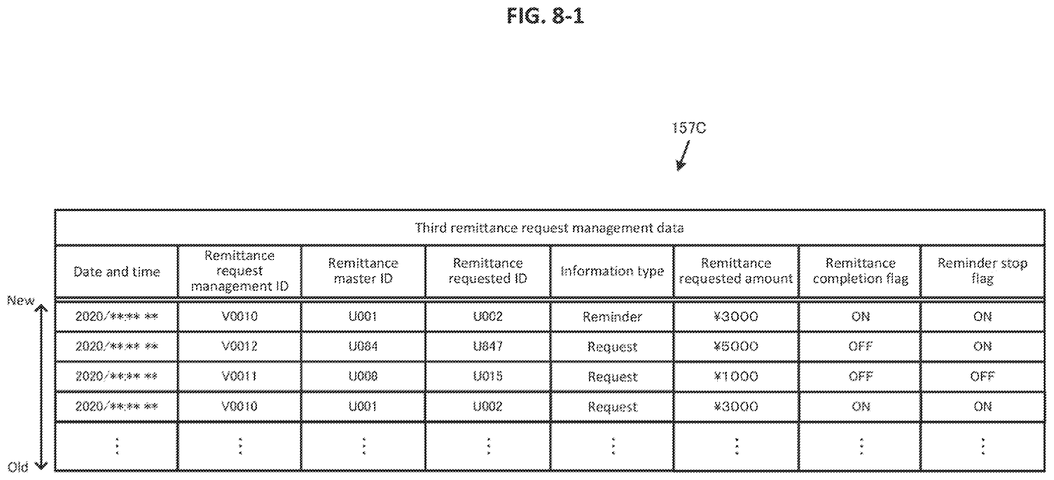

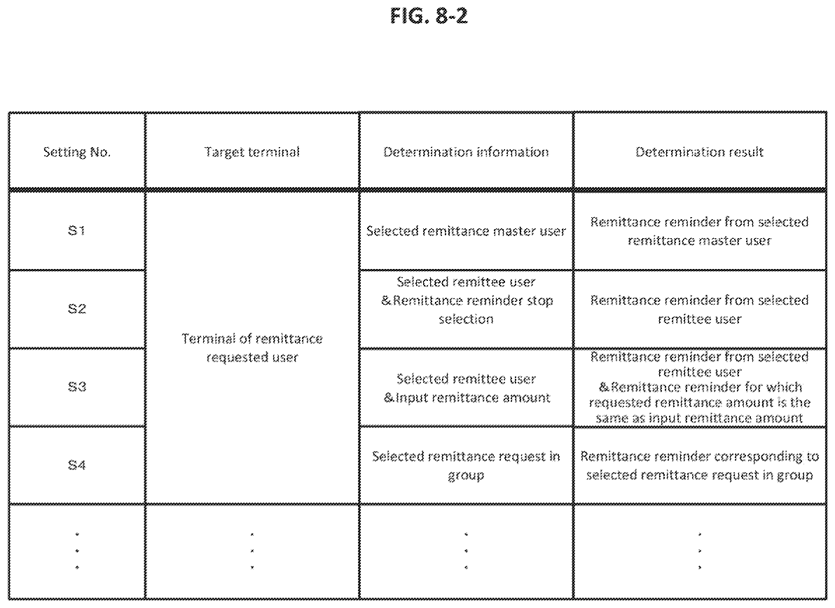

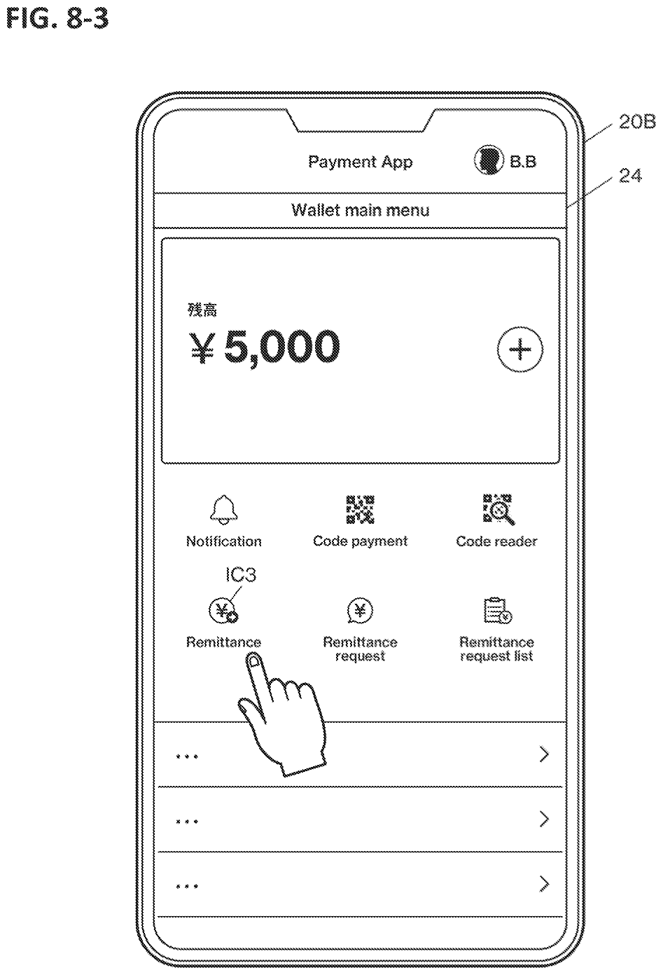

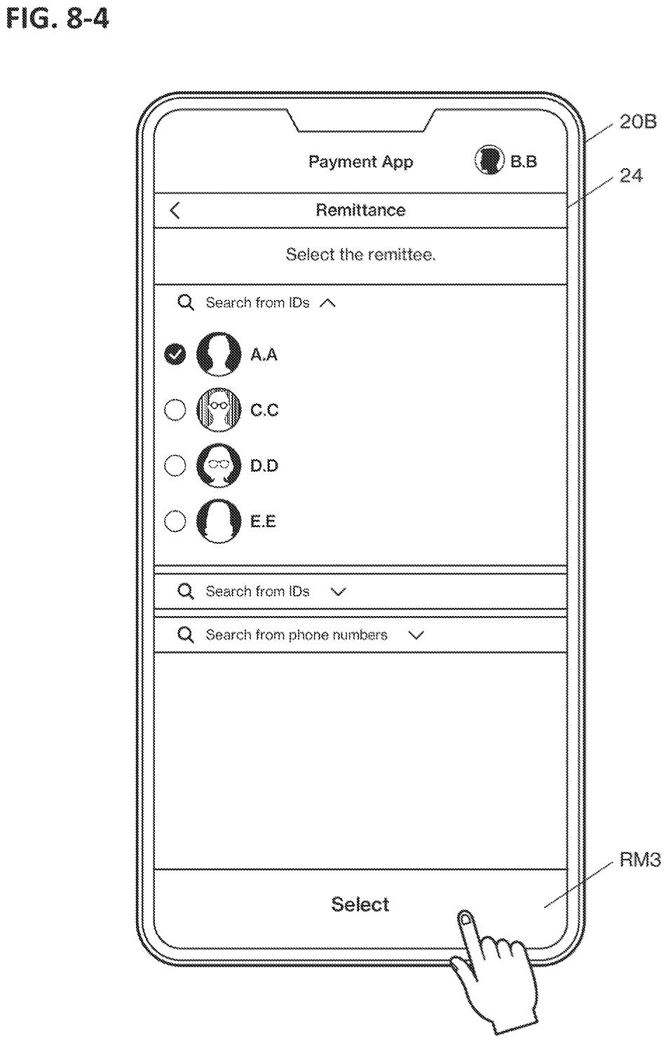

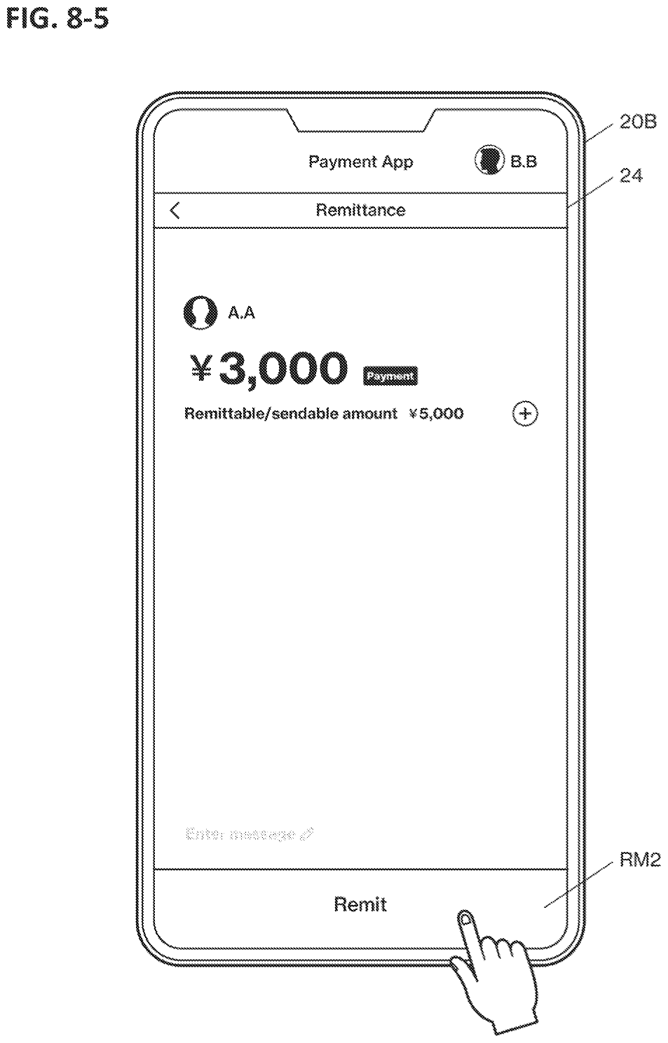

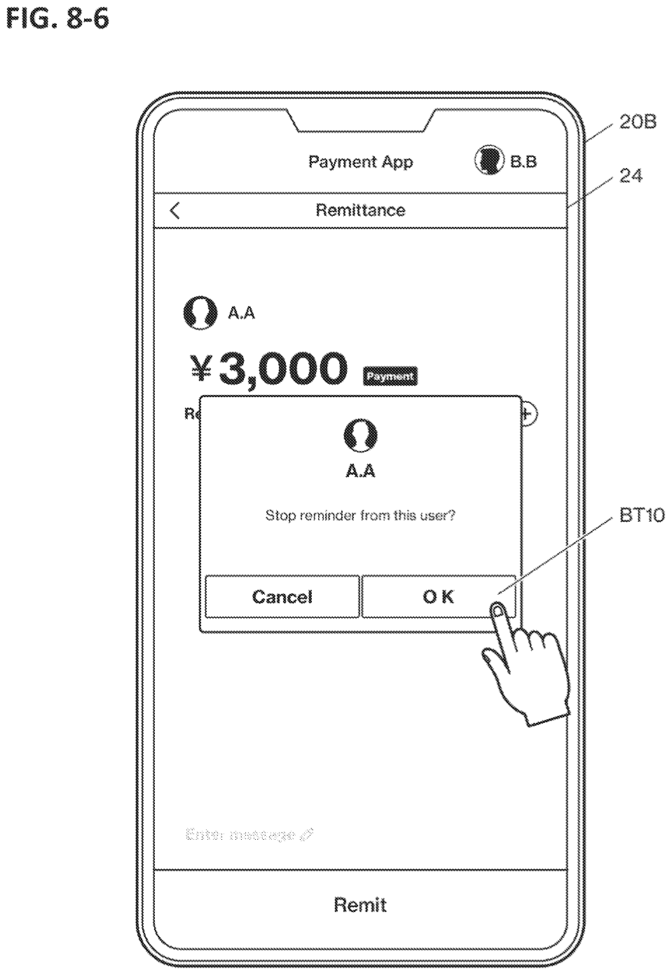

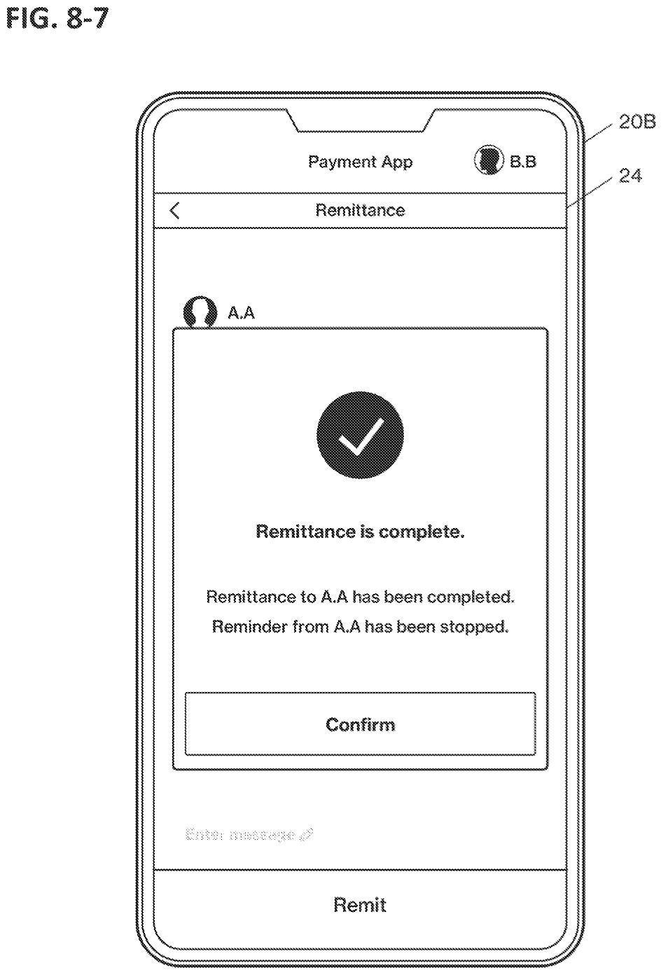

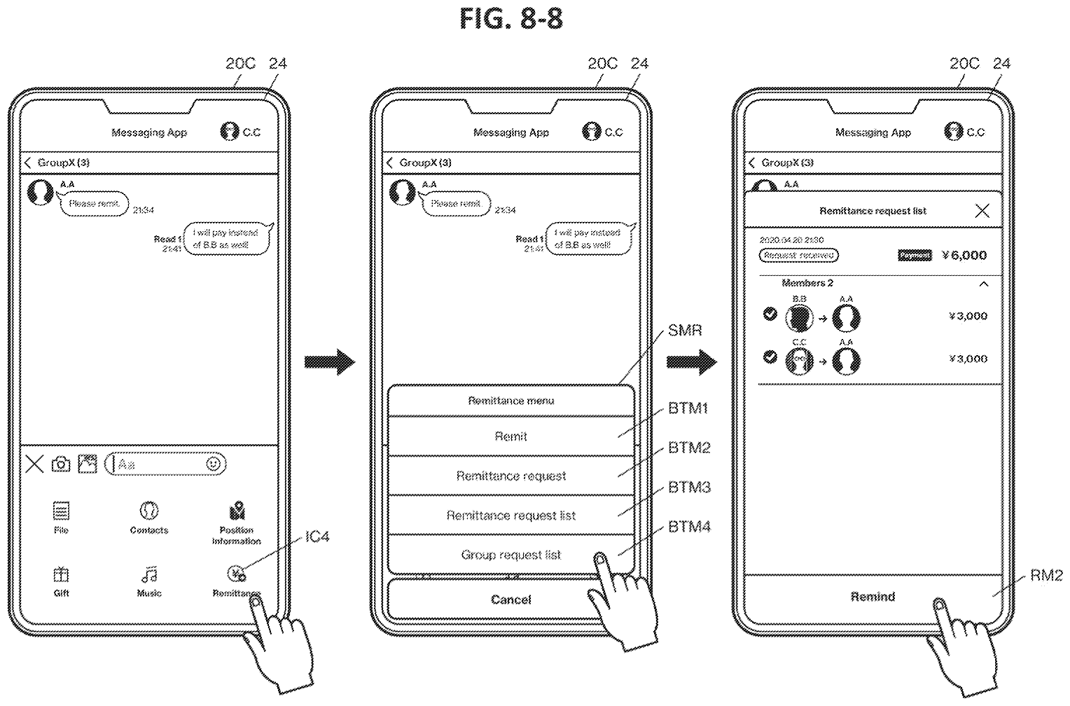

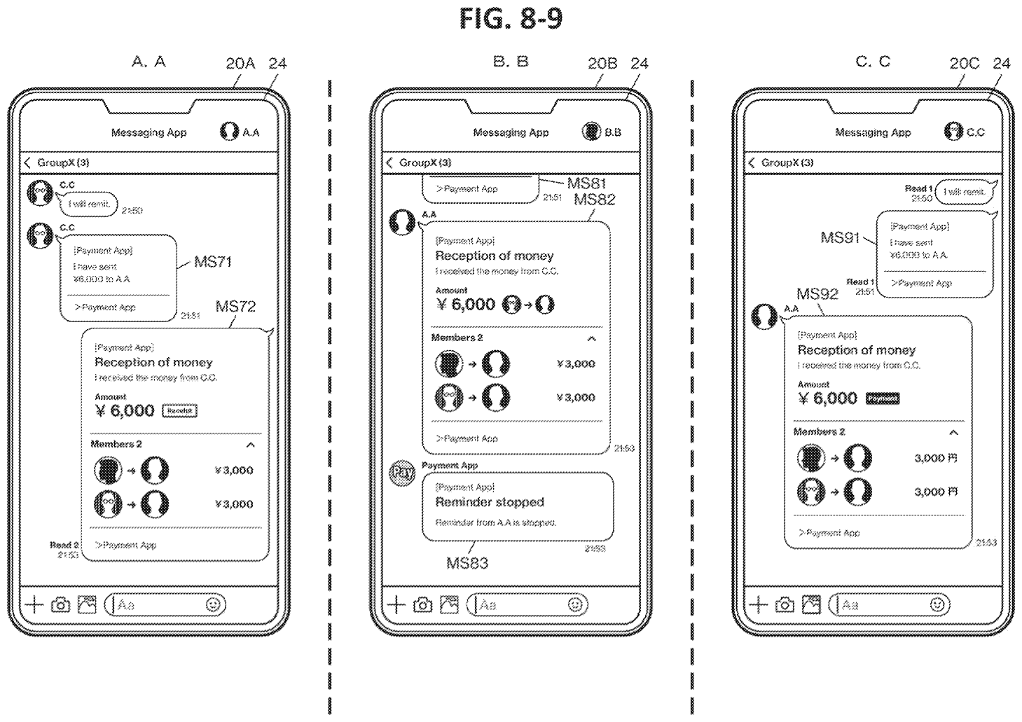

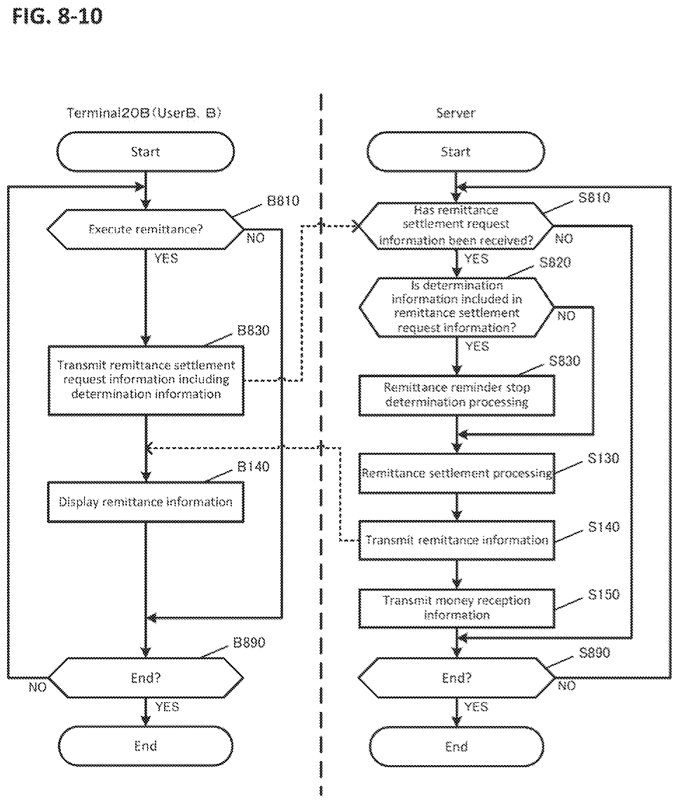

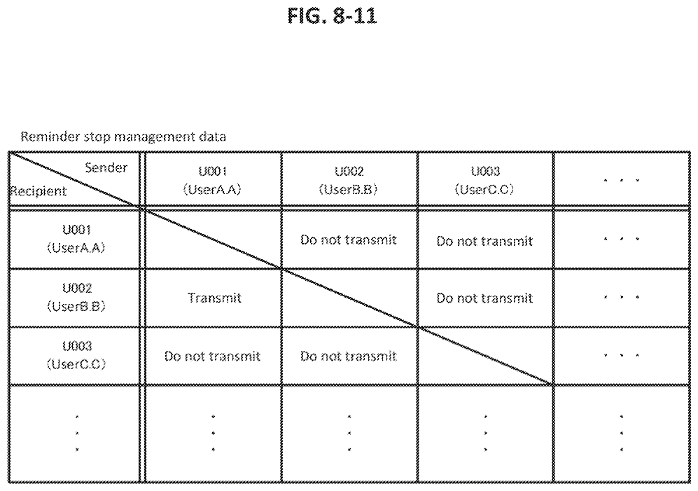

FIG. 8-1 is a diagram showing a configuration example of third remittance request management data 157C that is another example of the remittance request management data 157 described above and is stored in the storage 15 of the server 10.

In a non-limiting example, a reminder stop flag is stored in the third remittance request management data 157C in addition to and in association with the date and time, the remittance request management ID, the remittance master ID, the remittance requested ID, the remittance requested amount, the remittance completion flag, and the information type, which are included in the second remittance request management data 157B.

The reminder stop flag is a flag for discerning whether or not to stop transmission of remittance reminder information to the terminal 20 of the remittance requested user with respect to the corresponding remittance request management ID. The reminder stop flag is set to “ON” in the case where transmission of remittance reminder information is to be stopped.

The present embodiment differs from the above embodiments in that the reminder stop flag may be set to “ON” even if the remittance completion flag is “OFF”.

FIG. 8-2 is a diagram showing an example of a table showing a method with which the server 10 identifies a remittance request management ID in an example embodiment.

In a non-limiting example, setting numbers, target terminals, determination information, and determination results are set in association with each other in this table.

The “target terminal” is a terminal 20 that accepts selection or input of information based on which the server 10 determines a remittance reminder to be stopped.

The determination information is information based on which the server 10 determines a remittance reminder to be stopped.

The determination results are remittance reminders that are determined to be stopped by the server 10.

The following specifically describes the table.

In a setting No. S1, “the terminal of the remittance requested user” is set as the target terminal, “a selected remittance master user” is set as the determination information, and “a remittance reminder from the selected remittance master user” is set as the determination result.

This means that a list of users (remittance master users) requesting remittance is displayed in a screen (a non-limiting example of which is the remittance screen) displayed in the display 24 of the terminal 20 of the remittance requested user, for example, to let the remittance requested user select any of the remittance master users, and a remittance reminder from the selected remittance master user is stopped based on selection of the remittance master user.

When this setting is applied, the server 10 executes remittance from the remittance requested user while deeming the remittance to be a remittance based on a remittance request from the selected remittance master user to the remittance requested user. Then, the server 10 stops a remittance reminder from the remittance master user to the remittance requested user.

Specifically, the server 10 sets reminder stop flags corresponding to the remittance request management IDs of all remittance requests from the selected remittance master user to the remittance requested user to “ON” in the third remittance request management data 157C, in a non-limiting example.

However, the remittance request cannot be uniquely identified according to this setting, and therefore, the remittance completion flags may be kept “OFF”.

In a setting No. S2, “the terminal of the remittance requested user” is set as the target terminal, “a selected remittee user & remittance reminder stop selection” is set as the determination information, and “a remittance reminder from the selected remittee user” is set as the determination result.

This means that, when the remittance requested user selects a remittee user and further selects to stop a remittance reminder from the remittee user in a screen (a non-limiting example of which is the remittance screen) displayed in the display 24 of the terminal 20 of the remittance requested user, for example, a remittance reminder from the selected remittee user is stopped.

When this setting is applied, the server 10 determines whether or not there is a remittance request from the selected remittee user to the remittance requested user. Upon determining that there is such a remittance request, the server executes remittance from the remittance requested user while deeming the remittance to be a remittance based on the remittance request from the selected remittee user to the remittance requested user. Then, when a selection is made to stop a remittance reminder, the server 10 stops a remittance reminder from the remittee user to the remittance requested user.

Specifically, the server 10 sets reminder stop flags corresponding to the remittance request management IDs of all remittance requests from the selected remittee user to the remittance requested user to “ON” in the third remittance request management data 157C, in a non-limiting example.

However, the remittance request cannot be uniquely identified according to this setting as well, and therefore, the remittance completion flags may be kept “OFF”.

Note that if a selection is not made to stop a remittance reminder, the server 10 does not stop the remittance reminder. This also applies to the following cases.

In a setting No. S3, “the terminal of the remittance requested user” is set as the target terminal, “a selected remittee user & an input remittance amount” is set as the determination information, and “a remittance reminder from the selected remittee user & a remittance reminder for which the remittance requested amount is the same as the input remittance amount” is set as the determination result.

This means that, when the remittance requested user selects a remittee user and inputs a remittance amount to be remitted to the remittee user in a screen (a non-limiting example of which is the remittance screen) displayed in the display 24 of the terminal 20 of the remittance requested user, for example, a remittance reminder from the selected remittee user for which the remittance requested amount is the same as the input remittance amount is stopped.

When this setting is applied, the server 10 identifies a remittance request management ID that is associated with a remittance requested amount that is the same as the remittance amount input to the terminal 20 of the remittance requested user from among remittance request management IDs of remittance requests from the selected remittee user to the remittance requested user in the third remittance request management data 157C, in a non-limiting example.

Then, the server 10 executes remittance from the remittance requested user while deeming the remittance to be a remittance based on a remittance request corresponding to the identified remittance request management ID. Then, the server 10 stops a remittance reminder for the remittance request corresponding to the remittance request management ID. Specifically, the server 10 sets both the remittance completion flag and the reminder stop flag corresponding to the identified remittance request management ID to “ON” in the third remittance request management data 157C, in a non-limiting example.

Note that instead of or in addition to stopping a remittance reminder for which the remittance requested amount is the same as the input remittance amount, a remittance reminder for which the remittance requested amount is close to the input remittance amount (for example, a remittance reminder for which the difference between the remittance requested amount and the input remittance amount is \300 or less) may optionally be stopped.

In a setting No. S4, “the terminal of the remittance requested user” is set as the target terminal, “a selected remittance request in a group” is set as the determination information, and “a remittance reminder corresponding to the selected remittance request in the group” is set as the determination result.

This means that, when the remittance requested user selects a remittance request for another group user together with a remittance request for the remittance requested user in a screen (a non-limiting example of which is a group request list screen) displayed in the display 24 of the terminal 20 of the remittance requested user, remittance reminders corresponding to these remittance requests are stopped.

When this setting is applied, the server 10 executes remittance from the remittance requested user while deeming the remittance to be a remittance based on the selected remittance requests in the group. Then, the server 10 stops a remittance reminder corresponding to the remittance request for the remittance requested user and a remittance reminder corresponding to the selected remittance request for the other group user.

Specifically, the server 10 sets the remittance completion flags and the reminder stop flags corresponding to the remittance request management IDs of these remittance requests to “ON” in the third remittance request management data 157C, in a non-limiting example.

According to this setting, one remittance requested user included in a group can stop a remittance reminder to himself or herself and a remittance reminder to another group user who is included in the same group by remitting an amount to be remitted by the other group user in addition to the amount to be remitted by himself or herself

Note that, in each of the settings described above, selection of whether or not to stop a remittance reminder (whether or not a selection to stop a remittance reminder is made) may optionally be adopted as an essential element of determination, and a remittance reminder may be stopped in the case where a selection was made to stop the remittance reminder.

### Display Screen

The following describes examples of display screens of cases where the above-described setting Nos. S2 and S4 are respectively applied.

FIGS. 8-3 to 8-7 show an example of transition of the screen in the case where the setting No. S2 is applied.

FIG. 8-3 shows a main menu screen of the payment application displayed in the display 24 of the terminal 20B, which corresponds to the screen shown in FIG. 2-2. Here, a state where a remittance icon IC3 is tapped is shown. In a non-limiting example of this case, a remittee user selection screen shown in FIG. 8-4 is displayed.

The remittee user selection screen is a screen for selecting a remittee user, and includes a field for searching for candidates of the remittee user from payment application IDs and a field for searching for candidates of the remittee user from phone numbers, for example. In this example, the field for searching for candidates of the remittee user from payment application IDs is selected, and a plurality of users “A.A”, “C.C”, “D.D”, and “E.E” are displayed as the search results. In this example, the user “A.A” is selected as the remittee user as a result of the checkbox beside “A.A” being checked.

After a selection region RM3 in a lower portion of the screen is tapped in this state and a to-be-remitted amount is input in an amount input screen (not shown), the screen shown in FIG. 8-5 is displayed, in a non-limiting example.

In this screen, “\3,000” has been input as the to-be-remitted amount, and when a remittance region RM2 in a lower portion of the screen is tapped in this state, remittance reminder stop information RS1 including the icon image and the user name of the user A.A, a text “Stop reminder from this user?”, an OK button BT10, and a cancel button pops up in a center portion of the screen as shown in FIG. 8-6, in a non-limiting example.

When the OK button BT10 included in the remittance reminder stop information RS1 is tapped in this state, remittee user selection information (information indicating that the user A.A has been selected) and remittance reminder stop request information are transmitted from the terminal 20B to the server 10. Then, remittance is executed and remittance reminding is performed by the server 10. Then, a remittance completion notification indicating that remittance has been completed and remittance reminding has been stopped pops up in the center portion of the screen as shown in FIG. 8-7, in a non-limiting example.

FIG. 8-8 shows an example of the main menu screen of the payment application displayed in the display 24 of the terminal 20B in an example embodiment.

This main menu screen corresponds to the screen shown in FIG. 2-2, and shows the state where the remittance icon IC3 is tapped. In a non-limiting example of this case, the remittee user selection screen shown in FIG. 8-4 is displayed.

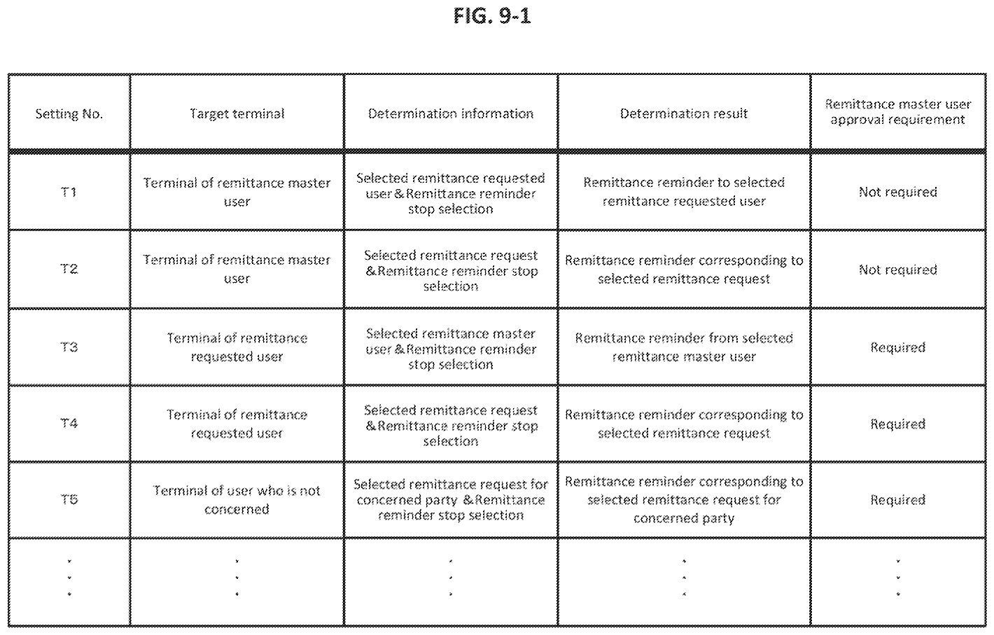

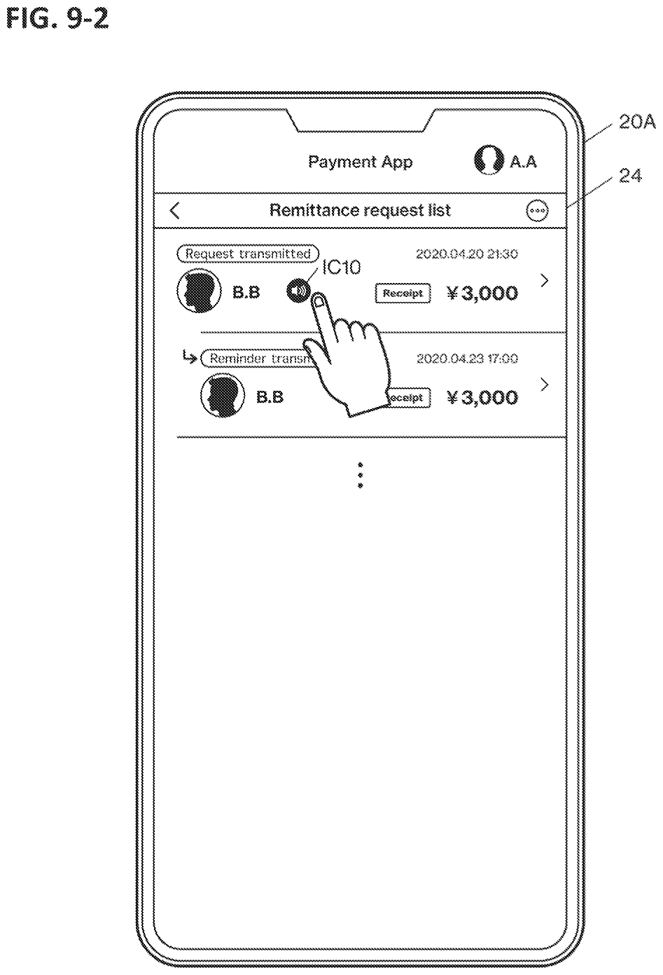

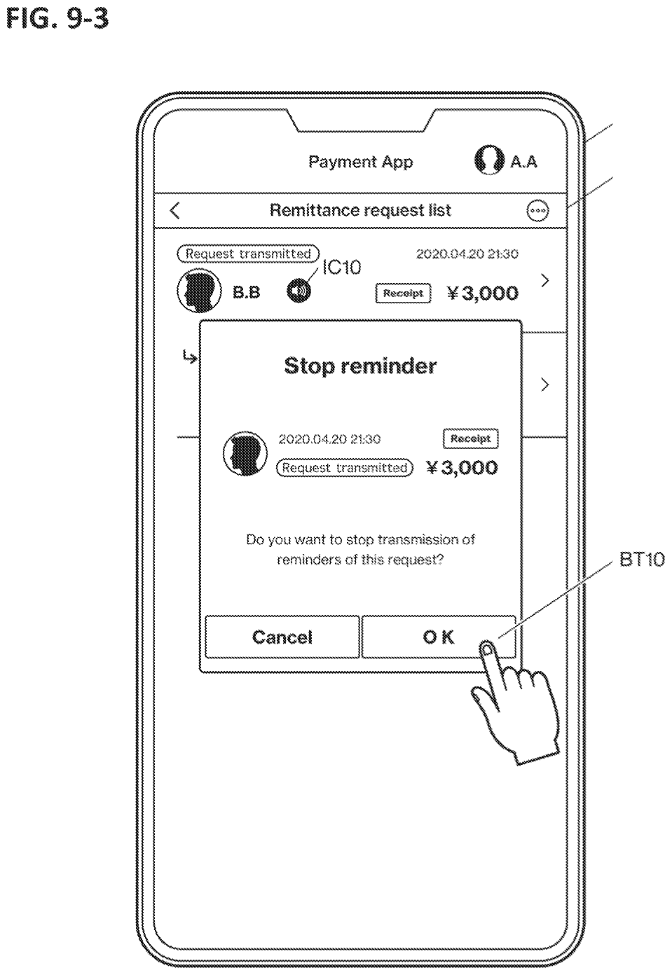

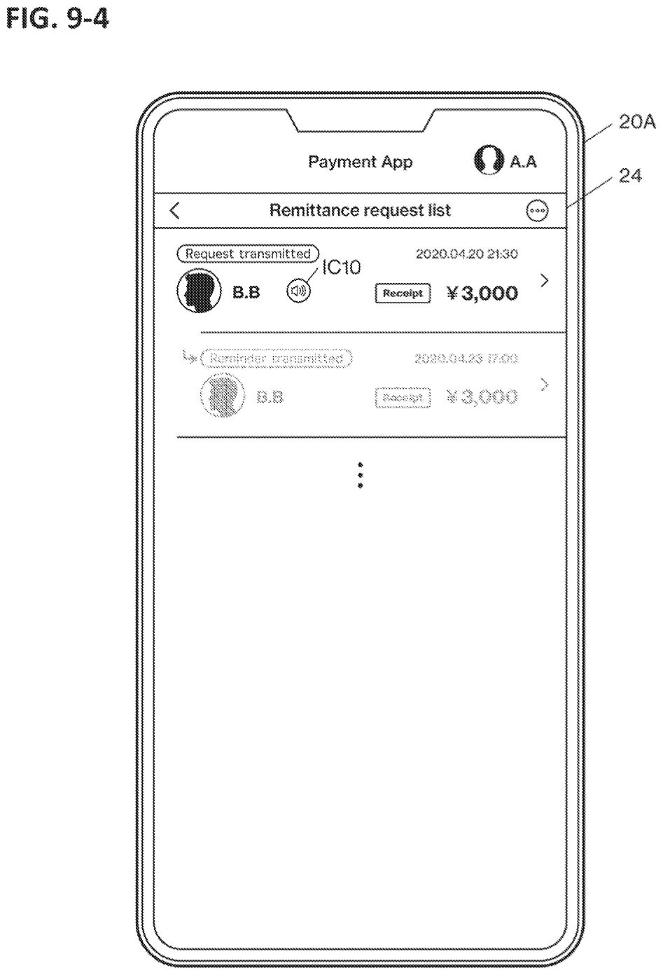

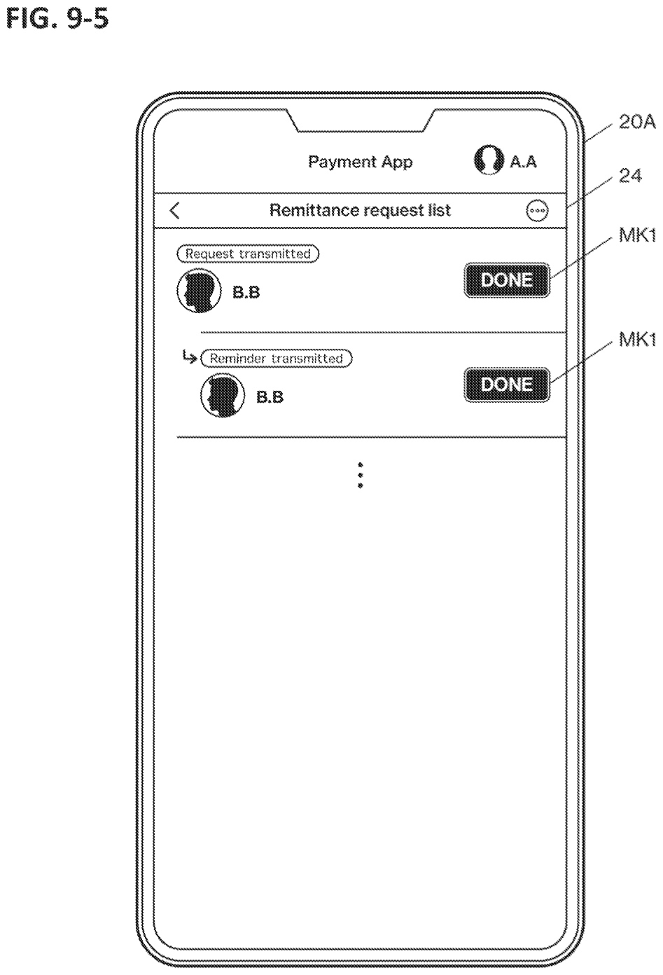

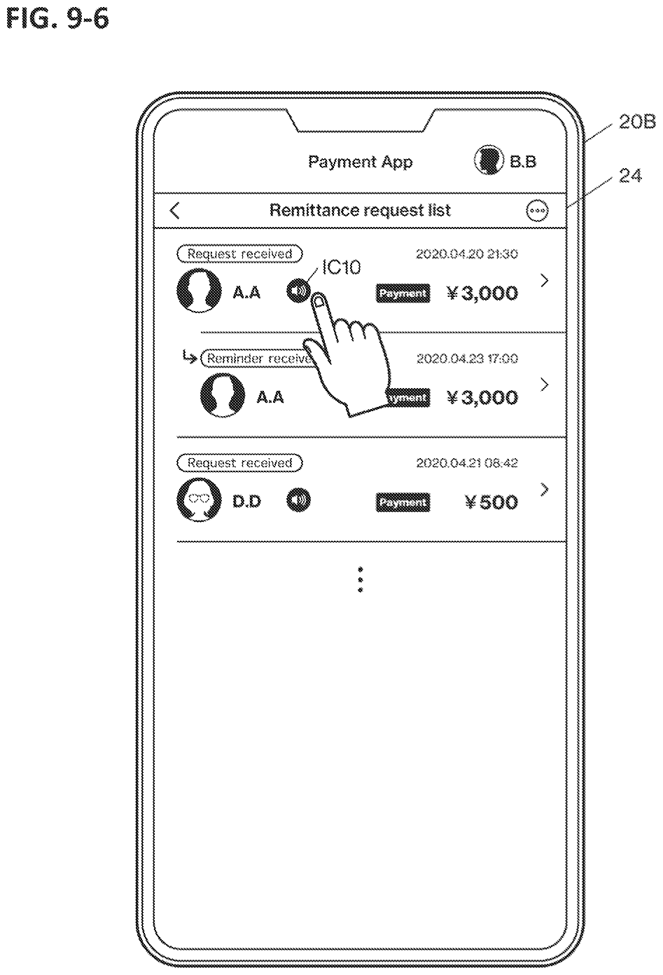

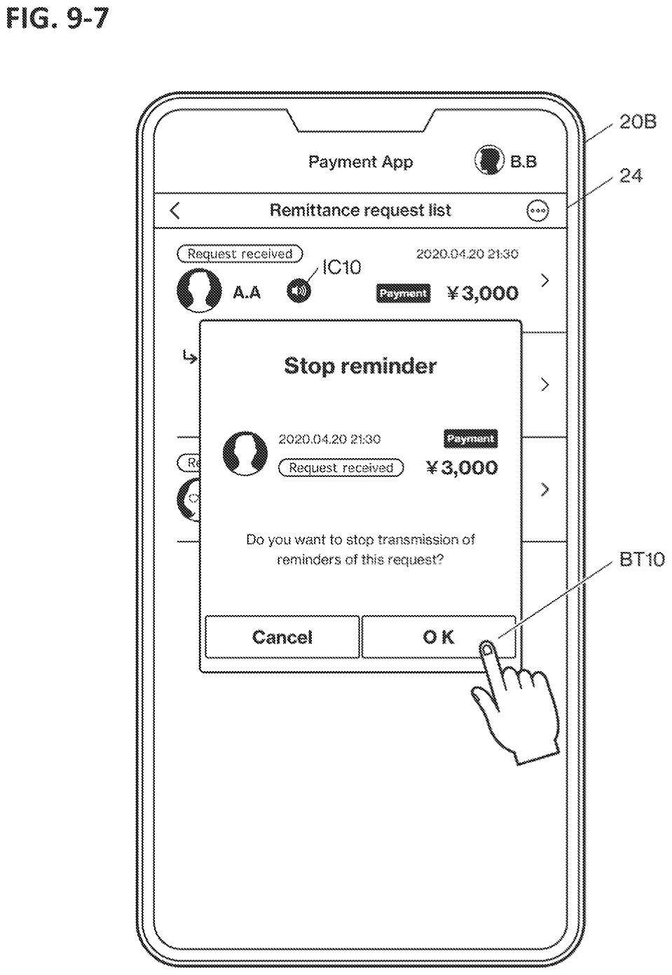

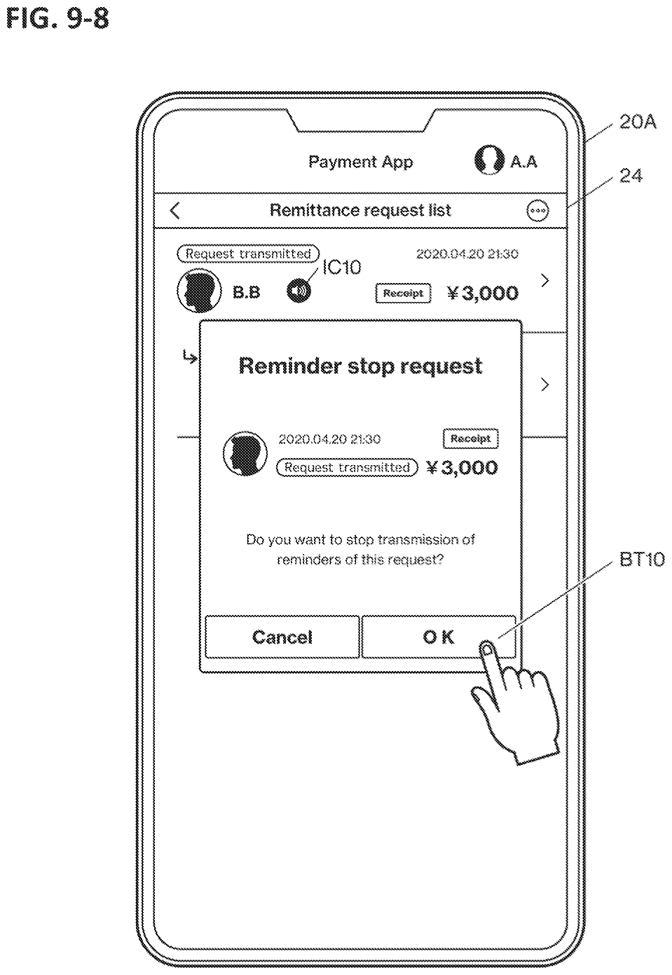

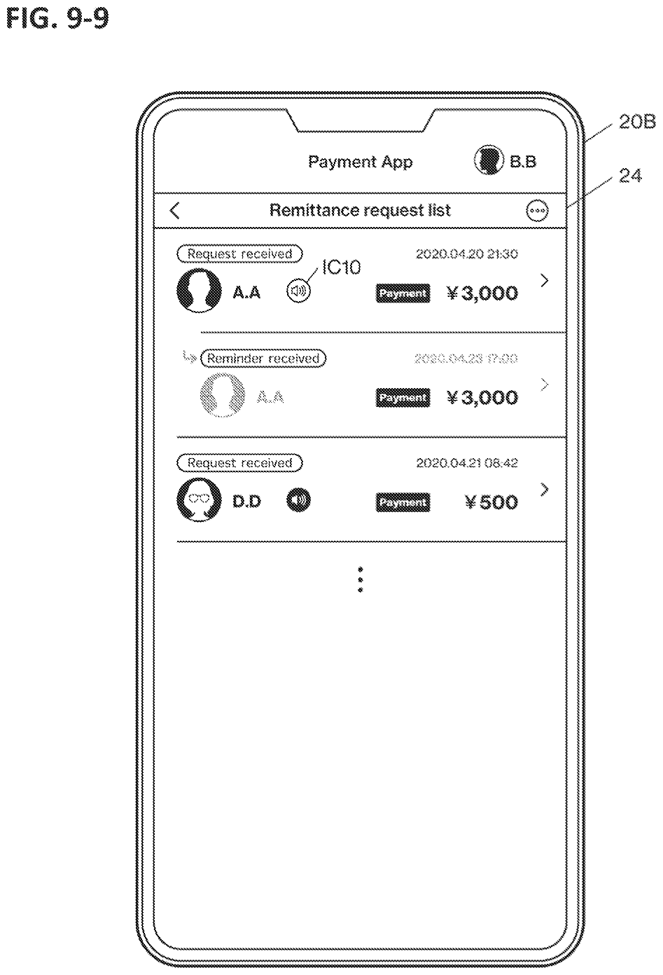

FIGS. 8-8 and 8-9 show an example of transition of the screen in the case where the setting No. S4 is applied. FIG. 8-8 shows an example of a group talk room displayed in the display 24 of the terminal 20C of the user C.C.

When a remittance icon IC4 at the lower right is tapped out of the icons displayed in a lower portion of the group talk room, the remittance item selection region SMR is displayed on the talk room as described above.

In this remittance item selection region SMR, a button BTM4 for displaying a group request list is displayed in addition to the button BTM1 for sending money to other users, the button BTM2 for transmitting remittance request information to other users, and the button BTM3 for displaying a remittance request list.

When the button BTM4 is tapped, a list of group requests is displayed in the screen, in a non-limiting example. In this example, remittance requests for two users, i.e., a remittance request from the user A.A to the user B.B (a request for remittance from the user B.B to the user A.A) requesting remittance of \3,000 and a remittance request from the user A.A to the user C.C (a request for remittance from the user C.C to the user A.A) requesting remittance of \3,000 are displayed as group requests.

When checkboxes associated with the respective remittance requests for the two users are checked and the remittance region RM2 in the lower portion of the screen is tapped, remittance request selection information is transmitted from the terminal 20C to the server 10. Then, remittance based on the remittance requests for the two users is executed and remittance reminding corresponding to the remittance requests is stopped by the server 10.

FIG. 8-9 shows a group talk room displayed in the display 24 of the terminal 20A of the remittance master user A.A, a group talk room displayed in the display 24 of the terminal 20B of the remittance requested user B.B, and a group talk room displayed in the display 24 of the terminal 20C of the remittance requested user C.C.

In the group talk room displayed in the terminal 20A, a message MS71 indicating that the amount to be remitted from the two users has been remitted from the user C.C to the user A.A is displayed, and a message M72 indicating that the user A.A received the amount is displayed below the message MS71.

In the group talk room displayed in the terminal 20B, a message M83 indicating that a remittance reminder from the user A.A to the user B.B has been stopped is displayed in addition to a message MS81 corresponding to the message MS71 and indicating that the amount to be remitted from the two users has been remitted from the user C.C to the user A.A and a message MS82 corresponding to the message MS72 and indicating that the user A.A received the amount.

In the group talk room displayed in the terminal 20C, a message MS91 corresponding to the message MS71 and indicating that the amount to be remitted from the two users has been remitted from the user C.C to the user A.A and a message MS92 corresponding to the message MS72 and indicating that the user A.A received the amount are displayed.

In this case, a remittance reminder from the user A.A to the user C.C is stopped as well as the remittance reminder from the user A.A to the user B.B. However, a message indicating that the remittance reminder from the user A.A to the user C.C has been stopped is not displayed in the group talk room displayed in the terminal 20C in this example because it is thought that the user C.C pays the amount including the amount requested for the user B.B, knowing that a remittance reminder to himself or herself will be stopped.

Note that a different configuration is also possible in which a message indicating that a remittance reminder from the user A.A to the user C.C has been stopped is displayed in the group talk room displayed in the terminal 20C.

### Processing

FIGS. 8-10 is a flowchart showing an example of a flow of processing executed by the devices in an example embodiment.

Here, processing performed by the terminal 20B is shown on the left, processing performed by the server 10 is shown on the right, and illustration of processing performed by the terminal 20A is omitted.

The processing is executed by the controller 21 of the terminal 20B and the controller 11 of the server 10 as a subroutine of the processing shown in FIGS. 6-1 and 6-2, in a non-limiting example.

The controller 21 of the terminal 20B determines whether or not to execute remittance (B810). Specifically, the controller determines whether or not input for executing remittance has been made to the input device via the above-described remittance screen, group request list screen, or the like, in a non-limiting example.

Upon determining to execute remittance (B810: YES), the controller 21 of the terminal 20B transmits remittance settlement request information including the above-described determination information by means of the communication I/F 22 to the server 10 (B830).

The controller 11 of the server 10 determines whether or not the remittance settlement request information has been received from the terminal 20B by the communication I/F 14 (S810), and upon determining that the remittance settlement request information has been received (S810: YES), determines whether or not the received remittance settlement request information includes determination information (S820).

Upon determining that the received remittance settlement request information includes determination information (S820: YES), the controller 11 of the server 10 executes remittance reminder stop determination processing (S830).

Specifically, the controller determines (identifies) a remittance request management ID for which a remittance reminder is to be stopped using the method described with reference to the table shown in FIG. 8-2, in a non-limiting example.

Thereafter, the controller 11 of the server 10 executes remittance settlement processing (S130). Specifically, the controller executes remittance with respect to a remittance request that is associated with the determined remittance request management ID, in a non-limiting example. Then, the controller sets flags (the remittance completion flag and the reminder stop flag) using the method described above.

After step B140, the controller 21 of the terminal 20B determines whether or not to end the processing (B890), and upon determining to continue the processing (B890: NO), returns to step B810.

On the other hand, upon determining to end the processing (B890: YES), the controller 21 of the terminal 20B ends the processing.

Likewise, after step S150, the controller 11 of the server 10 determines whether or not to end the processing (S890), and upon determining to continue the processing (S890: NO), returns to step 5810.

On the other hand, upon determining to end the processing (S890: YES), the controller 11 of the server 10 ends the processing.

Also, in this processing, the controller 11 of the server 10 determines, in step 5267 shown in FIG. 6-2, whether or not reminding has been stopped for the remittance request management ID corresponding to remittance reminder information of which transmission is requested. Specifically, in a non-limiting example, the controller refers to the third remittance request management data 157C, and if the request stop flag corresponding to the remittance request management ID is set to “ON”, determines that reminding has been stopped. Effects of Eighth Example Embodiment

In an example embodiment, second remittance processing (a non-limiting example of the remittance processing) is executed by the server 10 based on selection of a remittance master user (a non-limiting example of the first user) displayed in the display 24 of the terminal 20 of the remittance requested user.

As an example of effects of the embodiment obtained with this configuration, based on selection of the first user displayed in the display of the terminal, the remittance processing can be executed while being deemed to be a remittance based on a remittance request from the first user.

Also, in an example embodiment, a configuration is described in which the second remittance processing is executed based on selection of the remittance master user (a non-limiting example of the first user) and selection to stop a remittance reminder (a non-limiting example of information indicating that the second information is not to be transmitted) by the remittance requested user (a non-limiting example of the user of the terminal).

As an example of effects of the embodiment obtained with this configuration, the remittance processing can be appropriately executed based on selection of the first user and selection of the information indicating that the second information is not to be transmitted, by the user of the terminal.

Also, in an example embodiment, a configuration is described in which the second remittance processing is executed based on the remittance master user (a non-limiting example of the first user), the remittance requested amount (a non-limiting example of an amount based on the remittance request), and the to-be-remitted amount (a non-limiting example of an amount input by a user of the terminal).

As an example of effects of the embodiment obtained with this configuration, the remittance processing can be appropriately executed based on selection of the first user, the amount based on the remittance request, and the amount input by the user of the terminal.

Also, in an example embodiment, a configuration is described in which the second remittance processing is executed based on remittance to the remittance master user (a non-limiting example of the first user) from a group user (a non-limiting example of a second user) who is different from the remittance requested user (a non-limiting example of the user of the terminal).

As an example of effects of the embodiment obtained with this configuration, the remittance processing can be appropriately executed based on remittance to the first user from the second user different from the user of the terminal who is requested to remit.

In this case, a configuration is also possible in which remittance request information is transmitted to a group including at least the remittance requested user (a non-limiting example of the user of the terminal), the remittance master user (a non-limiting example of the first user), and the other group user (a non-limiting example of the second user), and the second remittance processing is executed based on input that is made by the other group user to a remittance request indication displayed in the terminal 20 of the group user based on the remittance request information.

As an example of effects of the embodiment obtained with this configuration, the remittance processing can be executed easily and appropriately based on input made by the second user to the first indication displayed in the terminal of the second user based on the first information.

Also, in an example embodiment, a configuration is described in which information (a non-limiting example of first user information) such as the icon image and the user name of the remittance master user is displayed in the display 24 of the terminal 20, and first remittance processing is executed based on input that is made by the remittance requested user (a non-limiting example of the user of the terminal) to the first user information displayed in the display 24.

As an example of effects of the embodiment obtained with this configuration, the remittance processing can be executed based on input made by the user of the terminal to the first user information displayed in the display, which is easy for the user to understand.

Also, in an example embodiment, the terminal 20 obtains information of a selected remittee user (a non-limiting example of information indicating selection of the first user) and information of the to-be-remitted amount (a non-limiting example of information of an amount to be remitted to the first user) based on input that is made to the terminal 20. Then, the first remittance processing is executed based on information of the remittance requested amount and the information of the to-be-remitted amount.

As an example of effects of the embodiment obtained with this configuration, when an amount based on a remittance request is the same as the amount to be remitted to a user, for example, remittance can be executed while being deemed to be a remittance based on the remittance request from the user.

Also, in an example embodiment, a configuration is described in which the first remittance processing is executed based on input (a non-limiting example of input indicating remittance to the first user based on the remittance request) that is made by the remittance requested user to the terminal 20 to select the remittance master user or to stop a remittance reminder.

As an example of effects of the embodiment obtained with this configuration, the remittance processing can be executed easily and appropriately based on input indicating remittance to the first user based on the remittance request.

### Eighth Modification

In an example embodiment, the reminder stop flags included in the remittance request management data 157 are used by the server 10 to determine whether or not to stop transmission of remittance reminder information, but there is no limitation to this configuration.

In a non-limiting example, data different from the remittance request management data may optionally be used to determine whether or not to stop transmission of remittance reminder information.

FIG. 8-11 is a diagram showing an example of reminder stop management data that is stored in the storage 15 of the server 10 in this modification.

In a non-limiting example of the reminder stop management data, information (transmit or do not transmit) indicating whether or not to transmit remittance reminder information from a sender to a recipient is stored in a matrix in which application IDs of users (recipients) who receive the remittance reminder information are stored in association with respective rows and application IDs of users (senders) who transmit the remittance reminder information are stored in association with respective columns.

In the default state, “transmit” is stored in each cell at which a column associated with a sender intersects with a row associated with a recipient, but when it is determined to stop transmitting the remittance reminder information from a sender to a recipient in the remittance reminder stop determination processing (S830) shown in FIG. 8-10, a cell at which the column associated with the sender intersects with the row associated with the recipient is updated to “do not transmit”.

For example, when it is determined to stop a remittance reminder from the user A.A, who is the remittance master user, to the user B.B, who is the remittance requested user, a cell at which the column associated with the sender “U001 (user A.A)” intersects with the row associated with the recipient “U002 (user B.B)” is updated to “do not transmit”.

### Ninth Example Embodiment

In a ninth embodiment, remittance reminding is stopped in exception cases that are different from those described in the above embodiment.

Matter described in an example embodiment can also be applied to other embodiments and modifications.

Constitutional elements that are the same as those already described are denoted with the same reference numerals as those used for corresponding elements, and a redundant description thereof is omitted.

The following cases are conceivable as cases in which remittance reminding needs to be stopped.

(A) Remittance based on a remittance request has not been executed, but it is desired to stop remittance reminding.

(B) It is desired to stop remittance reminding because an amount corresponding to a remittance request has been paid without use of the payment application, for example.

In a non-limiting example of the case (A), mainly a user who is a concerned party (in some cases, a user who is not a concerned party) desires to stop remittance reminding to prevent repetition of remittance reminding, although remittance has not been executed.

A case is also conceivable in which the remittance master user waives the remittance request.

In a non-limiting example of the case (B), the remittance requested amount has been paid in cash by being delivered in person or being transferred between accounts of financial institutions (e.g., banks), for example. In this case as well, it is thought that mainly a user who is a concerned party desires to stop remittance reminding.

FIG. 9-1 is a diagram showing an example of a table showing a method for stopping transmission of remittance reminder information in an example embodiment.

In a non-limiting example, setting numbers, target terminals, determination information, determination results, and remittance master user approval requirement are set in association with each other in this table.

The meanings of the target terminal, the determination information, and the determination results are the same as those in the table shown in FIG. 8-2.

Remittance master user approval requirement (required or not required) is information for determining the necessity of approval by the remittance master user to stop remittance reminding.

The following specifically describes the table.

In a setting No. T1, “the terminal of the remittance master user” is set as the target terminal, “a selected remittance requested user & remittance reminder stop selection” is set as the determination information, “a remittance reminder to the selected remittance requested user” is set as the determination result, and “not required” is set as the information for determining the necessity of approval by the remittance master user.

This means that, when the remittance master user selects a remittance requested user and further selects to stop a remittance reminder in a screen (a non-limiting example of which is a remittance requested user list screen) displayed in the display 24 of the terminal 20 of the remittance master user, for example, a remittance reminder to the selected remittance requested user is stopped.

Since the remittance reminder is stopped according to the request of the remittance master user, “not required” is set as the information for determining the necessity of approval by the remittance master user.

When this setting is applied, the server 10 stops all remittance reminders from the remittance master user to the selected remittance requested user.

Specifically, in a non-limiting example, the server 10 sets reminder stop flags corresponding to the remittance request management IDs of all remittance requests from the remittance master user to the selected remittance requested user to “ON” in the third remittance request management data 157C.

In a setting No. T2, “the terminal of the remittance master user” is set as the target terminal, “a selected remittance request & remittance reminder stop selection” is set as the determination information, “a remittance reminder corresponding to the selected remittance request” is set as the determination result, and “not required” is set as the information for determining the necessity of approval by the remittance master user.

This means that, when the remittance master user selects a remittance request and further selects to stop a remittance reminder in a screen (a non-limiting example of which is the remittance request list screen) displayed in the display 24 of the terminal 20 of the remittance master user, for example, a remittance reminder corresponding to the selected remittance request is stopped.

Since the remittance reminder is stopped according to the request of the remittance master user, “not required” is set as the information for determining the necessity of approval by the remittance master user.

When this setting is applied, the server 10 stops a remittance reminder corresponding to the selected remittance request. Specifically, in a non-limiting example, the server 10 sets the reminder stop flag corresponding to the remittance request management ID of the selected remittance request to “ON” in the third remittance request management data 157C.

However, although the remittance request management ID can be uniquely identified, whether or not remittance based on the remittance request has been executed cannot be determined according to this setting. Therefore, the remittance completion flag is kept “OFF”.

Accordingly, in the case where the remittance has already been executed, information indicating completion of the remittance may be transmitted from the terminal 20 of the remittance master user to the server 10, and the remittance completion flag may be set to “ON” by the server 10.

In a setting No. T3, “the terminal of the remittance requested user” is set as the target terminal, “the remittance master user & remittance reminder stop selection” is set as the determination information, “a remittance reminder from the selected remittance master user” is set as the determination result, and “required” is set as the information for determining the necessity of approval by the remittance master user.

This means that, when the remittance requested user selects a remittance master user and further selects to stop a remittance reminder in a screen (a non-limiting example of which is a remittance master user list screen) displayed in the display 24 of the terminal 20 of the remittance requested user, for example, a remittance reminder from the selected remittance master user is stopped.

Since the remittance reminder is stopped according to the request of the remittance requested user, “required” is set as the information for determining the necessity of approval by the remittance master user.

When this setting is applied, the server 10 executes processing (hereinafter referred to as “approval confirmation processing”) for confirming whether or not approval for stopping the remittance reminder can be obtained from the terminal 20 of the selected remittance master user. Specifically, the server 10 transmits, to the terminal 20 of the selected remittance master user, information (hereinafter referred to as “approval confirmation information”) for confirming whether or not the remittance master user approves stopping the remittance reminder.

Upon receiving information (hereinafter referred to as “approval information”) indicating approval from the terminal 20 of the remittance master user, the server 10 stops a remittance reminder from the remittance master user to the remittance requested user. Specifically, the server sets the reminder stop flags corresponding to the remittance request management IDs of all remittance requests for the remittance requested user from the remittance master user identified based on a received application ID to “ON” in the third remittance request management data 157C.

On the other hand, the server 10 does not stop the remittance reminder if the approval information has not been received from the terminal 20 of the remittance master user. That is, the reminder stop flags are kept “OFF”.

In a setting No. T4, “the terminal of the remittance requested user” is set as the target terminal, “a selected remittance request & remittance reminder stop selection” is set as the determination information, “a remittance reminder corresponding to the selected remittance request” is set as the determination result, and “required” is set as the information for determining the necessity of approval by the remittance master user.

This means that, when the remittance requested user selects a remittance request and further selects to stop a remittance reminder in a screen (a non-limiting example of which is the remittance request list screen) displayed in the display 24 of the terminal 20 of the remittance requested user, for example, a remittance reminder corresponding to the selected remittance request is stopped.

Since the remittance reminder is stopped according to the request of the remittance requested user, “required” is set as the information for determining the necessity of approval by the remittance master user.

When this setting is applied, the server 10 stops a remittance reminder corresponding to the selected remittance request. Specifically, the server 10 sets the reminder stop flag associated with the remittance request management ID corresponding to the selected remittance request to “ON” in the third remittance request management data 157C.

However, although the remittance request management ID can be uniquely identified, whether or not remittance based on the remittance request has been executed cannot be determined according to this setting. Therefore, the remittance completion flag is kept “OFF”.

Accordingly, in the case where the remittance has already been executed, information indicating completion of the remittance may be transmitted from the terminal 20 of the remittance requested user to the server 10, and the remittance completion flag may be set to “ON” by the server 10.

In a setting No. T5, “the terminal of a user who is not concerned” is set as the target terminal, “a selected remittance request for a concerned party & remittance reminder stop selection” is set as the determination information, “a remittance reminder corresponding to the selected remittance request for the concerned party” is set as the determination result, and “required” is set as the information for determining the necessity of approval by the remittance master user.

This means that, when a user who is not concerned with the remittance (a non-limiting example of which is a user who is neither the remittance master user nor the remittance requested user but is included in the same group as the remittance master user and the remittance requested user) selects a remittance request for a concerned party and further selects to stop a remittance reminder in a screen (a non-limiting example of which is the group request list screen) displayed in the display 24 of the terminal 20 of the user who is not concerned, a remittance reminder corresponding to the selected remittance request for the concerned party is stopped.

A non-limiting example of such a case is a case in which a user included in a group requests to stop a remittance reminder corresponding to a remittance request from the remittance master user to another group user (remittance requested user) included in the same group. This method can be said to be a method in which a user who is not the concerned party vouches for stopping a remittance reminder to the concerned party.

Since the remittance reminder is stopped according to the request of the user who is not the concerned party, “required” is set as the information for determining the necessity of approval by the remittance master user.

When this setting is applied, the server 10 stops a remittance reminder corresponding to the selected remittance request for the concerned party. Specifically, the server 10 sets the reminder stop flag associated with the remittance request management ID corresponding to the selected remittance request for the concerned party to “ON” in the third remittance request management data 157C.

Note that when the settings that require approval by the remittance master user are applied, the server 10 may execute the approval confirmation processing periodically, for example, at every few hours. This is for preventing the remittance master user from failing to disapprove.

Also, in a case where the server 10 does not receive approval information from the terminal 20 of the remittance master user even when a set period (a non-limiting example of which is a few days) has elapsed from when the approval confirmation processing is executed for the first time, the server 10 may stop a remittance reminder, assuming that the remittance master user approved.

To the contrary, a configuration is also possible in which, when the server 10 does not receive approval information from the terminal 20 of the remittance master user even when the set period has elapsed from when the approval confirmation processing is executed for the first time, the server 10 does not stop a remittance reminder, assuming that the remittance master user disapproved.

### Display Screen

The following describes examples of display screens in the cases where the setting No. T2 and the setting No. T4 are respectively applied.

FIG. 9-2 is a diagram showing an example of a remittance request list screen displayed in the display 24 of the terminal 20A of the user A.A.

In this example, a case will be described in which a remittance reminder corresponding to a remittance request transmitted from the remittance master user A.A to the remittance requested user B.B is stopped.

In this remittance request list screen, information regarding the remittance request transmitted from the user A.A to the user B.B and information regarding a remittance reminder corresponding to the remittance request are displayed.

A reminder stop icon IC10 that includes an image of a speaker and is used to stop a remittance reminder is displayed beside the icon image and the user name of the user B.B in the region in which information regarding the remittance request is displayed, in a non-limiting example.

In the default state (state where the remittance reminder is not stopped), the reminder stop icon IC10 is displayed in black and the image of the speaker is outlined, for example.

When the reminder stop icon IC10 is tapped, first remittance reminder stop information for stopping a remittance reminder corresponding to this remittance request pops up at the center of the screen as shown in FIG. 9-3, in a non-limiting example.

When an OK button BT10 included in first reminder stop confirmation information is tapped, remittance request selection information and first remittance reminder stop request information are transmitted from the terminal 20A to the server 10, and a remittance reminder corresponding to the selected remittance request is stopped.

Then, the display manner of the reminder stop icon IC10 associated with the remittance request from the user A.A to the user B.B changes from that shown in FIG. 9-2, in a non-limiting example. Specifically, the region of the reminder stop icon IC10 other than the image of the speaker, which was displayed in black, is also outlined as shown in FIG. 9-4, in a non-limiting example.

Moreover, as a result of the remittance reminder corresponding to the remittance request being stopped, the region in which the remittance reminder is displayed is faded as shown in FIG. 9-4, in a non-limiting example.

Note that not only the remittance reminder is stopped, but also a notification indicating that the requested amount has been paid may be given to the server 10 based on input made by the user to the terminal 20A.

In this case, the server 10 not only sets the reminder stop flag to “ON”, but also sets the remittance completion flag to “OFF”.

As a result, a completion mark MK1 including the text “DONE” is displayed for each of the remittance request and the corresponding remittance reminder in the remittance request list screen displayed in the display 24 of the terminal 20A as shown in FIG. 9-5, in a non-limiting example.

FIG. 9-6 is a diagram showing an example of the remittance request list screen displayed in the display 24 of the terminal 20A of the user B.B.

In this example, a case will be described in which the remittance requested user B.B requests to stop a remittance reminder corresponding to a remittance request that the remittance requested user B.B received from the remittance master user A.A.

In this remittance request list screen, information regarding the remittance request that the user B.B received from the user A.A and information regarding a remittance reminder corresponding to the remittance request are displayed.

The reminder stop icon IC10 described above is displayed beside the icon image and the user name of the user A.A in the region in which the remittance request is displayed.

When the reminder stop icon IC10 is tapped, second remittance reminder stop information for requesting the user A.A to stop a remittance reminder corresponding to the remittance request pops up at the center of the screen as shown in FIG. 9-7, in a non-limiting example.

When an OK button BT10 included in second reminder stop confirmation information is tapped, remittance request selection information and second remittance reminder stop request information are transmitted from the terminal 20B to the server 10. In this case, the server 10 transmits, to the terminal 20A of the user A.A, information for confirming whether or not the user A.A approves stopping the remittance reminder.

FIG. 9-8 is a diagram showing an example of a screen displayed in the display 24 of the terminal 20A of the user A.A in this case.

Stop approval confirmation information for confirming whether or not the user approves stopping the remittance reminder, which information is received from the server 10, is displayed at the center of the remittance request list screen in the display 24 of the terminal 20A. When an OK button BT10 included in the approval confirmation information is tapped, approval information is transmitted from the terminal 20A to the server 10. Then, the server 10 stops the remittance reminder corresponding to the remittance request.

As a result, a remittance request list screen shown in FIG. 9-9 is displayed in the display 24 of the terminal 20B, in a non-limiting example.

In the remittance request list screen shown in FIG. 9-9, the display manner of the reminder stop icon IC10 associated with the remittance request from the user A.A to the B.B is changed, and the region in which the remittance reminder corresponding to the remittance request is displayed is faded, in a non-limiting example. Effects of Ninth Example Embodiment

In an example embodiment, a configuration is described in which transmission control relating to transmission of the remittance reminder information (a non-limiting example of the second information) is executed by the server 10 based on input (a non-limiting example of first input) from the terminal 20 of the remittance master user (a non-limiting example of the first user).

As an example of effects of the embodiment obtained with this configuration, the transmission control relating to transmission of the second information to the terminal of the remittance requested user can be performed in accordance with the intention of the first user requesting remittance.

Also, in an example embodiment, a configuration is described in which the first input relates to not transmitting the remittance reminder information to the terminal 20 of the remittance requested user.

As an example of effects of the embodiment obtained with this configuration, control can be performed so as not to transmit the second information to the terminal of the remittance requested user in accordance with the intention of the first user requesting remittance.

Also, in an example embodiment, a configuration is described in which the transmission control described above is executed based on input (a non-limiting example of second input) that is made by the remittance requested user (a non-limiting example of a user of the terminal) to the terminal 20 of the remittance requested user.

As an example of effects of the embodiment obtained with this configuration, transmission control relating to transmission of the second information to the terminal of the remittance requested user can be performed in accordance with the intention of the remittance requested user.

Also, in an example embodiment, a configuration is described in which the second input relates to not transmitting the remittance reminder information.

As an example of effects of the embodiment obtained with this configuration, control can be performed so as not to transmit the second information to the terminal of the remittance requested user in accordance with the intention of the remittance requested user.

Also, in an example embodiment, a configuration is described in which the transmission control described above is executed based on the second input described above and information relating to approval by the remittance master user of not transmitting the second information (a non-limiting example of information relating to approval of the second input by the first user).

As an example of effects of the embodiment obtained with this configuration, even when the second input has been made, the second information can be transmitted to the terminal of the remittance requested user unless the first user requesting remittance approves the second input, in a non-limiting example. To the contrary, when the second input has been made, the second information can be kept from being transmitted to the terminal of the remittance requested user if the first user requesting remittance approves the second input.

### Others

In the above embodiments, the first information relating to a remittance request in the present disclosure is the “remittance request information”, and the second information based on the remittance request is the “remittance reminder information”, but there is no limitation to this configuration.

The combination of the first information and the second information in the present disclosure may be any of the following combinations.

### (1) First Combination

First information: remittance request information

Second information: remittance reminder information

This combination is described in the above embodiments.

### (2) Second Combination

First information: remittance request information

Second information: remittance exemption information

The remittance exemption information is information that is given from the remittance master user to inform the remittance requested user that the remittance requested user is exempted from remittance (information for informing the remittance requested user that he or she need not remit), in a non-limiting example.

This combination can be applied to a case where the remittance master user once requested remittance from the remittance requested user, but wants to inform the remittance requested user that he or she need not remit for some reason, for example.

### (3) Third Combination

First information: remittance exemption information

Second information: remittance exemption reminder information

The remittance exemption reminder information is information for making the remittance requested user recognize again that he or she is exempted from remittance by the remittance master user (information for reminding the remittance requested user that he or she need not remit), in a non-limiting example.

This combination can be applied to a case where the remittance master user wants to remind the remittance requested user that he or she is exempted from remittance after once informing the remittance requested user that he or she is exempted, for example.

### (4) Fourth Combination

First information: remittance exemption information

Second information: remittance request information

This combination can be applied to a case where the remittance master user once informed the remittance requested user that he or she is exempted from remittance, but the remittance became necessary for some reason, and the remittance master user requests the remittance from the remittance requested user.

The embodiments of the present disclosure have been shown and described above with reference to the accompanying drawings. The embodiments disclosed in the specification and drawings are only intended to provide specific examples for easily describing the technical content of the disclosure and for assisting understanding of the disclosure, and are not intended to limit the scope of the disclosure. It will be understood by those of ordinary skill in the art that the present disclosure may be easily modified into other detailed forms without changing the technical principle or essential features of the present disclosure, and without departing from the gist of the disclosure as claimed by the appended claims and their equivalents. Therefore, it should be interpreted that the scope of the disclosure includes all changes or modifications derived based on the technical idea of the disclosure in addition to the embodiments disclosed herein.

What is claimed is:

1. An information processing method performed by a terminal, the method comprising:
receiving, by a communication part of the terminal, first information relating to a remittance request from a first user;
displaying, in a display of the terminal, a first indication based on the first information;
displaying, in the display, a second indication that is based on the remittance request and differs from the first indication;
receiving, by an input device of the terminal, an input by a user of the terminal based on the second indication displayed in the display; and
executing remittance processing that is based on the remittance request and relates to remittance from a user of the terminal to the first user, based on the input by the user of the terminal.

2. The method of claim 1,
wherein the first indication comprises information of an amount based on the remittance request, and
the second indication comprises information of the amount based on the remittance request.

3. The method of claim 1,
wherein the first indication comprises information of the first user, and
the second indication comprises information of the first user.

4. The method of claim 1,
wherein the second indication is displayed in the terminal based on a first condition.

5. The method of claim 4,
wherein the first condition comprises a condition relating to time.

6. The method of claim 5,
wherein the first condition comprises a condition of a point in time or a period of time set by the terminal.

7. The method of claim 5,
wherein the first condition comprises a condition of a point in time or a period of time set by a terminal of the first user.

8. The method of claim 4,
wherein the first condition comprises a condition relating to a balance associated with the user of the terminal.

9. The method of claim 4,
wherein the first condition comprises a condition relating to remittance to the user of the terminal.

10. The method of claim 9,
wherein the condition relating to remittance to the user of the terminal comprises remittance to the user of the terminal as a result of the user of the terminal obtaining a loan.

11. The method of claim 9,
wherein the condition relating to remittance to the user of the terminal comprises remittance to the user of the terminal from a purchaser who purchased an item offered for sale by the user of the terminal.

12. The method of claims 4,
wherein the first condition comprises a condition relating to purchase of an item offered for sale by the user of the terminal.

13. The method of claim 4, the method further comprising:
based on the first condition, receiving, by the communication part, second information that is based on the remittance request and differs from the first information,
wherein the second indication is displayed in the display based on reception of the second information.

14. The method of claim 1,
wherein the first indication and the second indication are displayed in the display by an application installed in the terminal.

15. The method of claim 1, the method further comprising:
displaying a chat room, in the display, the chat room comprising at least the user of the terminal and the first user,
wherein the first indication and the second indication are displayed in the chat room.

16. The method of claim 15,
wherein the chat room comprises at least the user of the terminal, the first user, and a second user different from the first user, and
wherein the second indication is not displayed in a chat room that is displayed in a terminal of the second user.

17. The method of claim 16,
wherein the second indication is not displayed in a chat room that is displayed in a terminal of the first user.

18. The method of claims 15,
wherein the second indication comprises information indicating the user of the terminal.

19. The method of claim 16,
wherein the second indication is displayed in a first display manner in the chat room, and is displayed in a second display manner that is different from the first display manner in the chat room displayed in the terminal of the second user.

20. The method of claim 1,
wherein the first information is transmitted via a server to the terminal based on an input by the first user to a terminal of the first user, and
wherein the second indication is displayed based on second information that differs from the first information and is transmitted by the server to the terminal, and the second information is based on a settlement request.

21. The method of claim 20,
wherein the second information is transmitted to the terminal based on a time at which the first information is transmitted to the terminal or a time at which the first information is received by the terminal.

22. The method of claim 20, further comprising:
receiving, by the communication part, third information that is based on the remittance request and transmitted from the terminal of the first user, based on the input by the first user to the terminal of the first user; and
displaying, in the display, a third indication based on the third information,
wherein the second information is transmitted to the terminal based on transmission of the third information to the terminal.

23. The method of claims 1, further comprising:
performing notification processing based on reception, by the communication part, of second information that is based on a settlement request and differs from the first information,
wherein the notification processing is performed based on a second condition.

24. The method of claim 22, further comprising:
displaying, in the display, a fourth indication that remittance based on the remittance request has not been executed, based on the remittance processing not being executed; and
displaying, in the display, a fifth indication that remittance based on the remittance request has been executed, based on the remittance processing being executed.

25. The method of claim 1, wherein the remittance processing is executed based on an input by the user of the terminal based on the first indication.

26. The method of claim 1, wherein the executing the remittance processing comprises:
displaying, in the display, information indicating that remittance processing based on the remittance request has been executed.

27. The method of claim 1, wherein the executing the remittance processing comprises:
transmitting, by the communication part, information relating to a request for remittance processing based on the remittance request.

28. The method of claim 1,
wherein the first user is a store that sells a product relating to the remittance request.

29. The method of claims 1,
wherein the first user is a user who uses a business account.

30. A non-transitory computer readable medium for storing computer readable program code or instructions which are executable by a processor to perform a method, the method comprising:
receiving, by a communication part of the terminal, first information relating to a remittance request from a first user;
displaying, in a display of the terminal, a first indication based on the first information;
displaying, in the display, a second indication that is based on the remittance request and differs from the first indication;
receiving, by the communication part, an input by a user of the terminal based on the second indication displayed in the display; and
executing, by a processor of the terminal, remittance processing that is based on the remittance request and relates to remittance from the user of the terminal to the first user, based on the input by the user of the terminal.

31. A terminal comprising:
a communication part configured to receive first information relating to a remittance request from a first user;
a display configured to display a first indication based on the first information and a second indication that is based on the remittance request and differs from the first indication; and
a processor configured to execute remittance processing that is based on the remittance request and relates to remittance from a user of the terminal to the first user, based on an input that is based on the second indication displayed in the display.
